(19) United States
(12) Patent Application Publication
(10) Pub. No.: US 2025/0183357 A1
(43) Pub. Date: Jun. 5, 2025

(54) SOLID-STATE HYBRID ELECTROLYTES, METHODS OF MAKING SAME, AND USES THEREOF

(71) Applicant: University of Maryland, College Park, College Park, MD (US)

(72) Inventors: Liangbing HU, Hyattsville, MD (US); Eric D. WACHSMAN, Fulton, MD (US); Boyang LIU, Columbia, MD (US); Yunhui GONG, Clarksville, MD (US); Kun FU, College Park, MD (US)

(21) Appl. No.: 18/892,224

(22) Filed: Sep. 20, 2024

Related U.S. Application Data
(63) Continuation of application No. 16/499,203, filed on Sep. 27, 2019, now abandoned.
(60) Provisional application No. 62/478,396, filed on Mar. 29, 2017.
(60) Provisional application No. 62/483,816, filed on Apr. 10, 2017.

(51) Int. Cl. H01M 10/056; H01M 10/0525; H01M 50/451; H01M 50/454; H01M 50/457

(52) U.S. Cl. CPC H01M 10/056; H01M 10/0525; H01M 50/451; H01M 50/454; H01M 50/457; H01M 2300/0068; H01M 2300/0082; H01M 2300/0094

(57) ABSTRACT

Provided are solid-state hybrid electrolytes. The hybrid electrolytes have a polymeric material layer, which may be a polymer copolymer layer or a gel polymer copolymer layer, disposed on at least a portion of an exterior surface or all of the exterior surfaces of a solid-state electrolyte. A hybrid electrolyte can form an interface with an electrode of an ion-conducting battery that exhibits desirable properties. The solid-state electrolyte can comprise a monolithic SSE body, a mesoporous SSE body, or an inorganic SSE having fibers et strands, which may be aligned. In the case of solid-state electrolytes that have strands, the strands can be formed using a sacrificial template. The hybrid solid-state electrolytes can be used in ion-conducting batteries, which may be flexible, ion-conducting batteries.

### CROSS REFERENCE TO RELATED APPLICATIONS

This application claims priority to U.S. Provisional Application No. 62/478,396, filed on Mar. 29, 2017, and 62/483,816, filed Apr. 10, 2017, the disclosures of which are hereby incorporated by reference.

### STATEMENT REGARDING FEDERALLY SPONSORED RESEARCH

This invention was made with government support under contract nos. DEEE0006860 and DEEE0006860 awarded by the Department of Energy. The government has certain rights in the invention.

### FIELD OF THE DISCLOSURE

The disclosure generally relates to solid-state hybrid electrolytes. More particularly the disclosure generally relates to solid-state hybrid electrolytes for use in ion-conducting batteries.

### BACKGROUND OF THE DISCLOSURE

Lithium ion battery technology has advanced significantly in the last few decades. Pure lithium metal has the highest specific capacity (3860 mAh/g) and the lowest electrochemical potential (−3.04 V vs. standard hydrogen electrode) in comparison to any other lithium ion anode material. One critical challenge associated with lithium metal anodes is the formation of metal dendrites in liquid electrolyte system that can penetrate polymer separators and cause both safety concerns and performance decay in long term cycling applications. Solid state electrolyte (SSE) has been recognized as a solution to deter Li dendrite formation by acting as a strong, impenetrable barrier.

SSE generally has a wide electrochemical stability voltage window and a high shear modulus to prevent Li dendrite penetration, and improved safety as they are typically non-flammable. A major challenge for SSE's in Li metal batteries is the high interfacial resistance between the SSE and either the cathode or anode. High interfacial resistance results in a large overpotential and low coulombic efficiency as the cell is cycled.

Chemical/physical short circuits and volume variation in electrodes are the two other primary challenges in lithium batteries. In conventional batteries, polymer separators cannot effectively prevent chemical or physical short circuits. The dissolved active materials will inevitably travel though the polymer membrane micropores, and high modulus Li dendrites will easily penetrate the membrane, leading to poor performance and safety concerns. Volume change during lithiation and dilithiation raises additional concerns such as active material detachment at interfaces and structural instability of full cells. For sulfur cathodes the formation of lithium polysulfides and their transport across the liquid organic electrolyte is another major limitation to achieving high energy density batteries. Extensive work has been conducted by developing cathode hosts, modifying separators, or protecting Li metal to block short circuits and accommodate volume change, but few methods can address these challenges at the same time.

Liquid organic electrolytes are the industry standard ion conductors for lithium-ion batteries (LIB). Liquid electrolytes feature high ionic conductivity and good wettability with electrodes. However, liquid system are flammable and inevitably lead to solvation and diffusion of active materials, and the transport of unwanted species from cathode to anode cause “chemical short circuit” that deteriorates electrodes and limits the deployment of new cathode chemistries, which are typical for high voltage cathode, sulfur, and air/O₂. In high-voltage LIB, the dissolution of transition metals in LiNi_{0.5}Mn_{1.4}O₄ (LNMO) spinel cathode and their diffusion to the anode surface cause Li⁺ loss through continuous electrolyte decomposition that lead to rapid capacity decay. Besides LIB, the diffusion of active materials are more dominating in Li-metal batteries. For example, in Li—S batteries, the diffusion of polysulfides corrodes Li metal anode and the repeatable shuttling of polysulfides between electrodes causes low coulombic efficiency and active material loss. Similarly, a short circuit shuttle caused by mobile redox mediators in Li-air/O₂ batteries should be avoided as well. Therefore, it is critical to prevent chemical short circuit in terms of minimizing or blocking those soluble component transport in batteries.

There is an urgent and growing need for innovative approaches to develop new battery technologies with higher energy density and at the same time are less prone to catastrophic failure. Solid-state electrolyte is the key to providing high energy density and addressing the flammability and safety issue as well as challenges of chemical and physical short circuits by blocking migration of unwanted active materials and penetration of metal dendrites.

In the past several decades, many outstanding solid electrolyte materials, including conductive oxides, phosphates, hydrides, halides, sulfides, and polymer based composites, have been developed for solid-state batteries. Integration of solid lithium ion conductors into batteries has been demonstrated across a range of material sets, including: 0 D nanoparticles, 1 D nanofibers, 2D thin films, 3D networks and bulk components. Among these, the concept of a 3D lithium-ion conducting framework represents a creative solution to the shortcomings of current solid-state batteries' capabilities and cycling kinetics to provide continuous Li ion transport pathways and proper mechanical reinforcement.

A strategy to address Li dendrite penetration and SEI formation is to develop a solid-state electrolyte (SSE) to mechanically suppress the lithium dendrite and intrinsically eliminate SEI formation. Among the different types of solid-state electrolytes (inorganic oxides/non-oxides, and Li salt-contained polymers), solid-state polymer electrolytes have been the most extensively studied. In PEO-based composite, powders are incorporated into a host PEO polymer matrix to influence the recrystallization kinetics of the PEO polymer chains to promote local amorphous regions, thereby increasing the Li salt/polymer system's ionic conductivity. The addition of powders will also improve the electrochemical stability and enhance the mechanical strength. Developing nanostructured fillers is an approach to increase the ionic conductivity of polymer composite electrolytes due to the increased surface area of the amorphous region and improved interface between fillers and polymers. One dimensional nanowire fillers were demonstrated to enhance the ionic conductivity of the polymer composite electrolyte. This was because the nanowire fillers provide extended ionic transport pathways in the polymer matrix, instead of an isolated distribution of nanoparticle fillers in the polymer electrolyte. However, the agglomeration of ceramic fillers may remain and it will become a challenge for its mixing with polymer to fabricate uniform solid polymer electrolyte in large-scale. To solve this challenge, in situ synthesis of ceramic filler particles with high monodispersity in polymer electrolyte was recently reported. By in situ synthesizing nanosized SiO₂ particles into PRO/Li salt polymer, the reported solid polymer electrolyte exhibited an ionic conductivity of 4.4×10⁻⁵ S/cm at 30° C., which needs further improvement to achieve a higher ionic conductivity at room temperature. Based on our understanding, therefore, there is a major unmet need for creating a continuous SSE network with interconnected long-rang ion transport in composite hybrid electrolytes.

### SUMMARY OF THE DISCLOSURE

The present disclosure provides solid-state hybrid electrolytes. The present disclosure also provides methods of making and uses of solid-state hybrid electrolytes.

In an aspect, the present disclosure provides solid-state hybrid electrolytes. The solid-state hybrid electrolytes have a layer of polymeric material disposed on at least a portion of an exterior surface or all of the exterior surfaces of a solid-state electrolyte (SSE). In various examples, a solid-state hybrid electrolyte is a polymeric material/solid-state hybrid electrolyte, a polymer/solid-state hybrid electrolyte, or a gel polymer/solid-state hybrid electrolyte. In various examples, the SSE is a monolithic or mesoporous SSE body or an SSE comprising a plurality of fibers or a plurality of strands.

In an aspect, the present disclosure provides methods of making inorganic fibers or strands. The fibers or strands can form an inorganic SSE. In various examples, the methods are templating methods or electrospinning methods.

Strands can be formed using a templating method. A template comprises continuous void spaces that can used to form strands of inorganic materials that can form an inorganic solid-state electrolyte (e.g., solid-state hybrid electrolyte). The void spaces may be man-designed or naturally occurring in a biological material (e.g., wood, plant, and the like).

In an aspect, the present disclosure provides uses of solid-state hybrid electrolytes of the present disclosure. The solid-state hybrid electrolytes can be used in various devices. In various examples, a device comprises one or more solid-state hybrid electrolyte of the present disclosure. Non-limiting examples of devices include electrolytic cells, electrolysis cells, fuel cells, batteries, and other electrochemical devices such as, for example, sensors, and the like.

A device may be a battery. A battery may be an ion-conducting battery. The battery may be configured for applications such as, portable applications, transportation applications, stationary energy storage applications, and the like. Non-limiting examples of ion-conducing batteries include lithium-ion conducting batteries, sodium-ion conducting batteries, magnesium-ion conducing batteries, and the like.

### BRIEF DESCRIPTION OF THE FIGURES

For a fuller understanding of the nature and objects of the disclosure, reference should be made to the following detailed description taken in conjunction with the accompanying figures.

FIG. 1 shows (a) a schematic of the solid-state gel polymer battery design with hybrid polymer/garnet-type SSE electrolyte. (b) Without interfacial gel polymer layer, the garnet SSE and electrode have poor interfacial contact. With the gel polymer layer, the contact between electrode and SSE can be improved.

FIG. 2 shows impedance analysis of symmetric cells with hybrid electrolyte. (a) EIS of a LiFePO₄ cathode|polymer|SSE|polymer|cathode symmetric cell. (b) EIS of a SS|polymer|SSE|polymer|SS symmetric cell. (c) EIS of a cathode|polymer|SSE|polymer|cathode symmetric cell. (d) EIS plot of a Li|polymer|Li symmetric cell. (e) EIS plot of Li|polymer|SSE|polymer|Li symmetric cell. (f) Comparison of the SSE|electrode interfacial resistance with and without the gel polymer interface.

FIG. 3 shows impedance of the electrode|SSE|electrode symmetric cell components with and without gel polymer interfacial layers.

FIG. 4 shows electrochemical performances of polymer|SSE|polymer hybrid electrolyte in symmetric and full cells. (a) Voltage profile of Li stripping and platting in a Li|polymer|SSE|polymer|Li symmetric cell with constant current for 15 hours. (b) EIS plot of the cell before and after cycling. (c) Charge and discharge voltage profiles of a cathode|SSE|Li cell with gel polymer interfacial layers. (d) Discharge capacity and coulombic efficiency of the cell for 130 cycles. (e) EIS of the cell before cycling, after 20 cycles, and after 130 cycles.

FIG. 5 shows impedance of electrode|SSE|electrode symmetric cells without gel polymer interface. (a) EIS of cathode|SSE|cathode symmetric cell. (b) EIS of Li|SSE|Li symmetric cell.

FIG. 6 shows comparison of conventional battery and hybrid solid state electrolyte with a focus on bilayer solid-state electrolyte matrix.

FIG. 7 shows characterizations of bilayer garnet solid-state electrolyte Schematic is a 3D structure of bilayer garnet structure. (a) Photo image of bilayer garnet SSE. (b) Top view SEM image of the porous layer. The scale bar is 200 μm. (c) Magnified view of porous layer. The scale bar is 50 μm. (d) SEM of the connection part of porous layer and dense layer. The scale bar is 10 μm. (e) Magnified SEM image of the grain dense microstructure. The highly dense structure can block soluble active materials and suppress Li dendrite penetration. The scale bar is 10 μm. (f) Cross-section of the bilayer garnet structure. Two distinct layers with porous and dense garnet structures can be clearly observed with a dense layer of ˜35 μm and porous layer of 70 μm.

FIG. 8 shows chemical stability of garnet SSE in polysulfides solution, liquid electrolyte, and molten sulfur. (a-b) S 2p XPS spectra of dense garnet pellet before and after Ar sputtering on surface. Before XPS analysis, the dense garnet pellet was fully immersed in polysulfides solution (Li₂S₈ in DME/DOL) for 1 week (c) Zr 3d XPS spectra of dense garnet pellet before and after Ar sputtering on surface. (d-e) XRD patterns and Raman spectra of garnet powders after being soaked in liquid electrolyte (LiTFSI in DME/DOL) and polysulfides solution for one week. The samples were sealed in a Kapton bag to avoid oxygen and moisture contamination. (f) TEM image of garnet nanopowders after being soaked in polysulfides solution for 1 week. (g) XRD pattern of garnet powders after being soaked in molten sulfur at 160° C. for one week. (h) Calculated mutual reaction energy ΔE_{D,mutual} of the garnet and Li₂S and Li₂S₈.

FIG. 9 shows electrochemical characterization of the hybrid liquid-solid electrolyte. (a-b) Schematic and SEM image of bare dense garnet layer surface. (c-d) Schematic and SEM of polymer coated dense garnet layer surface. (e) ETS of the symmetric cell with polymer coating. (f) Voltage profile of the Li plating/stripping cycling with a current density of 0.3 mA/cm². The red line is the form Li/garnet/Li, which was prepared by attaching molten Li directly onto garnet dense surface. The Li/garnet/La shows an increased, voltage curve with large impedance. Black line is from the symmetric hybrid electrolyte cell. The Inset profiles show the detailed voltage plateau of Li stripping/plating in the beginning few hours and 140^{th} hours. (g-b) Voltage profile of the Li plating/stripping cycling with a current density of 0.5 and 1.0 mA/cm².

FIG. 10 shows electrochemical characterization of hybrid solid-state Li—S batteries. (a) Schematic of conventional Li—S and hybrid solid-state Li—S batteries. In conventional Li—S, polymeric porous membrane can neither block polysulfides nor prevent Li dendrite penetration. In hybrid solid-state Li—S batteries, the ceramic dense membrane cannot only physically block liquid electrolyte and polysulfides, but also suppress Li dendrite growth towards cathode. (b) Voltage profiles of conventional and hybrid Li—S cells. An extended plateau in charge plateau indicates the shuttle effect of polysulfides in conventional Li—S. No shuttle effect occurs in the hybrid Li—S cell. (c) Voltage profiles of hybrid Li—S cell at elevated current density. Dense garnet membrane and slurry-casted sulfur electrode with a mass loading of ˜1.2 mg/cm² were assembled into the hybrid cell. (d) Rate performance of the hybrid Li—S cell. (e) Schematic of hybrid solid-state bilayer Li—S battery. Sulfur and CNT were encapsulated in the pores. The mechanically stable bilayer garnet structure can accommodate the volume expansion of sulfur and maintain the electrode structure stable during cycling. (f) Cross-section of the bilayer sulfur cathode and elemental mappings show sulfur distribution inside of the porous layer. (g-h) Voltage profile and cycling performance of the hybrid bilayer Li—S cell with a loading of 7.5 mg/cm² at 0.2 mA/cm².

FIG. 11 shows Nyquist plots of the dense garnet SSE pellet at different temperatures (25, 30, 40, and 50° C.). The dense garnet pellet has a thickness of ˜250 μm.

FIG. 12 shows Arrhenius plot of garnet SSE conductivity. The activation energy is 0.35 eV.

FIG. 13 shows a conventional Li—S battery. The sulfur mass loading is ˜1.2 mg/cm². (a) Voltage profiles of conventional Li—S battery with long charge plateau, indicating shuttling effect of polysulfides. (b) Cycling performance of the conventional Li—S cell. The cell shows a fast decay after 10 cycles. (c) Poor coulombic efficiency of the conventional Li—S cell.

FIG. 14 shows cycling performance of hybrid solid-state Li—S battery at a current of 0.1 mA/cm². The sulfur loading is 1.2 mg/cm². The hybrid cell delivered high capacity >1000 mAb/g.

FIG. 15 shows an SEM micrograph of CNT coated garnet porous structure CNT were deposited on garnet surface, providing an electronic conducting network for sulfur active material. Scale bar in (a) and (b) is 10 μm and 500 nm.

FIG. 16 shows calculations of the specific energy density of the tested garnet bilayer Li—S battery.

FIG. 17 shows a projected energy density of bilayer garnet solid-state Li—S batteries with optimized parameters.

FIG. 18 shows a schematic of multi-scale aligned mesoporous garnet Li_{6.4}La₃ZrA_{10.2}O₁₂ (LLZO) membrane incorporated with polymer electrolyte in a lithium symmetric cell. The garnet-wood possesses multi-scale aligned mesostructure derived from natural wood, which enables the unobstructed Li ion transport along the garnet-polymer interface, through garnet, and through polymer electrolyte.

FIG. 19 shows characterization of the wood template. Illustrations of the wood template fabrication through compressing and slicing; Top-view SEM image of (b) pristine wood and (c) compressed wood, with the apparent diameter reduction of the wood microchannels after compression; Cross-sectional SEM images comparing (d) pristine wood and (e) compressed wood, in which the channels are closed but the highly aligned structure is preserved; (f) SEM image of the aligned nanofiber with a diameter of around 10 nm.

FIG. 20 shows calcination of the aligned garnet templated by wood. Cross-sectional SEM image shows the alignment of channels at both (a) micro-scale and (b) nanoscale; (c) Photograph of the flexible garnet-wood consisting of the aligned mesoporous garnet and PEO based polymer electrolyte; (d) XRD pattern of the aligned garnet matches JCPDS #90-0457, which verifies the cubic garnet structure.

FIG. 21 shows TEM characterization of garnet crystal structure. (a) HRTEM image of a nanoparticle broken off from the aligned garnet showing the (21 0̅) and (021) lattice planes; inset graph shows the FFT patterns of the HRTEM image; (b) TEM image of the edge of a garnet nanoparticle showing a clear multi-crystalline structure. (c) EELS spectrum of the garnet surface showing the ROI, spectrum image, and relative composition map of O, C, and La, respectively.

FIG. 22 shows electrochemical characterizations of the garnet-wood with aligned mesoporous structure. (a) SEM and its corresponding EDX images showing the complete, uniform infiltration of polymer electrolyte throughout the aligned garnet. Scale bars, 100 μm; (b) Nyquist plot showing the decrease in the impedance of the garnet-wood membrane with increasing temperature, the inset schematic shows the structure of the testing cell; (c) Comparison of the ionic conductivity of the garnet-wood and PEO based polymer electrolyte at different temperatures, the blue region indicates measurements performed within the range of room temperature (RT); (d) Schematic of the lithium symmetric cell with garnet-wood, showing the low tortuosity, fast lithium transport pathways; (e) Galvanostatic cycling of Li/garnet-wood/Li with a current density of 0.1 mA/cm² at room temperature.

FIG. 23 shows a photo of an as sintered aligned mesoporous garnet. The photograph shows a piece of as sintered aligned mesopores garnet. The garnet membrane was white and flat with a similar area to the wood template.

FIG. 24 shows a cross-sectional SEM image of garnet-wood. The thickness of the garnet-wood can be controlled by the thickness of the wood template. SEM image shows a thin garnet-wood sample with a thickness of ˜30 μm, in which the low-tortuosity channels are highly aligned and penetrate throughout the whole garnet membrane.

FIG. 25 shows a cross-sectional SEM image of the aligned garnet structure. The SEM image shows a piece of garnet wood sample with a thickness of 18 un. The sample was sintered from a template which was thinned by slicing and polishing.

FIG. 26 shows a cross-sectional SEM image of garnet-wood. The SEM image shows the cross-section and top surface of the garnet wood. The aligned structure is fully filled with PRO based polymer electrolyte.

FIG. 27 shows weight change of the wood template during precursor infiltration. The wood template was soaked in the precursor solution and the weight increases over time. The weight change shows the high absorbency of the wood template.

FIG. 28 shows (a) EIS measurements and (b) ionic conductivity of the PEO/SCN/Li-TFSI polymer electrolyte at different temperatures. The highlighted region indicates measurements performed around room temperature (RT). The inset shows that the PEO/LiTFSI/SCN polymer electrolyte film was sandwiched by two stainless steel electrodes. A polyethylene (PE) separator ring was placed around the polymer electrolyte film to fix the thickness and avoid shorting at high temperatures.

FIG. 29 shows galvanostatic cycling of Li/garnet wood/Li with a current density of 0.1 mA/cm² at room temperature for over 600 hours. The fluctuation in the voltage is caused by changes to the ambient temperature of the cell. The long-term cycling indicates the outstanding electrochemical and mechanical stability of the garnet wood composite electrolyte in Li metal cells.

FIG. 30 shows a flexible lithium-ion conducting ceramic textile. The lithium-ion conducting ceramic textile is flexible and retained the physical characteristics of the original template. The unique textile structure enables long-range lithium-ion transport pathways via continuous fibers and yarns, high surface area/volume ratio of solid ion conductors and multi-level porosity distribution.

FIG. 31 show characterization of the garnet textile. (a) SEM image of the pretreated textile template; (b) SEM image of the template impregnated with the precursor solution; (c) SEM image of the garnet textile converted from the precursor solution impregnated template; (d) Reconstructed model of garnet textile flatness uniformity generated by 3D laser scanning; (e) Flexibility, workability and solvent tolerance of the garnet textile; (f) Powder XRD patterns of the crushed garnet textile sintered at different temperatures; (g) Elemental distribution mapping of a single garnet fiber sintered at 800° C.

FIG. 32 shows electrochemical characterization of garnet textile reinforced flexible composite polymer electrolyte. (a) Dried CPE showing flexibility and mechanical strength; (b) illustration of fibrous garnet dominated lithium-ion transfer mechanism; (c) Impedance spectra of the CPE at different temperatures; (d) Arrhenius plot of the lithium-ion conductivity of the CPE as a function of temperature; (e) Galvanostatic cycling measurements of Li/CPE/Li symmetrical cells at various current densities and 60° C.

FIG. 33 shows characterization of garnet textile 3D electrode architecture for solid state Li—S batteries loaded with 10.8 mg/cm² sulfur. (a) Photograph of a garnet textile sintered on the dense supporting electrolyte. (b) SEM image of the sulfur cathode infiltrated garnet textile electrode architecture; (c) EDX elemental mapping of the sulfur carbon mixture loaded single garnet fiber; (d) Charge-discharge profiles of the solid-state Lithium-Sulfur battery.

FIG. 34 shows characterization of the flexible garnet textile. (a) Thermogravimetric analysis of the garnet precursor solution impregnated textile template. (b) Cross-sectional SEM image of the pretreated textile template; (c) Cross-sectional SEM image of the precursor solution-impregnated textile template; (d) Cross-sectional SEM image of the garnet textile after pyrolysis of the template and sintering at high temperature.

FIG. 35 shows a flexible garnet textile in large dimensions and different shapes.

FIG. 36 shows a characterization of Li-ion conducting garnet and insulating Al₂O₃ textile reinforced flexible CPE. (a) Cross-sectional SEM image of the garnet textile reinforced flexible CPE; (b) The insulating Al₂O₃ textile fabricated using the identical template method; (c) Impedance plots of the controlled CPE at different temperatures.

FIG. 37 shows electrochemical characterization of the garnet textile reinforced flexible CPE. (a) Impedance plots of a Li/CPE/Li symmetrical cell before and after 500 h cycling at 60° C.; (b) Room-temperature galvanostatic cycling measurements of Li/CPE/Li symmetrical cells at 0.05 mA/cm²; (c) Galvanostatic cycling measurements of Li/CPE/Li symmetrical cells at 1 mA/cm and 60° C.

FIG. 38 shows characterization of the sulfur infiltrated 3D electrode built with garnet textile architecture for solid-state Li—S batteries. (a) EDX elemental linear scan along the direction from the exposed yarn area to the dense electrolyte surface of the 3D sulfur cathode built with garnet textile; (b) High magnification cross-sectional SEM image and elemental mapping of the 3D sulfur cathode built with garnet textile.

FIG. 39 shows characteristic features of the garnet electrolyte support fabricated by tape casting and hot lamination, and chemical compatibility of garnet electrolyte with polysulfide catholyte and liquid electrolyte. (a) Cross-sectional SEM image of a 500 μm thick dense garnet electrolyte support; (b) XRD pattern of the crushed garnet electrolyte; (c) Lithium-ion conductivity of the dense garnet electrolyte in the temperature range of 25° C. and 100° C. (d) Photograph of a fresh garnet electrolyte support polished in the glove box; (e) Photograph of the garnet electrolyte soaked in polysulfide catholyte and liquid electrolyte for 300 h; (f) Photograph of the garnet electrolyte rinsed with DME/DOL solvent afterward, with no obvious color change observed. (g) XRD patterns of the garnet electrolyte before and after the soaking experiment, with no chemical change observed.

FIG. 40 shows discharge and charge profiles of the solid-state Li—S batteries built with garnet textile architecture with sulfur loading of 10.8 mg/cm² at 0.75 mA/cm².

FIG. 41 discharge and charge profiles of the solid-state Li—S batteries built with garnet textile architecture with higher sulfur loading of 18.6 mg/cm² at 0.15 mA/cm².

FIG. 42 shows relative weight and energy density of the solid-state Li—S batteries with 18.6 mg/cm² sulfur loading in different electrolyte support structural configurations. (a) Relative weight distribution of garnet, cathode, anode and current collector in solid-state Li—S batteries and corresponding energy densities: (1) 500 μm thick electrolyte support and 63% utilization of electrolyte area; (2) 100 μm thick electrolyte support and 100% utilization of electrolyte area. (3) Bi-layer support structure consisting of thin dense electrolyte (20 μm) and porous substrate (70 μm), and 100% utilization of electrolyte area. (b) Representative SEM image of the low-weight bi-layer supporting structure.

FIG. 43 shows densities of the constituent materials in solid-state Li—S battery.

FIG. 44 shows structural parameters of different electrolyte support configurations.

FIG. 45 shows parameters of cathode components.

FIG. 46 shows parameters of anode component.

FIG. 47 shows a schematic of the hybrid solid-state composite electrolyte, where ceramic garnet nanofibers function as the reinforcement and lithium ion conducting polymer as the matrix. The inter-welded garnet nanofiber network provides continuous ion-conducting pathway in the electrolyte membrane.

FIG. 48 shows fabrication of the flexible solid-state fiber-reinforced composite (FRPC) electrolyte. (a) Schematic setup of electrospinning garnet/PVP nanofibers. (b) Schematic procedure to fabricate the FRPC Li-ion conducting membrane. (c) SEM image of the as-spun nanofiber network. (d) Diameter distribution of the as-spun nanofibers. (e) SEM image of the garnet nanofiber network (f) Diameter distribution of the garnet nanofibers. (g) Photo image to show the flexible and bendable FRPC Li-ion conducting membrane.

FIG. 49 shows morphological characterizations of garnet nanofiber reinforcement and the solid-state FRPC electrolyte. (a) SEM image showing the inter-welded garnet nanofibers. (b) TEM image of polycrystalline garnet nanofiber. Inset is the magnified image of garnet nanofiber showing average grain size of 20 nm in diameter. (c) High resolution TEM image of an individual garnet nanofiber. (d) SEM image of: FRPC electrolyte membrane surface. (e) Cross-sectional SEM image of the membrane. (f) Magnified SEM image of the cross-section morphology. The free space of garnet 3D porous structure was filled with polymer.

FIG. 50 shows thermal properties and flammability tests of the solid-state FRPC electrolyte. (a) TGA curve of the as-spun nanofibers. (b) TGA curves of Li salt/PEO polymer and FRPC electrolyte membrane. (c) Flammability test of Li salt PEO polymer mixed with garnet nanoparticles. (d) Flammability test of FRPC electrolyte membrane.

FIG. 51 shows a phase structure of garnet fiber and electrical properties of solid-state FRPC electrolyte. (a) XRD pattern of the garnet nanofibers (b) EIS profiles of the FRPC electrolyte membrane at different temperatures (25° C., 40° C., and 90° C.). (c) Arrhenius plot of the FRPC electrolyte membrane at elevated temperatures (from 20° C. to 90° C. and record every 10° C. in increase). (d) LSV curve of the FRPC electrolyte membrane to show the electrochemical stability window in the range of 0-6V.

FIG. 52 shows electrochemical performance of FRPC electrolyte membrane measured in symmetric Li|FRPC electrolyte|Li cell. (a) Schematic of the symmetric cell for lithium plating/stripping experiment. (b) Voltage profile of the lithium plating/striping cycling with a current density of 0.2 mA/cm² at 15° C. (c) Voltage profile of the continued lithium plating/stripping cycling with a current density of 0.2 mA/cm² at 25° C. (d) The impedance spectra of the symmetric cell measured at different cycle time (300 hours, 500 hours, and 700 hours). (e) Magnified EIS spectra in the high frequency region. (e) Voltage profile of the continued lithium plating/stripping cycling with a current density of 0.5 mA/cm² at 25° C.

FIG. 53 shows the magnified TEM image of a garnet nanofiber with an average grain size of 20 nm in diameter.

FIG. 54 shows when the testing temperature increased to 25° C. the voltage dropped to 0.3 V due to the improved ionic conductivity at elevated temperature as shown in FIG. 6c. In the following long-time cycles, the voltage kept decreasing to 0.2 V with increasing cycle time to 700 hours. The fluctuation of voltage was caused by the surrounding environmental temperature change.

FIG. 55 shows two voltage profiles of the symmetric cell at two different stripping/plating process time were compared.

FIG. 56 show schematic of an example of a battery of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

All ranges provided herein include all values that fall within the ranges to the tenth decimal place, unless indicated otherwise.

The present disclosure provides solid-state hybrid electrolytes. The present disclosure also provides methods of making and uses of solid-state hybrid electrolytes.

In an aspect, the present disclosure provides solid-state hybrid electrolytes. The solid-state hybrid electrolytes have a layer of polymeric material disposed on at least a portion of an exterior surface or all of the exterior surfaces of a solid-state electrolyte (SSE). In various examples, a solid-state hybrid electrolyte is a polymeric material/solid-state hybrid electrolyte, a polymer/solid-state hybrid electrolyte, or a gel polymer/solid-state hybrid electrolyte. In various examples, the SSE is a monolithic or mesoporous SSE body or an SSE comprising a plurality of fibers or a plurality of strands.

In various examples, the present disclosure provides solid-state hybrid electrolytes with, for example, layers, including, but not limited to, polymer layers (e.g., polymer membranes), formed in different ways, to achieve solid-state hybrid electrolytes with, for example, desirable ionic conductivity, and stable and well-connected interfaces between such electrolyte and electrodes. The solid-state hybrid electrolytes of the present disclosure can exhibit, for example, interfacial resistance of 248 Ω×cm² or lower at an electrolyte lithium ion cathode interface and/or 214 Ω×cm² or lower at an electrolyte/lithium metal anode interface. The layer can be made with gel polymer (storing liquid electrolyte inside polymer) or dry polymer (no liquid inside, and, for example, conducting Li ions with salt in polymer), or other types of conductive thin films. The solid-state electrolyte with the polymer interfaces can be built up together with, for example, carbon or Li metal anodes and Li-metal oxide, sulfur, or air, to form solid state Li-batteries. This disclosure addresses the challenge of interface resistance between solid state electrolyte and electrodes, which will facilitate further development of solid state ion-conducting (e.g., lithium ion-conducting) batteries.

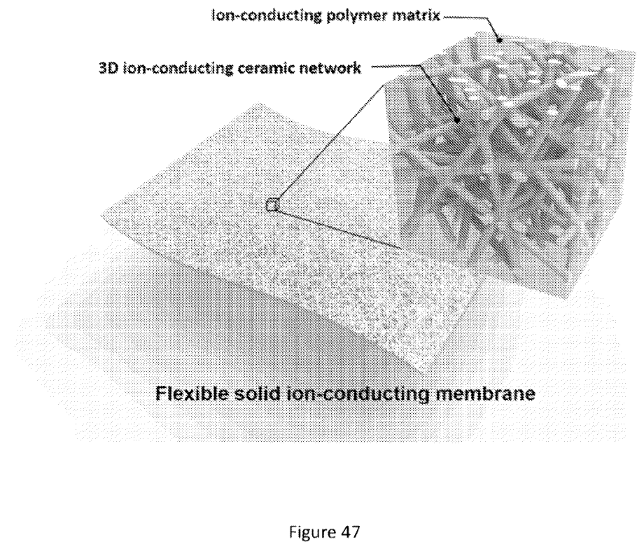

In various examples, the present disclosure provides solid-state hybrid electrolytes with flexible inorganic SSEs. The flexible inorganic SSEs can be low-cost, thin, flexible, ionically conductive membranes that are expected to enable next generation of ion conducing batteries (e.g., Li-metal batteries) that exhibit desirable safety. For example, ion-conductive 3D networks are be infiltrated with, for example, Li-ion conductive polymers to prepare the flexible ion-conductive SSE membranes. A schematic example is shown in FIG. 47. In various examples, oxide SSE materials, including, but not limited to, LLZO garnet, LLTO perovskite and LATP glass were used to produce a 3D ion-conductive network. The 3D structure can provide, for example, long-range ion transfer pathways and Structural reinforcement to enhance the polymer matrix. The membrane can exhibit desirable electrochemical stability to high voltage (e.g., greater than 6V), high ionic conductivity (e.g., greater than 10⁻⁴ S cm⁻¹) and high mechanical stability, for example, to effectively block lithium dendrites.

A solid-state hybrid electrolyte may comprise an inorganic SSE (e.g., an inorganic (e.g., ceramic) monolithic or mesoporous structured SSE body, or an SSE comprising a plurality of inorganic fibers or a plurality of inorganic strands (an F/S SSE)); and a polymeric material disposed on at least a portion an exterior surface of or all of the exterior surfaces of the SSE.

The inorganic SSE (e.g., of an F/S SSE) may have a three-dimensional network structure with one or more nodes formed by at least two fibers or strands. The inorganic solid-state electrolyte (e.g., solid-state hybrid electrolyte) has a continuous ionic conduction path from one side of the inorganic solid-state electrolyte to an opposite side of the inorganic solid-state electrolyte. The 3D ion-conductive network of the ionic SSE can function as reinforcement and ion-conducting (e.g., lithium ion conducting) polymer serves as a matrix. The 3D network provides continuous ion-conducting pathway in the electrolyte membrane. In the case of solid-state hybrid electrolytes formed from strands or fibers, the inorganic solid-state material may be exposed on one or more surface of the solid-state hybrid electrolyte. In the case of solid-state hybrid electrolytes formed from a plurality of strands, the inorganic SSE may be a continuous and, optionally, aligned, mesoporous structure.

In various examples of a solid-state hybrid electrolyte, a polymeric material at least partially or completely fills the void spaces of the inorganic fibers or templated inorganic strands. In the case of a solid-state hybrid electrolyte where the polymeric material partially fills the void spaces of the templated inorganic solid state electrolyte, at least a portion of the void spaces open to an exterior surface of the templated inorganic solid state electrolyte may be filled with a cathode material and/or anode material to form an integrated cathode and/or electrode.

The inorganic SSE can be formed from various inorganic materials. The inorganic material may be a ceramic material. The inorganic material is ion conducting (e.g., lithium-ion conducting, sodium-ion conducting, magnesium-ion conducting or the like) material. An inorganic SSE may be an ion-conducting electrolyte. Examples of suitable inorganic materials are known in the art. Non-limiting examples of inorganic materials include lithium-ion conducing inorganic materials, sodium-ion conducting inorganic materials, magnesium-ion conducing inorganic materials, and the like. Any inorganic SSE electrolyte material known in the art can be used. Methods of making inorganic SSE electrolyte material are known in the art.

The inorganic material can have various structure (e.g., secondary structure). In various examples, an inorganic material is amorphous, crystalline (e.g., single crystalline and polycrystalline), or have various amorphous and/or crystalline domains.

The inorganic material may be a lithium-conducting inorganic (e.g., ceramic) material. The lithium-conducting inorganic material may be a lithium-containing material.

Non-limiting examples of lithium-ion conducting SSE materials include lithium perovskite materials, LisN, Li-β-alumina, Lithium Super-ionic Conductors (LISICON), Li_{2.88}PO_{3.86}N_{0.14} (LiPON), Li₉AlSiO₈, Li₁₀GeP₂Sr₁₂, lithium garnet SSE materials, doped lithium garnet SSE materials, lithium garnet composite materials, and the like. In various examples, the lithium garnet SSE material is cation-doped Li₅La₃M¹₂O₁₂, where M¹ is Nb, Zr, Ta or combinations thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof, and the like. In various other examples, the lithium garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₂, Li_{6.4}Y₃₄Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa_{1.75}Ta_{1.75}Zn_{0.25}O₁₂, or the like.

The inorganic material may be a sodium-ion conducting inorganic (e.g., ceramic) material. The sodium-ion conducting inorganic material may be a sodium-containing material. For example, the sodium-ion conducting inorganic material is β″—Al₂O₃, Na₄Zr₂Si₂PO₁₂ (NASICON), cation-doped NASICON, or the like.

The inorganic material may be a magnesium-ion conducting inorganic (e.g., ceramic) material. The magnesium-ion conducting inorganic material may be a magnesium-containing material. In various examples, the magnesium-ion conducting inorganic material is selected from doped magnesium oxide materials. In various examples, the magnesium-ion conducing material is Mg₁₊ₓ(Al,Ti)₂(PO₄)₆, where x is 4 to 5. NASICON-type magnesium-ion conducting materials, or the like.

The monolithic SSE or mesoporous SSE body can have various sizes (i.e., dimensions) and/or shapes. Suitable monolithic SSE or mesoporous SSE bodies are known in the art. A monolithic SSE body may be a dense body (e.g., comprising only a dense layer of inorganic material) or a densely sintered body.

Non-limiting examples of mesoporous SSEs include planar SSE structures comprising an external layer of porous (e.g., mesoporous) material (e.g., a multilayer SSE structure comprising a dense layer and at least one porous (e.g., mesoporous) layer). Non-limiting examples of multilayer SSE structures include bilayer structures (comprising a porous layer disposed on a dense layer) and trilayer structures (comprising two porous layers disposed on opposite sides of a dense layer) are known in the art. Examples of multilayer structures are described in U.S. patent application Ser. No. 14/222,306 (titled “Jon Conducting Batteries with Solid State Electrolyte Materials”), filed on Mar. 21, 2014, and published on Sep. 25, 2014, as U.S. Patent Application Publication No. 2014/0287305 and U.S. patent application Ser. No. 15/364,528 (titled “Ceramic Ion Conducting Structures and Methods of Fabricating Same. and Uses of Same”), filed on Nov. 30, 2016, and published on Jun. 1, 2017, as U.S. Patent Application Publication No. 2017/0155169, the disclosures of which are incorporated herein by reference.

The F/S SSE can comprise a fibers or strands having various sizes (i.e., dimensions) and/or shapes. In various examples, the fibers or stands are cylindrical or substantially cylindrical, polyhedral or substantially polyhedral shaped, irregularly shaped, or the like. The fibers or strands can have a length corresponding to multiples of one or more dimension of the device in which they are used. In various examples, the fibers or strands have a length of 1 micron to 20 meters, including all integer micron values and ranges therebetween, and/or a greatest cross-sectional dimension (e.g., diameter) of 1 nm to 10 microns, including all integer nm values and ranges therebetween. In an example, the F/S SSE comprises fibers or strands with a length to greatest cross-sectional dimension (e.g., diameter) of 10 or greater.

The fibers or strands The F/S SSE can be flexible and provide a flexible solid-state hybrid electrolyte for use in a flexible device such as, for example, a battery. The F/S SSE and polymeric material may form an electrolyte. F/S SSEs can be made by methods described herein.

Various polymeric materials can be used. Mixtures of two or more polymeric materials (e.g., two or more polymers) can be used. The polymeric materials can be conducting (e.g., ion-conducting and/or electronic conducting), non-conducting, or a combination thereof. The polymeric material may be a dry polymer or a gel.

In the case of a monolithic SSE or mesoporous body, it may be desirable that the polymeric material be conducting (e.g., ion-conducting and/or electronic conducting). In the case of an inorganic SSE comprising a plurality of fibers or strands, it may be desirable that the polymeric material, which may be a mixture of polymeric materials, provide mechanical strength to the SSE.

In the case of solid-state hybrid electrolytes having a monolithic SSE or mesoporous SSE body, it is desirable to have a thin layer (e.g., having a thickness of 5 nm to 10 microns, including all integer nm values and range therebetween) of polymeric material.

The polymeric material can be disposed on at least a portion of or all of the surfaces of the SSE (e.g., inorganic SSE). In the case of a dense SSE material, the polymeric material is a layer (e.g., a conformal layer) disposed on at least a portion of (e.g., the portions of the SSE material on which an electrode (e.g., cathode and/or anode) would be disposed). In the case of a porous SSE (which may be an exterior portion (e.g., layer) of a monolithic SSE or mesoporous SSE body or an SSE comprising a plurality of fibers or strands), the polymeric material is disposed on the pore surface(s), the non-pore surface(s), or both. It may be desirable that the polymeric material be disposed on the portions of the porous SSE material on which an electrode (e.g., cathode and/or anode) would be disposed. In an example, the polymeric material is present at 1 volume percent or greater, 5 volume percent or greater, 10 volume percent or greater, 20 volume percent or greater, 30 volume percent or greater, 40 volume percent or greater, 50 volume percent or greater, or 60 volume percent or greater of the solid-state hybrid electrolyte.

In the case of solid-state hybrid electrolyte with a monolithic SSE or mesoporous body, the polymeric material can be a layer. The layer can be formed by various methods known in the art. For example, a polymeric material layer is formed by dip coating, slurry casting, spray coating or spinning coating or the like.

In the case of solid-state hybrid electrolyte with an F/S SSE, the polymeric material is disposed in the void space formed by the individual fibers or strands of the SSE. The void space may be a pore resulting from use of a template. The polymeric material may be incorporated in the F/S SSE by methods known in the art. For example, the polymeric material is infiltrated or in situ synthesized into the void space (e.g., pores) of the F/S SSE.

Various polymeric materials can be used. The polymeric materials may comprise one or more polymer, one or more co-polymer, or a combination thereof. Molecular weight of the polymer(s) and/or copolymer(s) is not particularly limited. For example, depending on the performance (e.g., ion conductivity) requirement of a devices (e.g., a solid-state, ion-conducting battery), polymer(s) and/or copolymer(s) can have a broad range of molecular weight. It may be desirable that the polymer(s) and/or copolymer(s) be conducting. A polymeric material may comprise a mixture of conducting polymer(s) and/or copolymer(s) and non-conducting polymer(s) and/or copolymer(s).

Polymer(s) and/or copolymers can have various structure (e.g., secondary structure) In various examples, polymer(s) and/or copolymer(s) are amorphous, crystalline, or a combination thereof. It may be desirable that the polymer(s) and/or copolymers have low crystallinity.

Polymeric materials include, but are not limited to, polymers and copolymers. The polymers and copolymers may be conducting or non-conducting. Non-limiting examples of polymers and co-polymers include poly(ethylene) (PE), poly(ethylene oxide) (PEO), poly(propylene) (PP), poly(propylene oxide), polymethyl methacrylate (PMMA), polyacrylonitrile (PAN), poly[bis(methoxy ethoxyethoxide}-phosphazene], poly(dimethylsiloxane) (PDMS), cellulose, cellulose acetate, cellulose acetate butylate, cellulose acetate propionate, poly vinylidene difluoride (PVdF), polyvinylpyrrolidone (PVP), polystyrene, sulfonate (PSS), polyvinylchloride (PVC) group, poly(vinylidene chloride) polypropylene oxide, polyvinylacetate, polytetrafluoroethylene (e.g., Teflon®), poly(ethylene terephthalate) (PET), polyimide, polyhydroxyalkanoate (PHA), PEO containing co-polymers (e.g., polystyrene (PS)-PEO copolymers and poly(methyl methacrylate) (PMMA)-PEO copolymers), polyacrylonitrile (PAN), poly(acrylonitrile-co-methylacrylate), PVdF containing co-polymers (e.g. polyvinylidene fluoride-co-hexafluoropropylene (PVdF-co-HFP)), PMMA co-polymers (e.g., poly(methylmethacrylate-co-ethylacrylate)). These non-limiting examples also include derivatives of the polymers and copolymers. In various examples, the polymeric material is a combination of two or more of these polymers.

The polymeric material may be a gel. A gel comprises a polymeric material (e.g., one or more polymer and/or one or more copolymer) and a liquid. Combinations of liquids can be used. In various examples, a liquid is an organic liquid (e.g., ethylene carbonate (EC), diethyl carbonate (DEC), dimethoxyethane (DME), dioxolane (DOL), and the like) or an ionic liquid (e.g., N-Propyl-N-methylpyrrolidinium bis(trifluoromethanesulfonyl) imide (PYR₁₃TFSI), and the like).

The liquid may be a liquid electrolyte. A liquid electrolyte may comprise a metal salt (e.g., one or more lithium salts, one or more sodium salts, one or more magnesium salts, and the like). A non-limiting example of a liquid electrolyte is an aqueous liquid electrolyte. Non-limiting examples of liquid electrolytes include LiPFi (e.g., 1M) in ethylene carbonate (EC); diethyl carbonate (DEC), LiTFSI (e.g., 1M) in dimethoxyethane (DME)/dioxolane (DOL), LiTFSI (e.g., 0.5 M) in N-Propyl-N-methylpyrrolidinium bis(trifluoromethanesulfonyl) imide (PYR₁₃TFSI) ionic liquid, and the like).

A polymeric material may comprise a filler. In an example, the polymeric material comprises one or more ceramic filler (e.g., 2-25 wt % of a ceramic filler based on total weight of the polymeric material). Non-limiting examples of ceramic fillers include conductive particles, non-conductive particles (e.g., Al₂O₃, SiO₂, TiO₂ nanoparticles, and the like), ceramic nanomaterials (e.g., ceramic nanoparticles, ceramic nanofibers, and the like), and the like. A ceramic nanomaterial may have the composition of an inorganic material disclosed herein.

In an aspect, the present disclosure provides methods of making inorganic fibers or strands. The fibers or strands can form an inorganic SSE. In various examples, the methods are templating methods or electrospinning methods.

Strands can be formed using a templating method. A template comprises continuous void spaces that can used to form strands of inorganic materials that can form an inorganic solid-state electrolyte (e.g., solid-state hybrid electrolyte). The void spaces may be man-designed or naturally occurring in a biological material (e.g., wood, plant, and the like).

The template method provides a simple but effective way to generate the necessary structure, wherein a textile template is contacted (e.g. soaked) with one or more inorganic SSE material precursor followed by an optional heating step to react the precursors(s) and a thermal treatment (e.g., pyrolysis) to remove the organic components. The resulting fibrous inorganic material can exhibit desirable properties that allow for integration in either flexible or rigid battery configurations. For example, inorganic material strands or fiber networks established lithium-ion migration pathways within polymeric materials to improve the mechanical strength of the polymeric materials. Alternatively, the inorganic material (e.g., ceramic) textile can be combined with electrode materials in interdigitated or concentric arrangements to minimize electrolyte volume and maximize electrode utilization, thereby increasing active electrolyte area, lithium-ion interfacial transport, and tolerance for electrode volume change during charging/discharging.

The templating methods provides porous (e.g., nanoporous and/or microporous) inorganic SSEs comprising a plurality of strands. The strands may have the general shape (e.g., cylindrical or substantially cylindrical, polyhedral or substantially polyhedral shaped, irregularly shaped, or the like) of the template used to form the individual strands. For example, the strands have a length ranging from micrometers to meters and/or a greatest cross-sectional dimension (e.g., diameter) ranging from nanometers to micrometers.

The pores of the inorganic SSE electrolyte (e.g., the pore size, pore size distribution, pore morphology, etc.) can vary based on the method (e.g., template or electrospinning used). In the case of templating methods, the pores may be formed by removal of the template material (e.g. have a size and/or shape corresponding to the templated material). In the case of electrospinning, the pores may be formed by void spaces formed by the fibers. For example, in the case of an inorganic SSE formed using a templating method, at least a portion of or all of the pores have at least one dimension of 1-100 microns. For example, in the case of an inorganic SSE formed using an electrospinning, at least a portion of or all of the pores have at least one dimension of 1 nm to 500 microns.

In various examples, the pores of the solid-state hybrid electrolyte and/or, if present, the strands (e.g., a portion of the strands or all of the strands) of the solid-state hybrid electrolyte and/or the pores of the solid-state hybrid electrolyte are aligned or all substantially aligned. By “aligned” it is meant that the strands and/or pores of the inorganic SSE are arranged such than a longitudinal axis of each strand is parallel or within 30 degrees, within 20 degrees, within 15 degrees, within 10 degrees, or within 5 degrees of parallel) to longitudinal axes of adjacent strands. In an example, the strands and/or pores are not arranged end to end. By substantially aligned it is meant that at least 50%, at least 60%, at least 70, 80%, at least 90%, at least 95%, at least 99% of the strands are aligned.

As an illustrative example, when a solid-state hybrid electrolyte formed using a biomaterial template (e.g., a wood template, plant template, or the like) is used in a battery with planar, discrete electrodes, the individual strands are generally aligned perpendicular (e.g., perpendicular) to a plane defined by one or both of the electrodes and the pores are generally aligned perpendicular (e.g., perpendicular) to a plane defined by one or both of the electrodes.

In various examples, the strands (e.g., a portion of the strands or all of the strands) of inorganic SSE are arranged as a fabric. e.g., arranged as a woven fabric, a braided fabric, and the like. The strands of the inorganic SSE may take the general structure of the textile template used to fabricate the inorganic SSE. The dimensions of the inorganic SSE may be substantially smaller than those of the textile template.

As an illustrative example, when a solid-state hybrid electrolyte formed using a carbon template (e.g., a textile template or the like) is used in a battery with planar, discrete electrodes, the individual strands of the inorganic SSE are generally aligned parallel (e.g., are parallel) to a plane defined by one or both of the electrodes and the pores of the inorganic SSE are aligned perpendicular to a plane defined by one or both of the electrodes.

In various examples, a templating method of forming an inorganic solid-state electrolyte (e.g., solid-state hybrid electrolyte) comprises:
contacting a template with one or more SSE material precursors;
optionally. reacting the SSE material precursor(s) to form a solid inorganic material (e.g., comprising at least partially or completely reacted and/or decomposed SSE material precursors); and
thermally treating the template with the solid inorganic material, wherein the template is removed (e.g., as carbon dioxide) and the inorganic SSE (e.g., monolithic SSE or mesoporous body or F/S SSE) is formed; and
contacting the calcined template with a polymeric material, where in the case of a monolithic SSE or mesoporous body, to form a layer on the inorganic SSE material (and, optionally, at least partially fill or fill the pores exposed on a surface of the inorganic SSE material) or, in the case of a F/S SSE, the polymeric material at least partially or completely fills the pores of the F/S SSE (e.g., pores which correspond to the template).

In various examples, a templating method of forming an inorganic solid-state electrolyte (e.g., solid-state hybrid electrolyte) comprises:
contacting (e.g., infiltrating) a biomaterial template with one or more SSE material precursor (e.g. one or more inorganic SSE material sol-gel precursor), where one or more or all of the aligned channels of the biomaterial template (e.g., a compressed biomaterial template) are at least partially or completely filled with the SSE material precursor(s);
optionally. reacting (e.g., heating) the SSE material precursor filled template to form a solid inorganic material (e.g., comprising at least one or all partially or completely reacted and/or decomposed inorganic SSE material sol-gel precursors);
thermally treating the heated template, where substantially all or all of the template material is removed and an inorganic SSE material is formed;
contacting the calcined template with a polymeric material, wherein the polymeric material at least partially fills the nanopores and/or micropores of the inorganic SSE.

In various examples, a templating method of forming an inorganic solid-state electrolyte (e.g., solid-state hybrid electrolyte) comprises:
contacting a carbon template with one or more inorganic SSE material precursors (e.g., one or more metal salts);
optionally. reacting (e.g., heating) the carbon template contacted carbon template to form a solid inorganic material (e.g., a plurality of nanoparticles of inorganic material);
thermally treating the template, where substantially all or all of the template material is removed and an inorganic SSE material is formed;
contacting (e.g., infiltrating) the inorganic SSE with a polymeric material, wherein the polymeric material at least partially fills the nanopores and/or micropores of the template.

Various templates can be used. The templates are formed from polymers (e.g., biologically derived polymers (e.g., cellulose, protein fibers, and the like), man-made polymers (e.g., PET, polyamides such, for example, Nylon, regenerated cellulose such as, for example, Rayon, polyesters, and the like), and the like. The templates may have a hierarchical interconnected structure comprising interconnected nanoscale and/or microscale voids. For example, the template is a low tortuosity template (e.g., a low tortuosity template formed using a wood template). The template can be a biological material (e.g., wood, plants, and the like) or a man-made template, which can formed using methods such as, for example, tape casting, screen printing, extrusion, 3-D printing, weaving, knitting, non-woven methods, and the like. In the methods, all or substantially all of the template is removed (i.e., it is a sacrificial template). For example, the template is removed by thermal treatment.

Various carbon templates can be used. Examples of carbon templates include, but are not limited to, textile templates, paper templates, foam templates, and the like). A carbon template may be a textile. In various examples, a textile is a fabric. A fabric may comprise various weaves, braids, and like, or be non-woven. In the case of woven fabrics, the woven fabric may be of any weave pattern.

Various biomaterial templates can be used. A biomaterial template may be a wood template, plant template, or the like.

Various wood and plant templates can be used. A wood or plant template comprises a plurality nanochannels and/or microchannels. The plurality of nanochannels and/or microchannels are interconnected to form a three-dimensional network with at least one node. A wood template may be a compressed wood template. Typically, a wood template is formed by removal of at least a portion or all of the lignin from a piece of wood having a size and shape appropriate for forming an F/S SSE. Removal of the lignin forms a template (e.g., a template with an aligned, porous nanostructure) with a plurality of aligned channels (e.g., channels having a cross-sectional size (e.g., a longest dimension such as, for example, a diameter) of 1 nm to 10 microns, including all integer nm values and ranges therebetween). Compression of the template in the can reduce the cross-section of the nanochannels and/or microchannels. The lignin can be removed by chemical treatment. Suitable treatments are known in the art. For example, the lignin is removed by contacting a wood sample with an aqueous base. Wood templates can be formed from various woods such as, for example, basswood, balsa wood, and the like.

The fibers of an inorganic SSE can be formed using electrospinning. Suitable methods of electrospinning are known in the art. The electrospinning can be carried out using methods known in the art.

The inorganic SSE material precursors may be reacted (e.g., at least partially or completely reacted and or thermally degraded) to form, for example, a solid inorganic material (which may comprise reside such as, for example, carbon-based residue) of one or more of the precursors. The inorganic material may be thermally treated to provide an inorganic SSE material.

In various examples, an electrospinning method of forming an inorganic solid-state electrolyte (e.g., solid-state hybrid electrolyte) comprises:
electrospinning a precursor solution comprising an electrospinning polymer and one or more inorganic SSE precursor material to provide nanofibers comprising the polymer and one or inorganic SSE precursor material;
thermally treating the nanofibers, where all or substantially all of the polymer of the nanofibers is removed and an inorganic SSE material is formed; and
contacting the inorganic SSE with a polymeric material, wherein the polymeric material at least partially fills the void spaces of the inorganic SSE material.

Various electrospinning polymers can be used. Suitable electrospinning polymers are known in the art. Non-limiting examples of electrospinning polymers include polyvinylpyrrolidone (PVP), polyarcrylonitrile (PAN), poly(ethylene oxide) (PEO) or polyvinylchloride (PVC), and the like.

Various inorganic SSE precursor materials can be used. Non-limiting examples of inorganic SSE precursor materials include sol-gel precursors, metal salts, and the like. The SSE material precursor may one or more sol-gel precursors or one or more metal salts that on reaction, e.g., beating, provide an inorganic SSE of a desired composition. Examples of suitable sol-gel precursors and combinations of sol-gel precursors are known in the art. Examples of suitable metal salts and combinations of metal salts are known in the art. In various examples, a thermal treatment comprises sintering and/or a calcining the inorganic SSE material precursor(s) or reacted (e.g., at least partially reacted or completely reacted) inorganic SSE material precursor(s).

A thermal treatment removes (e.g., pyrolyzes) the template material. The thermal treatment as least partially (e.g., substantially) removes or complete removes the template material to provide and inorganic SSE. In various examples, a thermal treatment is carried out at 700-1000° C. in an air atmosphere or an atmosphere comprising oxygen.

In an aspect, the present disclosure provides uses of solid-state hybrid electrolytes of the present disclosure. The solid-state hybrid electrolytes can be used in various devices. In various examples, a device comprises one or more solid-state hybrid electrolyte of the present disclosure. Non-limiting examples of devices include electrolytic cells, electrolysis cells, fuel cells, batteries, and other electrochemical devices such as, for example, sensors, and the like.

A device may be a battery. A battery may be an ion-conducting battery. The battery may be configured for applications such as, portable applications, transportation applications, stationary energy storage applications, and the like. Non-limiting examples of ion-conducing batteries include lithium-ion conducting batteries, sodium-ion conducting batteries, magnesium-ion conducing batteries, and the like.

In various examples, a battery (e.g., an ion-conducting battery such as, for example, a solid-state, ion-conducting battery) comprises a solid-state hybrid electrolyte of the present disclosure, an anode, and a cathode, where the solid-state hybrid electrolyte is disposed between the anode and cathode. In an example, the polymeric material of the solid-state hybrid electrolyte is disposed between the inorganic SSE material of the solid-state hybrid electrolyte and the anode and/or cathode.

An inorganic SSE material can be used in a conventional ion-conducting battery, e.g., an ion-conducting battery comprises an electrolyte as the principle electrolyte. A conventional ion-conducting battery comprises a non-conducting (e.g., non-ion conducting) separator. Accordingly, in an example, a battery comprises an inorganic SSE material disclosed herein (e.g., an F/S SSE, which may be a templated inorganic SSE or an electrospun inorganic SSE) or a solid-state hybrid electrode disclosed herein (e.g., an F/S SSE), and electrolyte. The electrolyte may be any electrolyte used in conventional ion-conducting (e.g., lithium-ion conducing) batteries known in the art. Non-limiting examples of electrolytes for conventional batteries include liquids such as, for example, organic liquids, gels, polymers, and the like. In various examples, the liquid electrolyte is not part of the solid-state hybrid electrolyte (e.g., part of the polymeric material such as, for example, a gel polymer of the solid-state hybrid electrolyte). In this case, the inorganic SSE material or solid-state hybrid electrode is a separator in the conventional battery. In various examples, the inorganic SSE material or solid-state hybrid electrode replaces the separator in a conventional battery. Unlike typical separators used in conventional batteries, the inorganic SSE material or solid-state hybrid electrode both separates the cathode and anode and is ion-conducting. In various examples, the inorganic SSE material or solid-state hybrid electrode is an ion-conducting separator in a conventional battery. Various electrodes (e.g., cathodes and anodes) can be used. Individual electrodes (e.g., cathode and/or anode) can be independent (e.g., separated from) the solid-state hybrid electrolyte (e.g., a planar electrode) or integrated with the solid-state hybrid electrolyte. In the case of an integrated electrode, the solid-state hybrid electrolyte (e.g., monolithic SSE or mesoporous SSE body) has one or more porous regions exposed to the surface of the solid-state hybrid electrolyte and an electrode is formed by an electrode material (e.g., cathode material and/or anode material) disposed in pores of a discrete porous region of the solid-state hybrid electrolyte.

The cathode and anodes can be formed from various materials (e.g., cathode materials or anode materials, respectively). Examples of suitable cathode materials and anode materials are known in the art.

A cathode comprises one or more cathode material in electrical contact with the solid-state hybrid electrolyte Various cathode materials can be used Combinations of cathode materials may be used. For example, the cathode material is an ion-conducting material that stores ions by mechanisms such as intercalation or reacts with the ion to form a secondary phase (e.g., an air or sulfide electrode). Examples of suitable cathode materials are known in the art.

In the case of an integrated cathode, the cathode material is disposed on at least a portion of a surface (e.g., a pore surface of one of the pores) of a porous region of the solid-state hybrid electrolyte. The cathode material may at least partially fill one or more pores (e.g., a majority of the pores) of a porous region or one of the porous regions of the ion-conducting, solid-state electrolyte material. In an example, the cathode material is infiltrated into at least a portion of the pores of the porous region of the ion-conducting, solid-state electrolyte material.

In an example, the cathode material is disposed on at least a portion of the pore surface of the cathode side of the porous region of a porous SSE material, where the cathode side of the porous region of SSE material is opposed to an anode side of the porous region of the porous SSE material on which the anode material is disposed.

In various examples, the cathode comprises a conducting carbon material. Non-limiting examples of carbon materials include graphite, hard carbon, porous hollow carbon spheres and tubes, and the like. The cathode material may further comprises an organic or gel ion-conducting electrolyte. Suitable organic or gel ion-conducting electrolytes are known in the art.

It may be desirable to use an electrically conductive material as part of the ion-conducting cathode material. In an example, the ion-conducting cathode material also comprises an electrically conducting carbon material (e.g., graphene or carbon black), and the ion-conducting cathode material, optionally, further comprises an organic or gel ion-conducting electrolyte. The electrically conductive material may separate from the ion-conducting cathode material. For example, electrically conductive material (e.g., graphene, carbon nanotubes, and the like) is disposed on at least a portion of a surface (e.g., a pore surface) of the porous region of the ion-conducting. SSE electrolyte material and the ion-conducting cathode material is disposed on at least a portion of the electrically conductive material (e.g., graphene, carbon nanotubes, and the like).

In various other examples, the cathode comprises a sulfur-containing material. In an example, the cathode material is an organic sulfide or polysulfide. Examples of organic sulfides include carbyne polysulfide and copolymerized sulfur. Non-limiting examples of sulfur-containing materials include sulfur, sulfur composite materials (e.g., carbyne polysulfide, copolymerized sulfur, and the like), and polysulfide materials, and the like.

In an example, the cathode is an air electrode. Examples of materials suitable for air electrodes include those used in ion-conducting batteries such as, for example, lithium ion batteries with air cathodes such as large surface area carbon particles (e.g., Super P which is a conductive carbon black) and catalyst particles (e.g. alpha-MnO₂ nanorods) bound in a mesh (e.g., a polymer binder such as PVDF binder).

The cathode material may be a lithium ion-conducting material. Non-limiting examples of lithium ion-conducting cathode materials include lithium nickel manganese cobalt oxides (e.g., NMC, LiNiₓMn_{y}Co_{z}O₂, where x+y+z=1, such as, for example. Li(NiMnCo)_{1/3}O₂), LiCoO₂, LiNi_{1/3}Co_{1/3}Mn_{1/3}O₂, LiNi_{0.5}Co_{0.2}Mn_{0.3}O₂, lithium manganese oxides (LMOs) (e.g., LiMn₂O₄ and LiNi_{0.5}Mn_{1.5}O₄), lithium iron phosphates (LFPs) (e.g., LiFePO₄), LiMnPO₄, LiCoPO₄, and Li₂MMn₃O₈, wherein M is selected from Fe, Co, and the like.

The cathode material may be a sodium ion-conducting material. Non-limiting examples of sodium ion-conducting cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂@graphene composite.

The cathode material may be a magnesium ion-conducting material. Non-limiting examples of magnesium ion-conducting cathode materials include doped manganese oxide (e.g., MgₓMnO₂·_{y}H₂O), Mg₁₊ₓ(Al, Ti)₂(PO₄)₆, where x is 4 to 5. NASICON-type magnesium-ion conducting materials, and the like).

An anode comprises one or more anode material in electrical contact with the porous region of the solid-state hybrid electrolyte. For example, the anode material is the metallic form of the ion conducted in the solid state electrolyte (e.g, metallic lithium for a lithium-ion battery) or a compound that intercalates the conducting ion (e.g., lithium carbide, Li₆C, for a lithium-ion battery). Examples of suitable anode materials are known in the art.

In the case of an integrated anode, the anode material is disposed on at least a portion of a surface (e.g., a pore surface of one of the pores) of the porous region of the solid-state hybrid electrolyte. The anode material may at least partially fill one or more pores (e.g., a majority of the pores) of the porous region of the solid-state hybrid electrolyte. In an example, the anode material is infiltrated into at least a portion of the pores of the porous region of the solid-state hybrid electrolyte.

In an example, the anode material is disposed on at least a portion of the pore surface of an anode-side porous region of the solid-state hybrid electrolyte, where the anode side of the solid-state hybrid electrolyte is opposed to a cathode side of the solid-state hybrid electrolyte on which the cathode material is disposed.

In various examples, the anode comprises (or consists of) a conducting carbon material. Non-limiting examples of carbon materials include graphite, hard carbon, porous hollow carbon spheres and tubes, and the like. The anode material may further comprises an organic or gel ion-conducting electrolyte. Suitable organic or gel ion-conducting electrolytes are known in the art.

The anode material may be a conducting material. Non-limiting examples of conducting materials include conducting carbon materials, tin and its alloys, tin/carbon, tin/cobalt alloys, silicon carbon materials, and the like. Non-limiting examples of conducing carbon materials include graphite, hard carbon, porous hollow carbon spheres and tubes (e.g. carbon nanotubes), and the like.

The anode may be a metal. Non-limiting examples of metals include lithium metal, sodium metal, magnesium metal, and the like.

The anode material may be a lithium-containing material. Non-limiting examples of lithium-containing materials include lithium metal, lithium carbide, Li₆C, and lithium titanales (LTOs) (e.g., Li₄Ti₅O₁₂, and the like).

The anode material may be a sodium-containing material. Non-limiting examples of anode materials include sodium metal, and ion-conducting sodium-containing anode materials such as Na₂C₈H₄O₄ and Na_{0.66}Li_{0.22}Ti_{0.78}O₂.

The anode material may be a magnesium-containing material. In an example, the anode material is magnesium metal.

The batteries may comprise current collector(s). For example, a battery comprises a cathode-side (first) current collector disposed on the cathode-side of a solid-state hybrid electrolyte and an anode-side (second) current collector disposed on the anode-side of the solid-state hybrid electrolyte. The current collector are each independently fabricated of a metal (e.g., aluminum, copper, or titanium) or metal alloy (aluminum alloy, copper alloy, or titanium alloy).

The batteries may comprise various additional structural components (such as, for example, bipolar plates, external packaging, electrical contacts/leads to connect wires, and the like). In an example, a battery further comprises bipolar plates. In various examples, a battery further comprises bipolar plates and external packaging, and electrical contacts/leads to connect wires. In an example, repeat battery cell units are separated by a bipolar plate.

The solid-state hybrid electrolyte, cathode, anode, the cathode-side (first) current collector (if present), and the anode-side (second) current collector (if present) may form a cell. A battery may comprise a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges therebetween.

The steps of the methods described in the various embodiments and examples disclosed herein are sufficient to carry out the methods of the present disclosure. Thus, in an example, a method consists essentially of a combination of steps of the methods disclosed herein. In another example, a method consists of such steps.

The following Statements provide examples of the solid-state hybrid electrolytes of the present disclosure and uses thereof.

Statement 1. A hybrid electrolyte (e.g., a solid-state hybrid electrolyte) comprising:
a SSE (e.g., an inorganic (e.g., ceramic) SSE) disclosed herein (or comprising an inorganic SSE material disclosed herein); and
a polymeric material disclosed herein disposed on at least a portion of an exterior surface of or all of the exterior surfaces of the solid-state electrolyte (e.g., solid-state electrolyte material).
   Statement 2. A hybrid electrolyte according to Statement 1, where the SSE material is a monolithic (e.g., a porous monolithic, a dense monolithic) SSE body or a mesoporous SSE body disclosed herein. Examples of mesoporous SSE body materials include bilayer and Inlayer materials comprising one or more porous SSE material layers disposed on a dense SSE material layer).
   Statement 3. A hybrid electrolyte according to Statement 1 or Statement 2, where the SSE material is a disc, a sheet, or a polyhedron (e.g., has a polyhedral shape).
   Statement 4. A hybrid electrolyte the according to any one of the preceding Statements, where the polymeric material has at one or more points a thickness of 10 nm-10 microns (e.g., 5-10 microns).
   Statement 5. A hybrid electrolyte according to any one of the preceding Statements, where the SSE comprises a plurality of fibers or strands (e.g., a plurality of non-woven strands or a plurality of woven strands).
   Statement 6. A hybrid electrolyte according to Statement 5, where the fibers are present as a woven substrate.
   Statement 7. A hybrid electrolyte according to Statement 5 or Statement 6, where the fibers are randomly arranged or aligned.
   Statement 8. A hybrid electrolyte according to any one of Statements 5-7, where the fibers or strands of the polymeric material form an interconnected 3-D network.
   Statement 9. A hybrid electrolyte according to any one of the preceding Statements, where the SSE material comprises a lithium-ion conducting (e.g., lithium-ion containing) SSE material, a sodium-ion conducting (e.g., sodium-ion containing) SSE material, or a magnesium-ion conducting (e.g., magnesium-ion containing) SSE material.
   Statement 10. A hybrid electrolyte according to Statement 9, where the lithium-ion conducting SSE material is selected from the group consisting of lithium perovskite materials, LisN. Li-β-alumina, Lithium Super-ionic Conductors (LISICON), Li_{2.88}PO_{3.36}N_{0.14} (LiPON), Li₉AlSiO₈, Li₁₀GeP₂S₁₂, lithium garnet materials, doped lithium garnet materials, lithium garnet composite materials, and combinations thereof.
   Statement 11. A hybrid electrolyte according to Statement 10, where the lithium garnet material is cation-doped Li₅ La₃M¹₂O₁₂, where M¹ is Nb, Zr, Ta, or combinations thereof, cation-doped Li₆La₂BaTa₂O₁₂, cation-doped Li₇La₃Zr₂O₁₂, and cation-doped Li₆BaY₂M¹₂O₁₂, where M¹ is Nb, Zr, Ta, or combinations thereof, and where cation dopants are barium, yttrium, zinc, or combinations thereof.
   Statement 12. A hybrid electrolyte according to Statement 10, where the lithium garnet material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa₂Ta_{1.75}Zn_{0.25}O₁₂, and combinations thereof.
   Statement 13. A hybrid electrolyte according to Statement 9, where the sodium-ion conducting SSE material is selected from the group consisting of β″—Al₂O₃, Na₄Zn₂Si₂PO₁₂ (NASICON), cation-doped NASICON, and combinations thereof.
   Statement 14. A hybrid electrolyte according to Statement 9, where the magnesium-ion conducting SSE material is selected from the group consisting of Mg₁₊ₓ(Al,Ti)₂(PO₄)₆, where x is 4 to 5, NASICON-type magnesium-ion conducting materials, and combinations thereof.
   Statement 15. A hybrid electrolyte according to any one of the preceding Statements, where the inorganic SSE has pores exposed to an exterior surface of the inorganic SSE and the hybrid electrolyte further comprises at least one cathode material and/or at least one anode material disposed in at least a portion of the pores, and wherein in the case where at least one cathode material and at least one anode material is disposed in at least a portion of the pores the at least one cathode material and at least one anode material are disposed in discrete and electrically separated regions of the inorganic SSE.
   Statement 16. A hybrid electrolyte according to any one of the preceding Statements, where the polymeric material comprises (e.g., the polymeric material is) a polymer selected from the group consisting of poly(ethylene) (PE), poly(ethylene oxide) (PEO), poly(propylene) (PP), poly(propylene oxide), polymethyl methacrylate (PMMA), polyacrylonitrile (PAN), poly[bis(methoxy ethoxyethoxide}-phosphazene], poly(dimethylsiloxane) (PDMS), cellulose, cellulose acetate, cellulose acetate butylate, cellulose acetate propionate, poly vinylidene difluoride (PVdF), poly vinylpyrrolidone (PVP), polystyrene, sulfonate (PSS), polyvinylchloride (PVC) group, poly(vinylidene chloride) polypropylene oxide, polyvinylacetate, polytetrafluoroethylene (e.g., Teflon®), poly(ethylene terephthalate) (PET), polyimide, polyhydroxyalkanoate (PHA), PEO containing co-polymers (e.g., polystyrene (PS)—PEO copolymers and poly(methyl methacrylate) (PMMA)—PEO copolymers), polyacrylonitrile (PAN), poly(acrylonitrile-co-methylacrylate), PVdF containing co-polymers (e.g., polyvinylidene fluoride-co-hexafluoropropylene (PVdF-co-HFP)), PMMA co-polymers (e.g., poly(methylmethacrylate-co-ethylacrylate)), derivatives thereof, and combinations thereof.
   Statement 17. A hybrid electrolyte according to any one of the preceding Statements, where the polymeric material is a gel (e.g., a gel comprising 60 to 80 wt. % of a liquid based on the total weight of the polymeric material).
   Statement 18. A hybrid electrolyte according to any one of the preceding Statements, where the liquid is a liquid electrolyte (e.g., non-aqueous liquid electrolytes such as, for example. LiPF₆ (e.g., 1M) in ethylene carbonate (EC)/diethyl carbonate (DEC), LiTFSI (e.g., 1M) in dimethoxyethane (DME)/dioxolane (DOL), LiTFSI (e.g., 0.5 M) in N-Propyl-N-methylpyrrolidinium bis(trifluoromethanesulfonyl) imide (PYR₁₃TFSI) ionic liquid, and the like).
   Statement 19. A hybrid electrolyte according to Statement 17 or Statement 18, where the polymeric material of the gel comprises (e.g., the polymeric material is) a polymer selected from the group consisting of polyvinylidene fluoride (PVDF), polyvinylidene fluoride-co-hexafluoropropylene (PVdF-co-HFP), polyvinylpyrrolidone (PVP), PEO, PMMA, PAN, polystyrene (PS), polyethylene (PE), and combinations thereof.
   Statement 20. A hybrid electrolyte according to any one of the preceding Statements, where the polymeric material comprises a metal salt (e.g., a metal salt selected from the group consisting of lithium salts, sodium salts, magnesium salts, and the like).
   Statement 21. A hybrid electrolyte according to any one of the preceding Statements, where the polymeric material comprises a ceramic filler (e.g., 2-25 wt % based on total weight of the polymeric material).
   Statement 22. A hybrid electrolyte according to Statement 21, where the ceramic filler is selected from the group consisting of conductive particles, non-conductive particles (e.g., Al₂O₃, SiO₂, TiO₂nanoparticles, and the like), ceramic nanomaterials (e.g., ceramic nanoparticles, ceramic nanofibers), and the like.
   Statement 23. A device comprising one or more hybrid electrolyte of the present disclosure (e.g., a hybrid electrolyte of any one of Statements 1-22).
   Statement 24. A device according to Statement 23, where the device is a battery (e.g., an ion-conducting battery such as, for example, a solid-state, ion-conducting battery) comprising:
a hybrid electrolyte of the present disclosure (e.g., a hybrid electrolyte of any one of Statements 1-22);
an anode; and
a cathode,
   where the hybrid electrolyte is disposed between the cathode and anode (e.g., the polymeric material of the hybrid electrolyte is disposed between, for example, fills substantially all of the void space between, the SSE material of the hybrid electrolyte and the anode and/or cathode).
   Statement 25. A device according to Statement 24, where the battery further comprises a current collector disposed on at least a portion of the cathode and/or the anode.
   Statement 26. The device of claim 25, wherein the current collector is a conducting metal or metal alloy.
   Statement 27. A device according to any one of Statements 24-26, where the battery is a lithium-ion conducting solid-state battery and the hybrid electrolyte is a lithium ion-conducting (e.g., lithium containing) SSE material (e.g., a lithium-conducting (e.g., lithium containing) SSE material of any one of Statements 11-13).
   Statement 28. A device according to any one of Statements 24-26, where the battery is a sodium-ion conducting solid-state battery and the hybrid electrolyte is a sodium ion-conducting (e.g., sodium containing) SSE material (e.g., a sodium-ion conducting (e.g., sodium containing) SSE material of Statement 14).
   Statement 29. A device according to any one of Statements 24-26, where the battery is a magnesium-ion conducting solid-state battery and the hybrid electrolyte is a magnesium ion-conducting (e.g., magnesium containing) SSE material (e.g., a magnesium-ion conducting (e.g., magnesium containing) SSE material of Statement 15).
   Statement 30. A device according to any one of Statements 24-29, where the cathode and/or anode comprises a conducting carbon material (e.g., graphite, hard carbon, porous hollow carbon spheres and tubes, and the like), and the cathode material, optionally, further comprises an organic or gel ion-conducting electrolyte.
   Statement 31. The device according to any one of Statements 24-29, where the cathode comprises a material selected from sulfur, sulfur composite materials (e.g., carbynepolysulfide, copolymerized sulfur, and the like), and poly sulfide materials, or the cathode is air.
   Statement 32. A device according to Statement 27, where the cathode (e.g., lithium ion-conducting, lithium-containing cathode) comprises a material selected from the group consisting of lithium-containing materials.
   Statement 33. A device according to Statement 32, where the lithium-containing cathode material is selected from the group consisting of lithium nickel manganese cobalt oxides (e.g., NMC, LiNiₓMn_{y}Co_{z}O₂, where x+y+z=1, such as, for example, Li(NiMnCo)_{1/3}O₂). LiCoO₂, LiNi_{1/3}Co_{1/3}Mn_{1/3}O₂, LiNi_{0.5}Co_{0.2}Mn_{0.3}O₂, lithium manganese oxides (LMOs) (e.g., LiMn₂O₄ and LiNi_{0.5}Mn_{0.5}O₄), lithium iron phosphates (LFPs) (e.g., LaFePO₄), LiMnPO₄, LiCoPO⁴, and Li₂MMn₃O₈, wherein M is selected from Fe, Co, and combinations thereof.
   Statement 34. A device according to Statement 28, where cathode (e.g., a sodium ion-conducting, sodium-containing cathode) comprises a material selected from sodium-containing cathode materials.
   Statement 35. A device according to Statement 34, where the sodium-containing cathode material is selected from the group consisting of Na₂V₂O₅, P2-Na_{1/3}Fe_{1/2}Mn_{1/2}O₂, Na₃V₂(PO₄)₃, NaMn_{1/3}Co_{1/3}Ni_{1/3}PO₄, and Na_{2/3}Fe_{1/2}Mn_{1/2}O₂@graphene composite.
   Statement 36. A device according to Statement 29, wherein the cathode (e.g., a magnesium ion-conducting, magnesium-containing cathode) comprises a material selected from the group consisting of doped magnesium oxides (e.g., Mg₁₊ₓ(Al,Ti)₂(PO₄)₆, where x is 4 to 5, NASICON-type magnesium-ion conducting materials, and the like).
   Statement 37. A device according to any one of Statements 24-36, where the anode comprises a material selected from the group consisting of silicon-containing materials (e.g., silicon, silicon/carbon, and the like), tin and its alloys (e.g., tin/cobalt alloys and the like), tin/carbon, and phosphorus.
   Statement 38. A device according to any one of Statements 24-27 and 31-33, where the anode (e.g., a lithium ion-conducting anode and lithium containing anode) comprises a material selected from the group consisting of lithium-ion conducting anode materials.
   Statement 39. The device of claim 38, where the lithium ion-conducting anode material is a lithium containing material selected from the group consisting of lithium carbide, Li₆C, and lithium titanates (ITOs) (e.g., Li₄Ti₅O₁₂, and the like).
   Statement 40. A device according to Statement 38, where the anode is lithium metal.
   Statement 41. A device according to any one of Statements 24-26, 28, and 34-35, where the anode (e.g., a sodium-containing and sodium ion-conducting anode) comprises a material selected from sodium-ion conducting anode materials.
   Statement 42. A device according to Statement 41, where the sodium-containing anode material is selected from the group consisting of Na₂C₈H₄O₄ and Na_{0.66}Li_{0.22}Ti_{0.78}O₂.
   Statement 43. A device according to Statement 41, where the anode is sodium metal.
   Statement 44. A device according to any one of Statements 24-26, 29, and 36, where the anode is a magnesium-containing anode material.
   Statement 45. A device according to Statement 44, where the anode is magnesium metal.
   Statement 46. A device according to any one of Statements 24-45, where the hybrid electrolyte, cathode, anode, and, optionally, the current collector form a cell, and the battery comprises a plurality of the cells and each adjacent pair of the cells is separated by a bipolar plate.
   Statement 47. A device according to any one of Statements 23-46, wherein the device is a conventional ion-conducting battery comprising a liquid electrolyte (e.g., as the principle electrolyte) and the battery comprises an inorganic SSE disclosed herein or a solid-state hybrid electrolyte disclosed herein and a liquid electrolyte (e.g., a liquid electrolyte used in a conventional battery), where the liquid electrolyte is not present as component of the solid-state hybrid electrolyte, and where the inorganic SSE material or the solid-state hybrid electrolyte is a separator in the conventional battery.
   Statement 48. The device according to Statement 47, wherein the inorganic SSE is an F/S SSE disclosed herein (e.g., templated inorganic SSE or an electrospun inorganic SSE)
   Statement 49. A method of making a hybrid electrolyte (e.g., a solid-state hybrid electrolyte) (e.g., a hybrid electrolyte of any one of Statements 1-22) comprising:
contacting a template with one or more SSE material precursors;
reacting (e.g., by heating) the SSE material precursor(s) to form a solid inorganic material (e.g., comprising at least partially or completely reacted and/or decomposed SSE material precursors); and
thermally treating (e.g., sintering and/or calcining) the template with the solid inorganic material, where the template is removed (e.g., as carbon dioxide, for example, by combustion) and the inorganic SSE (e.g., monolithic SSE or mesoporous body of F/S SSE) is formed; and
contacting (e.g., infiltrating) the calcined template with a polymeric material, wherein in the case of a monolithic SSE or mesoporous body, to form a layer on the inorganic SSE material (and, optionally, at least partially fill or fill the pores exposed on a surface of the inorganic SSE material) or, in the case of a F/S SSE, the polymeric material at least partially or completely fills the pores of the F/S SSE (e.g. pores which correspond to the template).
   Statement 50. The method according to Statement 49, where the SSE material precursors are sol-gel precursors or metal salts.
   Statement 51. The method according to Statement 49 or Statement 50, where the template is a carbon template (e.g., a textile template) or a biomaterial template (e.g., a wood or plant template).

The following examples are presented to illustrate the present disclosure. They are not intended to limiting in any matter.

### Example 1

This example provides a description of solid-state hybrid electrolytes of the present disclosure. This example also provides examples of making and characterization of such electrolytes.

Reduced Interfacial Resistance of Hybrid Polymer/Garnet-type Electrolyte System for Lithium-Metal Batteries. Garnet-type solid state electrolyte has demonstrated promising results for Li metal batteries, due to its high ionic conductivity (10⁻⁴ S/cm˜10⁻³ S/cm) and wide electrochemically stable window (0˜6 V vs. Li⁺/Li). One of the main challenges for garnet-type solid state electrolyte is the high interfacial resistance between the electrolyte and electrodes. This examples described a hybrid electrolyte with a solid state Li₇La_{2.75}Ca_{0.25}Zr_{1.75}Nb_{0.25}O₁₂ (LLCZN) garnet-type electrolyte between two gel polymer electrolyte layers to decrease the interfacial resistance of a lithium metal symmetric cell and protect against dendrite penetration. The gel polymer electrolyte layers form favorable interfaces between the garnet solid state electrolyte (SSE) and the electrodes with low interfacial resistance and long term electrochemical stability. The hybrid gel polymer and LLCZN electrolyte achieves low interfacial charge transfer resistance around 248 Ω×cm² at the SSE/Cathode interface and 214 Ω×cm² at the SSE/Li metal interface. A distinct advantage of this design is that the hybrid electrolyte can prevent lithium dendrite formation, because of the dense LLCZN garnet layer. Our results show that the hybrid symmetric cells can run with stable stripping and plating profiles for long periods of cycling. In addition, this hybrid electrolyte can be used for Li metal batteries with small over potentials and increased reliability against dendrite short circuiting. The hybrid electrolyte design with gel polymer interface layers is an exciting surface engineering solution to combat the garnet solid state interface resistance and demonstrate safe Li metal batteries with high performance capabilities.

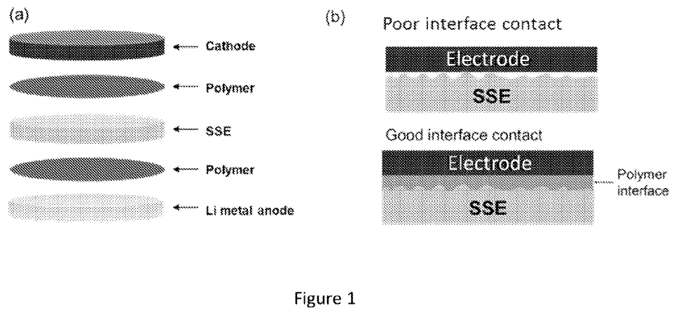

A hybrid electrolyte with gel polymer electrolyte as interfacial layers in between LLCZN garnet SSE is proposed to reduce the interfacial resistance and demonstrate Li metal full cells that can operate at room temperature. FIG. 1a shows a schematic of the solid-polymer Li metal battery design using the polymer/garnet-type SSE hybrid electrolyte. In the battery, gel polymer is used as interfacial layers, in between of garnet-type SSE and electrodes, to reduce interfacial resistance. Gel polymer electrolyte can help to increase the contact between garnet-type SSE and electrodes, so as to decrease the garnet-type SSE interfacial resistance against cathode and Li metal (FIG. 1b). Gel polymer electrolyte used in this study is a combination of a porous PVDF-HFP polymer matrix and a controlled amount of liquid electrolyte stored inside the polymer. The gel polymer, prepared by a known technique, has good ionic conductivity (5×10⁻⁴ S/cm) and is electrochemically stable in the voltage range of 0 to 4.5 V vs. Li⁺/Li, which is suitable for most commercially employed cathode materials. Due to the hybrid design with gel polymer electrolyte at the interface between the garnet-type SSE and the active electrodes, the interfacial resistance is measured to be as low as 248 Ω×cm² for cathode interface, and 214 Ω×cm² for Li metal anode interface. Our results show that the hybrid symmetric cells can run with stable stripping and plating profiles for up to 15 hours and with a low over potential, which is indicative of a stable interface between the garnet-type SSE and metallic Li anode. Since minimal amounts of liquid electrolyte are stored in the gel polymer interlayer, the hybrid electrolyte will not suffer from leakage as do conventional liquid electrolyte-based batteries. The hybrid electrolyte design with gel polymer interface layers can be considered as an important surface engineering strategy to decrease the overall interfacial resistance against electrodes, including both cathode and Li metal anode within the electrochemical cells, and demonstrate safe Li metal batteries with high performance.

Results and Discussion. Characterization of hybrid electrolyte. The characterizations of garnet-type SSE and gel polymer electrolyte are described herein. Across-sectional scanning electron microscope (SEM) image was taken of the garnet-type LLCZN pallet, and it showed a total thickness of about 450 μm, which remains consistent between samples in these trials. The surface of the garnet pallet is not smooth, which leads to poor contact against the electrode layers. A zoomed in cross-sectional SEM image of a garnet-type LLCZN pallet with small grains as a result of the 12 hours of high temperature sintering during the synthesis process was examined. The dense structure of the garnet-type SSE prevents lithium metal dendrites from penetrating through the electrolyte during cycling. An SEM image of the PVDF-HFP polymer matrix was taken. The porous structure of the matrix absorbs and contains the additional liquid electrolyte well. X-Ray diffraction (XRD) was performed on a garnet-type LLCZN pallet. It matched well with the standard XRD plot of cubic phase garnet-type Li₅La₃Nb₂O₁₂, which indicates that the LLCZN pallet has a cubic garnet-phase, which has higher Li ion conductivity compared with tetragonal garnet-phase. Electrochemical impedance spectroscopy (EIS) was performed with two LLCZN pallets, with thicknesses of 1000 μm and 150 μm, tested in a symmetric cell with gold deposited on both sides. The semicircle in the high frequency portion of the impedance spectroscopy curve represents the bulk resistance and the grain boundary resistance of LLCZN. The LLCZN pallets with different thicknesses have the same bulk conductivity of around 2×10⁻⁴ S/cm. The conductivity was calculated using the equation σ=R⁻¹LS⁻¹, where R is the resistance, L is the thickness of the LLCZN pallet, and S′ is the area of the electrode. The bulk areal specific resistance (ASR) of a 450 μm thick LLCZN pallet is 225 Ω×cm², which is acceptable for a battery. This means that the inner resistance of the garnet-type SSE is relatively small, and the main contribution to the resistance of the solid state battery comes from the interfaces between the SSE and the electrodes. Therefore, as long as the interfacial resistance can be reduced to the same level as the inner resistance, solid state electrolytes can have small enough resistance for battery use. Cyclic voltammetry (CV) was performed with the Li|polymer|T₁ system. The sharp peaks at −0.3 V and 0.3 V correspond to lithium platting and stripping, and there are no peaks in the higher voltage range. The flatness of the CV curve in the voltage range of 0.5 to 4.5 V suggests that the gel polymer electrolyte is electrochemically stable up to 4.5 V. In addition, the garnet-type LLZO is electrochemically stable from 0 to 6 V vs. Li⁺/Li, and therefore, the hybrid electrolyte design is stable in the voltage range of 0) to 4.5 V vs. Li⁺/Li. This stable voltage range makes the hybrid electrolyte suitable for lithium metal designs with numerous cathode materials. The areal specific resistance and ionic conductivity of the gel polymer with 40 μm thickness is 8 Ω×cm² and 5×10⁻⁴ S/cm, respectively, which is measured from the EIS plot of a simple symmetric cell with stainless steel plates. This soft and highly ionically conductive gel polymer can improve the contact between SSE and electrodes, and reduce the interfacial resistance.

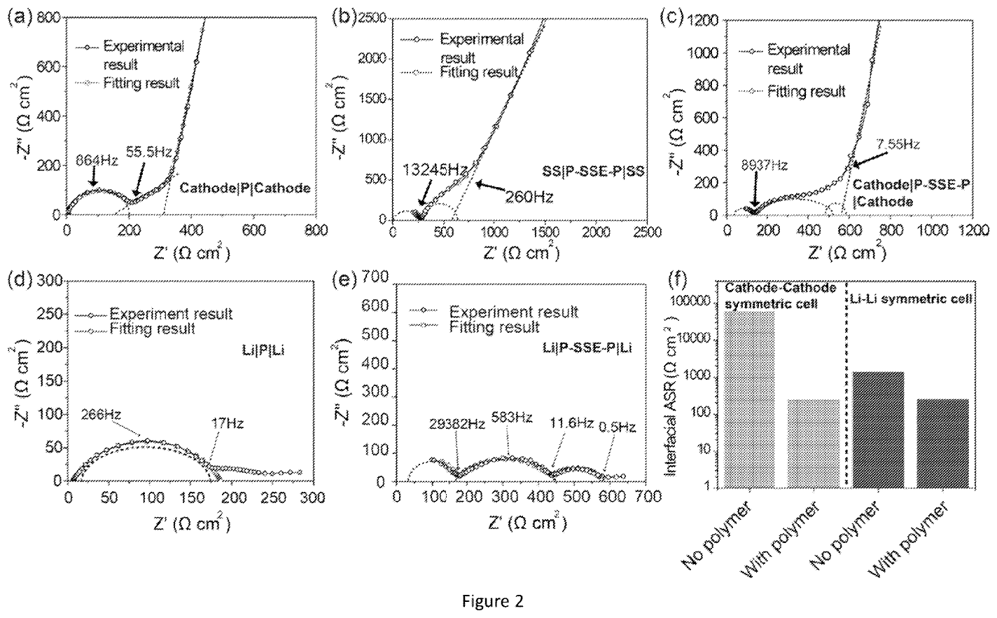

Analysis of the interfacial impedance of the hybrid electrolyte. The impedance analysis of symmetric cells with garnet-polymer hybrid electrolyte is shown in FIG. 2. FIG. 2a shows the impedance profile of a cathode|polymer|cathode symmetric cell. The bulk resistance of this cell is small, because of the thin and conductive gel polymer layer. The semi-circle in the middle frequency part corresponds to the charge transfer resistance (R_{ct}), which is about 107 Ω×cm² for each side. This value is calculated with equivalent circuit simulations. The R_{ct} represents the kinetic hindrance of charge transfer between the cathode material and the gel polymer, and the small R_{ct} means that the gel polymer and cathode have good interfacial contact. The long tail in the low frequency part corresponds to the diffusion impedance in the cathode. FIG. 2b shows the impedance profile of a stainless steel (SS)|polymer|SSE|polymer|SS symmetric cell, which is combined by three parts: the bulk and grain boundary impedance of the garnet-type SSE at high frequency, the interfacial R_{ct} in middle frequency range, and the diffusion impedance at low frequencies. From an impedance plot of gel polymer, the R_{ct} between the gel polymer and SS is almost zero, since no corresponding semicircle shows up in the impedance plot. So all of the R_{ct} in a SS|polymer|SSE|polymer|SS symmetric cell comes from polymer|SSE interfaces. The R_{ct} of the polymer|SSE interface is about 155 Ω×cm² for each side, calculated from the corresponding fitting result in FIG. 5b. This resistance is close to the R_{ct} of the cathode|polymer interface, which means that the polymer|SSE and cathode|polymer interfaces have similar contact performance. FIG. 2c is the EIS plot of a cathode|polymer|SSE|polymer|cathode symmetric cell. The impedance curve is combined of three parts. In the high frequency part is the bulk and grain boundary impedance of the garnet-type SSE itself. In the middle frequency part is a combination of two semi-circles corresponding to interfacial R_{ct} between garnet-type SSE and cathode, including R_{ct} of the polymer|SSE and cathode|polymer interfaces, as the resistance of the gel polymer layer itself is relatively very small. In the low frequency part is a straight line, corresponding to diffusion impedance of the cathode. The total interfacial R_{ct} in the cathode|polymer|SSE|polymer|cathode symmetric cell is 248 Ω×cm² for each side. This value was got from equivalent circuit fitting. The interfacial R_{ct} of the cathode|polymer|SSE|polymer|cathode symmetric cell is approximately the sum of polymer|cathode interfacial R_{ct} and polymer|SSE interfacial R_{ct}, and the impedances of all of the three kinds of interfaces show up in middle frequency range. This means the impedance of cathode polymer|SSE interface is sum up of polymer|cathode and polymer|SSE interfacial impedance. For comparison of the symmetric cells with and without gel polymer interfacial layers. FIG. 5a is the EIS plot of cathode|SSE|cathode symmetric cell without any interfacial modification. The symmetric cell was made by directly brushing the cathode slurry on the garnet-type SSE surface and then drying up. It shows that the total R_{ct} of cathode|SSE|cathode symmetric cell without polymer interfacial layer is about 1×10⁶ Ω×cm². The huge resistance is evidence of poor contact between SSE and LiFePO₄ cathode materials. This problem can be solved with gel polymer layer in the hybrid design between garnet-type SSE and the cathode.

FIG. 2d shows the impedance curve of a Li|polymer|Li symmetric cell. The intersection point of the impedance curve and Z′ axis is 6.4 Ω×cm², which is the bulk resistance of the gel polymer. The diameter of the semicircle is 180 Ω×cm², which is the Rat of two polymer|Li interfaces on both sides of the symmetric cell. Therefore, the interfacial resistance for one polymer|Li interface is 90 Ω×cm², close to the polymer|cathode interfacial resistance. This means that the contact between the gel polymer and Li metal is as good as the contact between the gel polymer and the cathode, and the surface of Li metal electrode is also fully wetted by the gel polymer. FIG. 2e shows the EIS plot of Li|polymer SSE|polymer|Li symmetric cell, containing 4 parts. In the high frequency part is the bulk resistance and the grain boundary resistance of the garnet-type SSE. In the middle frequency part are two semi-circles corresponding to interfacial R_{ct} between garnet-type SSE and Li metal, which mainly come from the impedance of the polymer|SSE and polymer|Li interfaces, as the impedance of the gel polymer layer itself is very small. From the corresponding equivalent circuit fitting result herein, the total interfacial R_{ct} on one interface in the Li|polymer|SSE|polymer|Li symmetric cell is 214 Ω×cm². FIG. 5b shows that the total resistance of a Li|SSE|Li symmetric cell without interface modification is about 1400 Ω×cm² for one side. The metallic lithium is melted and coated on both sides of garnet-type SSE. The reason for the small resistance, compared with the cathode|SSE|cathode symmetric cell in FIG. 5a, is that the melting of lithium metal improved the surface contact, compared to the solid state cathode powders and binder. However, the 1400 Ω×cm² interfacial resistance is still too large for battery use, and this can be reduced by the gel polymer interfacial layers. As a conclusion, gel interfacial layer can significantly reduce the interfacial R_{ct} between the LLCZN solid state electrolyte and the electrodes, including numerous cathode materials and Li metal anodes. FIG. 2f compares the interfacial resistance of Li|SSE|Li and cathode|SSE|cathode symmetric cell with and without the gel polymer interface. It clearly shows that the gel interface can reduce the interfacial resistance to an acceptable range. The interfacial resistance between cathode and garnet type SSE was decreased from 6×10⁴ Ω×cm² to 248 Ω×cm², after applying the gel polymer interface. The interfacial resistance between the Li metal anode and garnet type SSE was decreased from 1400 Ω×cm² to 214 Ω×cm², after applying gel polymer interface.

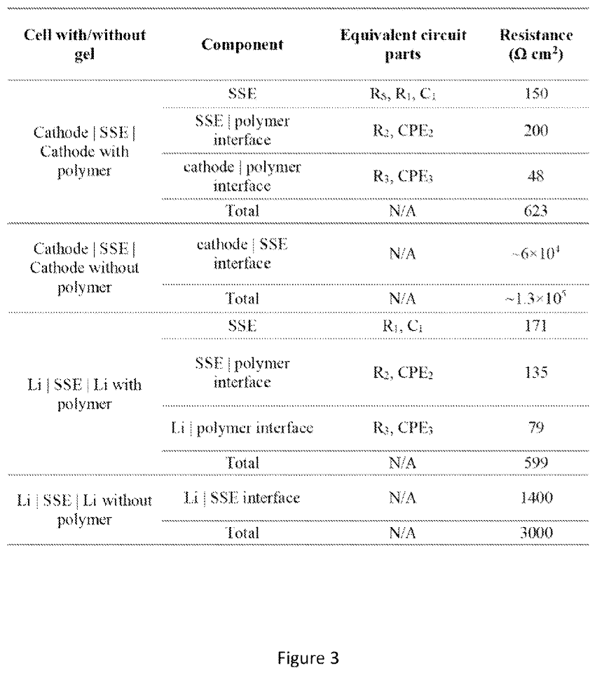

FIG. 3 analyses the impedance identified for each interface in symmetric cells with and without gel polymer interfaces. The analysis of the impedance in a cathode polymer|SSE|polymer|cathode symmetric cell comes from FIGS. 2a-c, and the analysis of the impedance in a cathode|SSE|cathode symmetric cell without gel polymer interfaces is presented in FIG. 5a. Corresponding equivalent circuits are described herein. In each equivalent circuit, there is one parallel connection between a resistor and capacitor/constant phase element (CPE) for impedance on one interface. The capacitor/CPE is for double layer capacitance on the interface, and the resistor is for charge transfer resistance on the interface. The total interfacial R_{ct} of cathode|polymer|SSE|polymer|cathode symmetric cell is 496 Ω×cm², much less than the interfacial R_{ct} of the cathode|SSE|cathode symmetric cell without a gel polymer interface (1.3×10⁵ Ω×cm²). This reduced resistance means that the gel polymer interface can significantly improve the contact performance between the cathode and SSE. The analysis of the impedance in Li|polymer|SSE|polymer|Li symmetric cell comes from analysis of FIGS. 2b, d-e, and the analysis of the impedance in a Li|SSE|Li symmetric cell without gel polymer interfaces comes FIG. 5b. It compares the impedance of a Li|SSE|Li symmetric cell with and without gel polymer interfaces. Corresponding equivalent circuits are described herein. The total interfacial R_{ct} of a Li|polymer|SSE|polymer|Li symmetric cell is 428 Ω×cm², much smaller than the interfacial R_{ct} of the Li|SSE|Li symmetric cell without interfacial modifications (2800 Ω×cm²). This reduced resistance means that the gel polymer interface can significantly improve the contact performance between Li and the SSE.

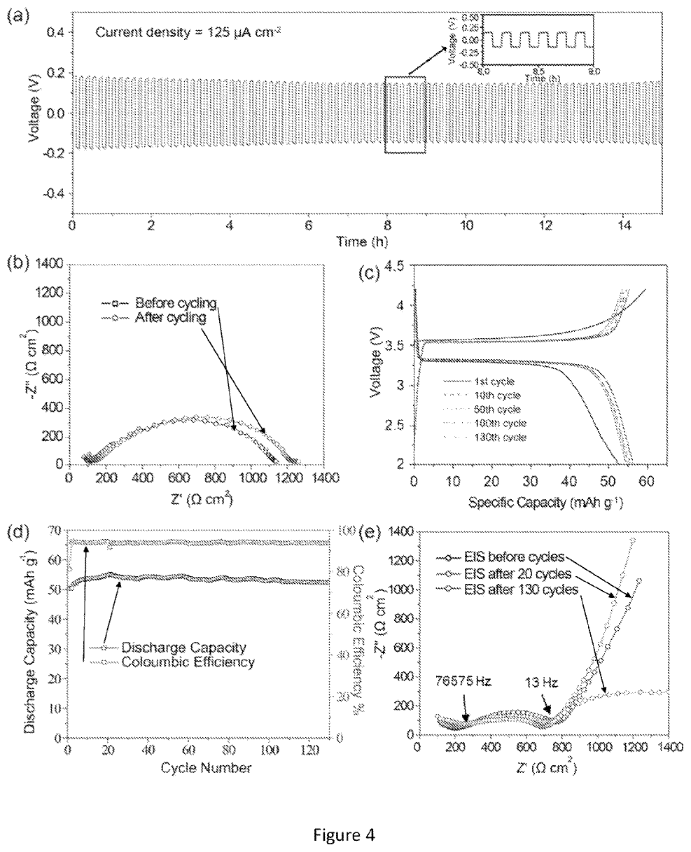

Electrochemical performance of the hybrid solid-polymer electrolyte. The electrochemical performances of lithium symmetric cells and full cells with polymer/garnet-type SSE hybrid electrolyte are shown in FIG. 4. Figure da shows the DC cycling voltage profiles of a Li|SSE|Li symmetric cell with gel polymer interface layers, under constant current cycling. The total DC ASR of the symmetric cell is 1400 Ω×cm², which is measured from the voltage value 180 mV divided by the areal current density 125 μA/cm². The inset of FIG. 4a shows that the DC resistance is kept constant in one cycle. This DC resistance comes from the bulk and grain boundary resistance of SSE, and the resistance of the SSE|polymer|Li interfaces, so the interfacial resistance kept constant in a single cycle. The voltage is smaller in the first 5 hours from 180 mV to 160 mV, because lithium stripping and plating can improve the interfacial contact between lithium and gel polymer electrolyte. After 5 hours the voltage is kept constant, the interfacial resistance is kept constant, and the interface is stable. FIG. 4b shows the ETS plots of the cell before and after cycling for 15 hours. While cycling, the interfacial ASR is almost constant and changes from 1000 Ω×cm² to 1100 Ω×cm². This means that the gel polymer interface was stable and kept a small resistance for a long time.

FIG. 4c-e shows the cycling performances of a full cell with polymer/garnet-type SSE hybrid electrolyte. The cell was charged and discharged at 65 μA/cm² areal current density and 1 C rate (170 mA/g) for 130 cycles. FIG. 4c is the charge and discharge profiles of the 1st, 10th, 50th, 100th, and 130th cycles. The charge and discharge curves show stable voltage plateaus, and the over potentials of the cycles are consistent. This means that the interfacial resistance is constant during 130 charge and discharge cycles. FIG. 4d shows the discharge capacity and coulombic efficiency of each cycle and the coulombic efficiency is about 95% for each cycle beyond the first. The Columbic efficiency of the first cycle is low, owing to that an SEI layer was formed between electrodes and gel during the first cycle. The discharge capacity is stable, between 50˜55 mAh/g for 130 cycles. The stable discharge capacity proves that the interfacial layer is stable for extended periods of cycling. One possible reason for the small specific capacity is that not all of the cathode material was wet by the gel electrolyte and activated in the reaction, because main part of the liquid electrolyte is inside the gel, and only a little is inside the cathode material. However, the discharge capacity of battery has good stability over a long period, because the interfacial layer is electrochemically stable. FIG. 4e is the EIS plot of the battery before cycling, after 20 cycles, and after 130 cycles. The R_{ct} shown as the diameter of the semicircle in the middle frequency range, is almost constant at about 500 Ω×cm², which means that the impedance of the gel polymer electrolyte is very stable, and can maintain a small charge transfer resistance for 130 cycles. In conclusion, the hybrid polymer/garnet electrolyte can be used for Li metal full cells with small over potentials and good stability.

This example demonstrates that the polymer/garnet hybrid electrolyte can be used in a successful solid-polymer battery design, instead of pure SSE, to reduce the interfacial resistance between the garnet-type SSE and the electrodes. Gel polymer electrolyte has high ionic conductivity and a wide electrochemically stable voltage window. Therefore, it can be used as an interfacial layer between the LLZCN garnet SSE and electrodes, to provide an electrochemically stable and ionically conductive interface. The R_{ct} between SSE and electrodes, with a gel polymer interfacial layer is 248 Ω×cm² for the cathode, and 214 Ω×cm² for Li metal anode, as measured by impedance spectroscopy of symmetric and full cells. This interfacial resistance is acceptable for commercial lithium metal cell production. A Li metal symmetric cell with polymer/garnet-type SSE hybrid electrolyte was demonstrated and cycled for over 15 hours with a stable voltage profile. It proves that the gel polymer interface between Li metal anode and garnet-type SSE is electrochemically stable. A battery was realized and cycled 130 times at room temperature using a Li metal anode. LiFePO₄ cathode and the polymer/garnet hybrid electrolyte. The interfacial R_{ct} of the full cell was constant while cycling, which means that the gel polymer electrolyte can form a stable interface between the LLCZN garnet electrolyte and the lithium iron phosphate electrode. Overall, this work demonstrated a new kind of hybrid garnet-polymer electrolyte, which is a combination of pure solid state electrolyte with two gel polymer layers coated on both sides. It has low total interfacial resistance (˜500 Ω×cm²) at room temperature after applying gel polymer interfaces, in comparison to unfavorable performance without the gel polymer layers and 6×10 Ω×cm² total interfacial resistance.

Experimental. Synthesis of the LLCZN pallets. The garnet-type Ln₇La_{2.75}Ca_{0.25}Zr_{1.75}Nb_{0.25}O₁₂ powders were synthesized by a sol-gel method. Precursors LiNO₃ (99%, Alfa Aesar), La(NO₃)₃·6H₂O (99%, Alfa Aesar), Ca(NO₃)₂·4H₂O (99.9%, Sigma Aldrich), NbCl₅ (99%, Alfa Aesar) and Zirconium (IV) propoxide (70 wt. % in 1-propanol, Sigma Aldrich) were dissolved into ethanol, with stoichiometric amounts and 10 wt. % extra LiNO₃, and the solution was stirred until clear then pure acetic acid was added in, with a volume ratio 1:4 to the solution. The ethanol solvent was evaporated under 100° C. to get the gel precursors. The gel was heated at 350° C. to get dry precursor powders, and then heated at 800° C. for 10 hours, to get garnet powders. The powders are ball milled for 48 hours, and then pressed into cylindrical pallets. The area of a pallet is 0.5 cm². Then, the pallets were sintered at 1150° C. for 12 hours. The as-synthesized pallets were polished with sand paper to reduce the thickness to between 400 μm and 450 μm and washed with isopropyl alcohol (IPA).

Synthesis of the PVDF-HFP based gel polymer electrolyte. PVDF-HFP based gel polymer electrolyte was made by the following way. First dissolve 0.25 g of PVDF-HFP (Sigma-Aldrich) into a mixture of 4.5 g acetone and 0.25 g ethanol under mechanical stirring for 1 h, to get homogeneous solution. The solution was then cast onto a flat aluminum foil and the solvent was evaporated in a constant humidity chamber with 80% humidity and 25° C. temperature. The samples are dried under vacuum at 60° C. for 5 h. After that a homogeneous freestanding membrane was obtained. The thickness of the PVDF-HFP membrane is around 40 μm. Second, the as-prepared porous PVDF-HFP membrane was cut into small round films with an area of 0.2 cm², and immersed into 1 M LiPF₆ in 1:1 ethylene carbonate (EC): diethyl carbonate (DEC) liquid electrolyte for 1 minute to be fully soaked by electrolyte, and the excess liquid on the surface of the membrane was moved away by wipers.

Material characterization. Phase analysis of the LLCZN garnet pallets was performed by X-ray diffraction (XRD) on a D8 Advanced with LynxEye and SolX (Bruker AXS, WI, USA) using a Cu Kα radiation source operated at 40 KV and 40 mA. The morphology of the microstructures of as-prepared LLCZN garnet pallets and PVDF-HFP membranes was examined by a field emission scanning electron microscope (FE-SEM, JEOL 2100F).

Battery fabrication electrochemical test. The interfacial impedance was measured for both the Li|SSE interface and the LifePO₄ cathode|SSE interface. The lithium metal electrodes were pressed and punched from a Li belt (Sigma-Aldrich) into round disks with an area of 0.2 cm² and a thickness 0.5 mm. To make the cathode. LiFePO₄, Carbon Black. and poly vinylidene difluoride (PVDF) were dissolved in N-methyl-2-pyrrolidone (NMP) with a mass ratio 3:2:1 and mixed into a slurry. The slurry was coated on Aluminum foil and then dried at 100° C. in an oven for 12 h. After drying, the cathodes were cut into round disks with an area of 0.2 cm², and immersed in 1 M LiPF₆ in 1:1 ethylene carbonate (EC):diethyl carbonate (DEC) liquid electrolyte before testing, and the surplus liquid electrolyte was wiped away. Battery assembly and electrochemically tests were done in an argon filled glove box. Cyclic voltammetry (CV) of Li|gel polymer|Ti cell was tested with a voltage range of −0.3 V to 4.5 V, with a scan rate of 1 mV/s. Symmetric cells were made for the ETS test. The schematic of the cell for each test is in the corresponding EIS plot. The electrodes, gel membranes, and garnet pallets were pressed together in sequence by clips, with one stainless steel pallet on each side of the cell. The electrochemical performance of the cells were tested by a Bio-Logic tester. EIS tests of the symmetrical cells have a voltage amplitude of 10 mV and a frequency range of 0.1 Hz to 1 MHz. Constant current cycling of Li|SSE|Li with gel interface layers used the same assembly method as with the EIS test, and were conducted with a current density of 0.125 mA/cm² with a period of 10 minute. The EIS of the cell before cycling and after cycling for 15 hours was measured and compared. The Li|SSE|LiFePO₄ full cell with gel polymer interfaces was made by pressing the garnet, gel and electrode layers together in a CR2016 coin cell, and sealed by epoxy. This cell was cycled with a constant current of 50 μA/cm′ in the voltage range of 2 V to 4.5 V. and the EIS of the cell before and after cycling was measured.

A system for Lithium-Metal Batteries is was examined. The bulk resistance of the 40 μm thick gel polymer layer is 7 Ω×cm². FIG. 5 shows impedance of electrode|SSE|electrode symmetric cells without gel polymer interface. (a) EIS of cathode|SSE|cathode symmetric cell. (b) EIS of Li|SSE|Li symmetric cell.

### Example 2

This example provides a description of solid-state hybrid electrolytes of the present disclosure. This example also provides examples of making and characterization of such electrolytes.

Solid-state Ion Conducting Framework to Prevent Chemical and Physical Short Circuits in Li-Metal Batteries. Chemical and physical short circuits are two important challenges in Li-metal batteries associated with transport of soluble materials and penetration of Li dendrite, leading to limited battery cycle-life and thermal runaway. To address these challenges, a hybrid solid-state electrolyte system consisting of a structural garnet-type solid-state electrolyte (SSE) and liquid electrolyte are described in this example. The hybrid electrolyte utilizes regular liquid electrolyte to maintain high ion transport kinetics in electrodes and employs SSE to not only separate electrodes as well as liquid electrolyte apart but also block the unwanted species diffusion and Li dendrites. The example describes investigation of garnet SSE chemical and electrochemical stability in sulfur, polysulfides and liquid electrolyte, and development of a bilayer garnet SSE framework for hybrid Li—S battery with a continuous Li⁺/electron pathway in porous layer for high sulfur loading cathode and a dense layer to block polysulfides diffusion and dendrite penetration. This work showed that the integrated sulfur loading can reach >7 mg/cm′ and an energy density of >280 Wh/kg based on full cell level. The initial coulombic efficiency is as high as 99.8%, and no chemical or physical short circuit was observed in the hybrid system. This bilayer hybrid configuration is expected to improve Li—S batteries and this design is expected to extend to other cathode materials, such as high voltage cathode (LNMO) and air/O₂ cathode, paving the way to transition from conventional battery towards all-solid-state batteries.

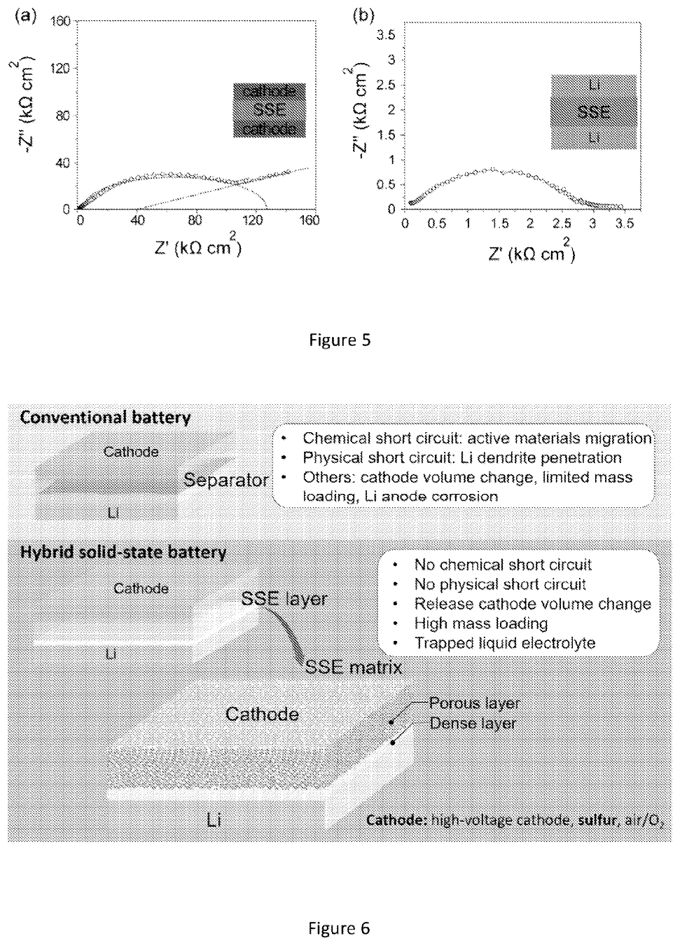

Garnet SSE chemical and electrochemical stability in sulfur, polysulfides and liquid electrolyte was instigated, and a bilayer garnet SSE framework for hybrid Li—S battery with a continuous Li⁺/electron pathway in porous layer for high sulfur loading cathode and a dense layer to block polysulfides diffusion and dendrite formation was developed. Compared to conventional battery configuration, the hybrid solid-state battery cannot only prevent chemical and physical short circuits, but also allow high cathode mass loading, trap liquid electrolyte, and release cathode volume change. Schematic of the bilayer hybrid Li—S battery is shown in FIG. 6. In bilayer SSE, the thicker porous garnet layer allows the supported dense layer to reduce to a few micrometer thick to contribute small electrolyte impedance. The bilayer SSE encapsulates active materials directly into the pores and these pores can be tailored to accommodate volume change of active materials thus keeping battery structure stable during cycling. Integrated sulfur cathode loading can reach >7 mg/cm², and the proposed hybrid Li—S battery exhibited a high initial coulombic efficiency (>99.8%) and high coulombic efficiency (>99%) for each following cycle, and no chemical or physical short circuit was observed in the hybrid system. This bilayer SSE represents a promising strategy to revolutionize Li—S batteries. In addition, this structural hybrid electrolyte design with high surface reaction sites for cathode and blocking layer for Li anode can be expected to use other cathode materials, such as high voltage cathode (LNMO) and air/O₂ cathode, paving the way to transition from conventional battery towards all-solid-state batteries.

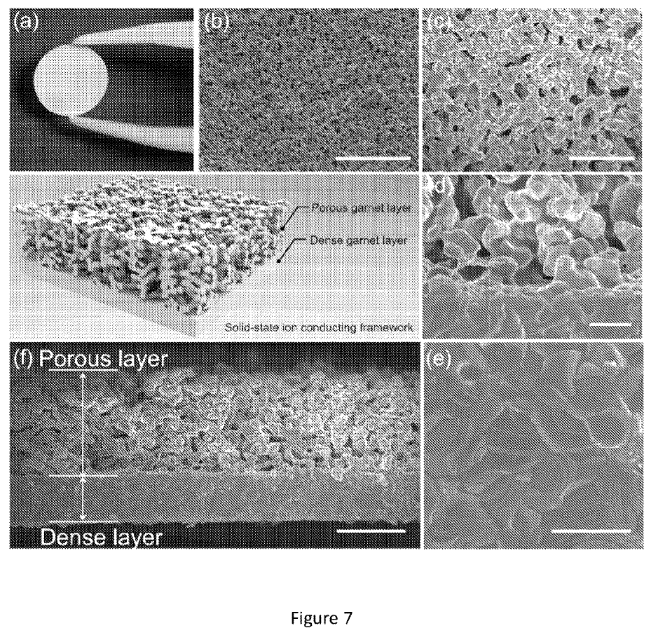

Characterizations of garnet solid state electrolyte. The porous structure was fabricated by tape casting method of whose tapes were using LLCZN powder slurry containing poly(methyl methacrylate) (PMMA) spheres as sacrificial pore formers. The bilayer garnet SSE were prepared by laminating porous tape onto dense tape, followed by co-sintering to remove the organic polymers. Details of fabrication can be found herein. FIG. 7a shows the photo image of the bilayer garnet SSE. It has proper mechanical strength to handle by hand and allow stack together in series for high voltage cells. Unlike sulfide-type superionic conductors that is sensitive to air and moisture, garnet SSE is much chemically stable in dry air and can be handled in dry-room environment Schematic of the bilayer garnet SSE structure is shown in FIG. 7. The porous structure was sitting on top of dense layer and the porous structure can enhance the mechanical strength of the ultrathin dense layer. The further encapsulation of cathode materials through these pores makes an integrated cathode and electrolyte structure. FIG. 7b is the top view of the scanning electron microscopy (SEM) image of porous layer. Micro-sized pores are evenly distributed, allowing electrode slurry to easily get into the interior structure. The cross-section of the bilayer garnet SSE in shown in FIG. 7c-e. Garnet powders were sintered into a 3D network, with a porosity of ˜70%. FIG. 7d shows the connection part of porous layer and dense layer, suggesting that the porous and dense layer were well sintered and no delamination was observed. The dense garnet layer in FIG. 7e demonstrates that large garnet crystal grains make up the dense microstructure and this dense layer can block dissoluble active material and liquid electrolyte go through the solid electrolyte. FIG. 7f is the cross-section of bilayer garnet with a total thickness of 105 μm including 35 μm dense part and 70 μm porous part.

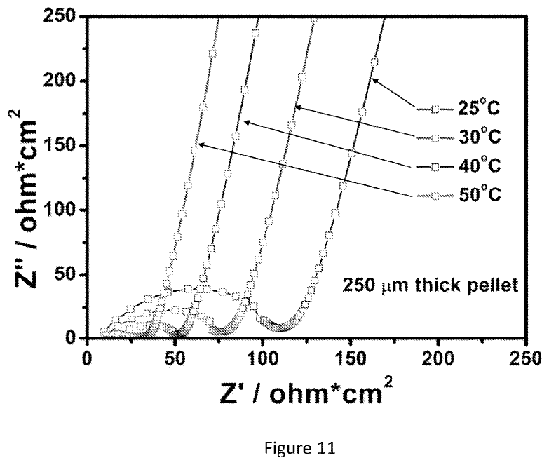

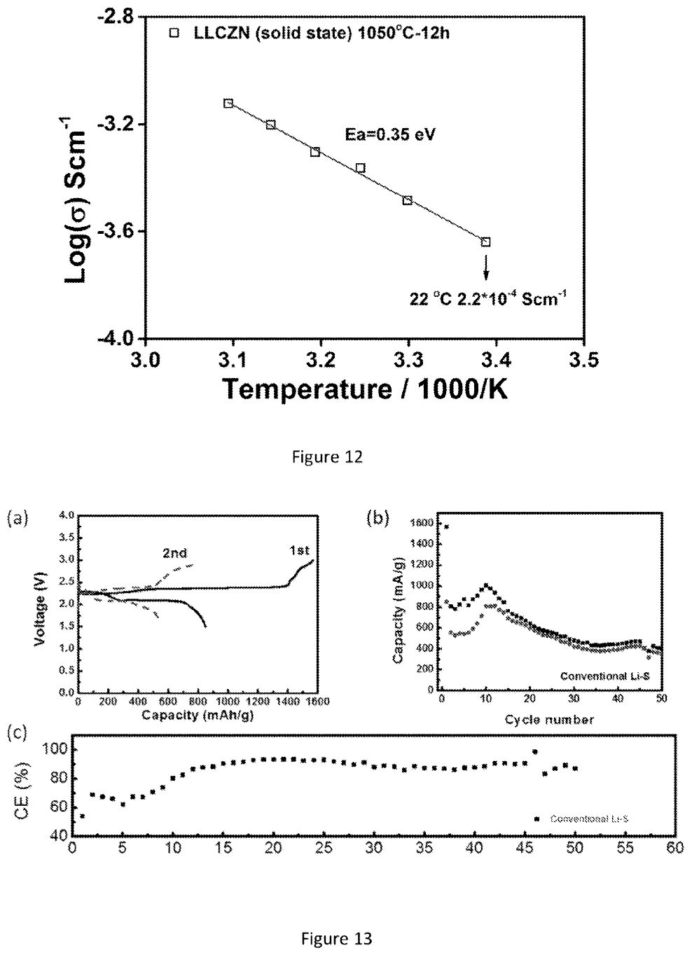

The phase of sintered garnet SSE was confirmed by X-ray diffraction (XRD). The as-synthesized garnet SSE based on Li₇La_{2.75}Ca_{0.25}Zr_{1.75}Nb_{0.25}O₁₂ (LLCZNO) exhibited the cubic structure. All the peaks are matching well with the standard cubic garnet Li₅La₃Nb₂O₁₂ (PDF 80-0457). In Raman spectrum, the broad and partially overlapped bands confirms the cubic phase of LLCZNO garnet, which agrees with garnet spectrum reported elsewhere. The ionic conductivity was measured by electrochemical impedance spectroscopy (EIS) using a blocking cell setup. A dense garnet pellet was used to make the symmetric Au/garnet SSE/Au blocking cell. The EIS of garnet SSE was measured in a temperature range of 25° C. to 50° C. (FIG. 11). The intercept in the real axis at high frequency is assigned to the bulk resistance of garnet SSE, and the depressed semicircle is associated with the grain boundary of garnet SSE. The total resistance including the bulk and grain boundary contributions were calculated by using the low frequency intercept, which is corresponding to the capacitive behavior of the Au electrodes. The ionic conductivity was calculated using a w L/(Z×A), where Z is the impedance for the real axis in the Nyquist plot. L is the garnet ceramic disk length, and A is the surface area. The logarithmic ionic conductivity of garnet SSE against the inverse of temperature is plotted in FIG. 12. The activation energy of 0.35 eV were calculated from the conductivities as a function of temperature using the Arrhenius equation.

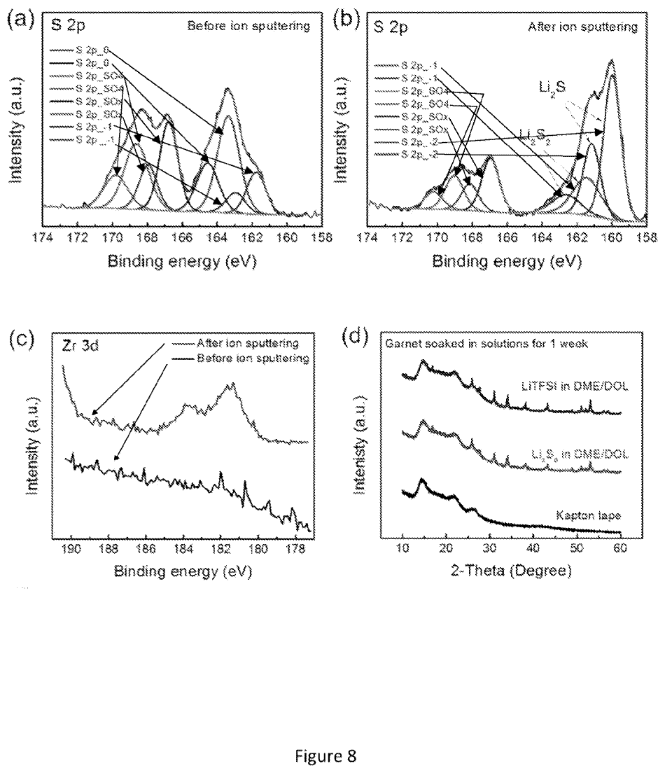

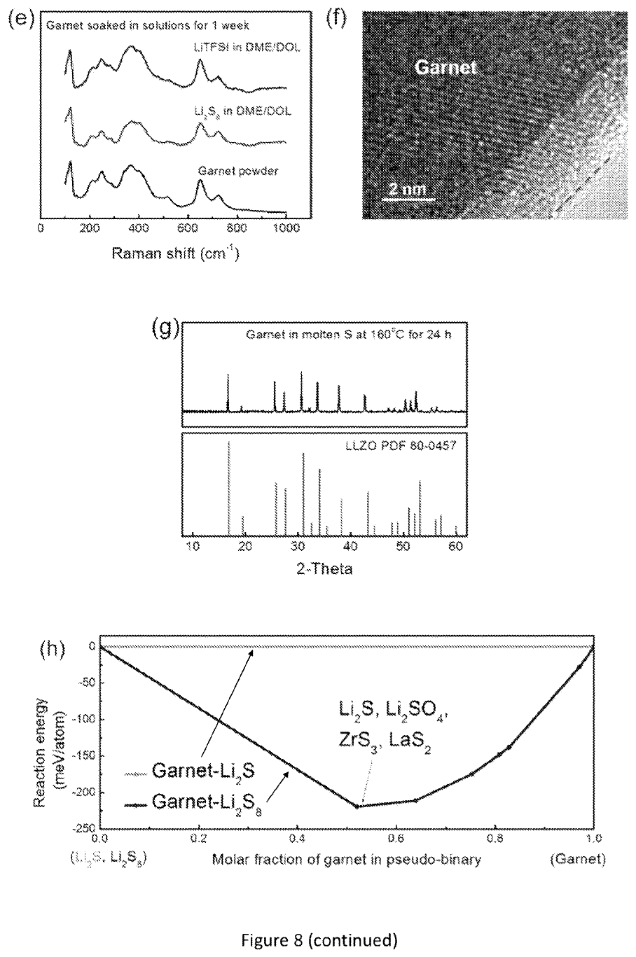

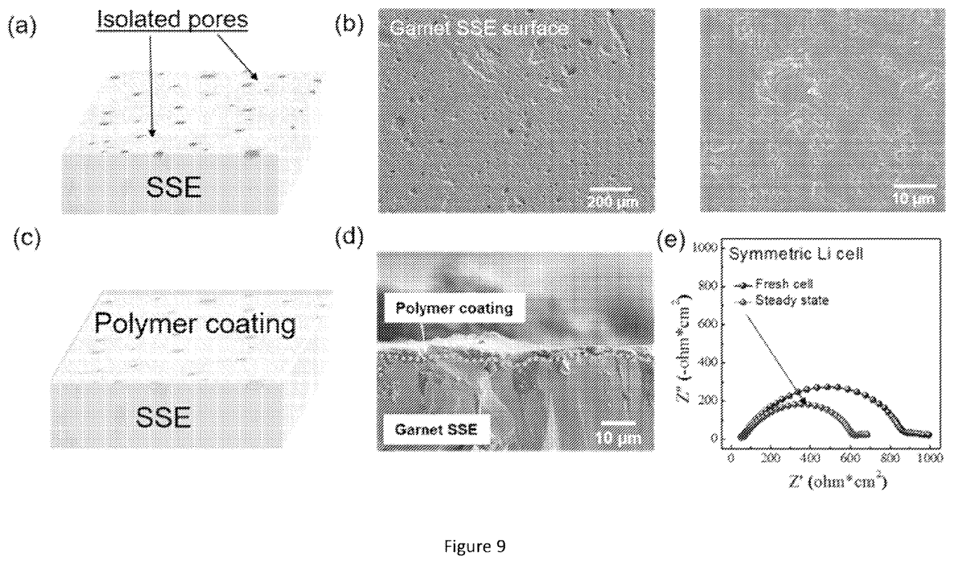

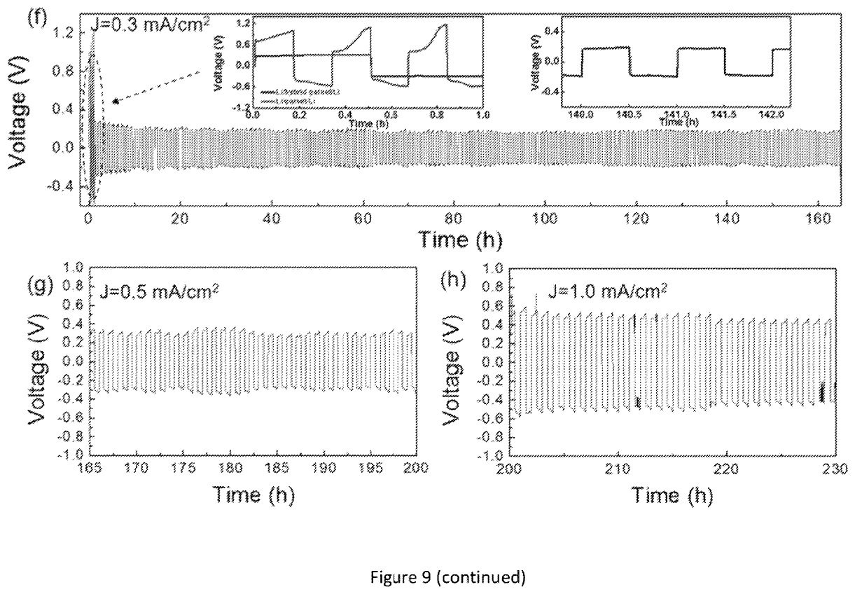

Chemical stability of the hybrid liquid-solid electrolyte system. Experiments to understand garnet SSE compatibility with liquid Li—S chemistry were carried out by immersing garnet SSE in lithium polysulfides solution (L₂S₈ dissolved in DME/DOL) and liquid electrolyte (LiTFSI in DME/DOL) to examine their surface composition and phase structure. The surface of garnet pellet was cleaned by sand paper to remove Li₂CO₃, followed by immersing in liquid electrolyte or lithium polysulfides solution for one week. After soaking in the solutions, garnet SSE were rinsed by DME/DOL solvent and dried before further characterization. Samples transfer were in a protective environment to avoid oxygen and moisture contamination. After immersing garnet pallet in L₂S₈/DME/DOL for 1 week. SO₄⁻² and S₂⁻² were detected on the garnet surface by X-ray photoelectron spectroscopy analysis (XPS) (FIG. 9a). With 30 min Ar ion sputtering to clean the surface. S⁻² signal was detected with a sharp peak and high intensity (FIG. 9b). The S₂⁻² and S⁻² peaks may come from the Li₂S₂ and Li₂S, which are the decomposition of lithium polysulfides Li₂S₈. The Zr 3d spectra of garnet with and without ion sputtering in FIG. 9c shows that before sputtering there is no Zr 3d detected on garnet surface, but after sputtering the Zr 3d, which is an indicator of LLCZNO garnet, was detected, indicating the formation of a solid interphase on garnet surface and the solid interphase has a finite thickness on garnet. Our results can be confirmed by a recent study reported that a solid electrolytes tend to dissolve into liquid electrolyte and within the contact region a so-called solid-liquid electrolyte interphase (SLEI) was observed and contained decomposition products from both solid electrolyte and organic electrolyte. The X-ray diffraction patterns (XRD) in FIG. 9d show that garnet powders remained cubic phase structure and no phase change was observed after soaking in lithium polysulfides and liquid electrolyte. Although the XPS results indicate that liquid electrolyte and garnet solid electrolyte, to a certain extent, were decomposed in polysulfides solution, the stable cubic phase and the electrochemical performance in Li/SSE/L symmetric cells and Li—S full cells fully demonstrate that garnet solid electrolytes could perform well in the liquid electrolyte and the reduced species of sulfur environment. Raman spectra of garnet treated under the same conditions confirm that garnet cubic structure remained stable (Figure Be). High-resolution transmission electron microscopy (TEM) indicates that an amorphous layer with a thickness of ˜4 nm was formed on garnet nanopowder surface, which might be the slight decomposition of garnet (FIG. 8f). The garnet nanopowders were also mixed with sulfur and heated at 160° C. for 24 hours to study garnet and sulfur chemical stability Samples were washed by carbon disulfide (CS₂) to remove sulfur before characterizing the structure of garnet in XRD. The XRD pattern in FIG. 8F also confirms the cubic structure the same as the standard garnet LLZO XRD pattern. To understand the stability of garnet solid electrolyte with reduced sulfur species, computational analysis was carried out to simulate the chemical stability of garnet and polysulfides. The computational results indicate that a self-inhibiting effect will occur at the interface once Li₂S is formed to terminate further reaction between garnet and polysulfides.

Electrochemical characterizations of the hybrid liquid-solid electrolyte. The structure and chemistry of interface between SSE and electrodes are the main challenge for solid-state electrolytes. Recent work suggests that poor contact at the interface is the key factor that leads to the large interfacial resistance of garnet SSE against Li. Introducing a liquid phase by using liquid electrolyte interlayer between solid electrolyte and electrodes should be an effective way to decrease their interfacial resistance. This part of work focuses on the interface modification of garnet SSE against Li metal. FIG. 9a depicts the schematic of garnet SSE dense surface. Isolated pores are distributed on garnet surface and these cavities would make garnet have limited surface area with Li metal (FIG. 9b), and also the rough and stiff garnet surface has a poor conformal contact with Li metal, leading to high interface resistance. To FIG. 9c, a polymeric gel-like layer is designed to conformally coat onto garnet SSE surface. This layer cannot only absorb liquid electrolyte, but also the elastic interlayer can ensure close contact between garnet SSE and lithium metal. FIG. 9d shows the cross-section of polymer coated garnet SSE. Polyethylene oxide (PEO) polymer was deposited on garnet SSE surface by spin coating. The PEO has a thickness of 2 μm and it conformally coated on the garnet SSE (FIG. 8e). This elastic polymer layer can compensate the roughness of garnet and Li metal and ensure a uniform Li ion flux through the interface. The Nyquist plot of the electrochemical impedance spectroscopy (EIS) measurement shows that the total impedance was ˜900 ohm·cm² (FIG. 9e).

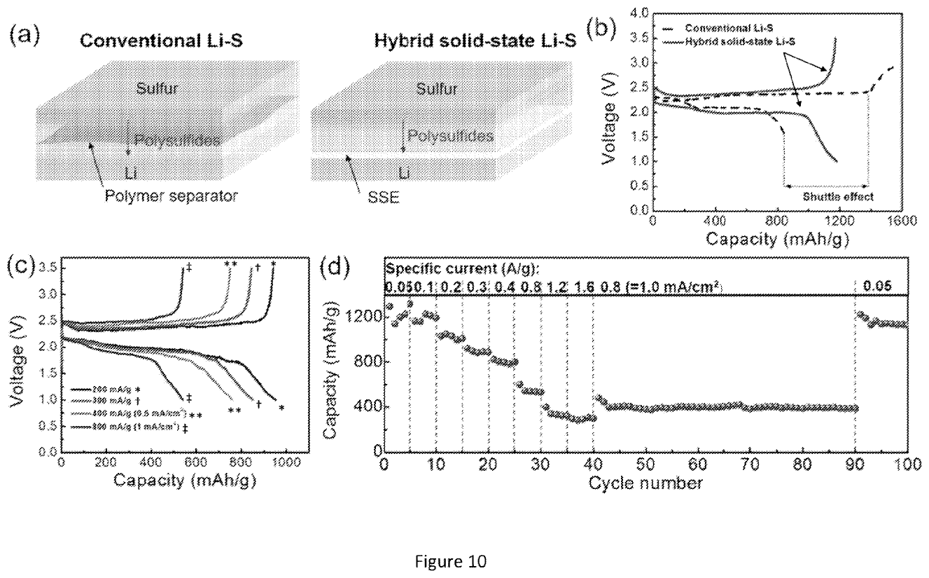

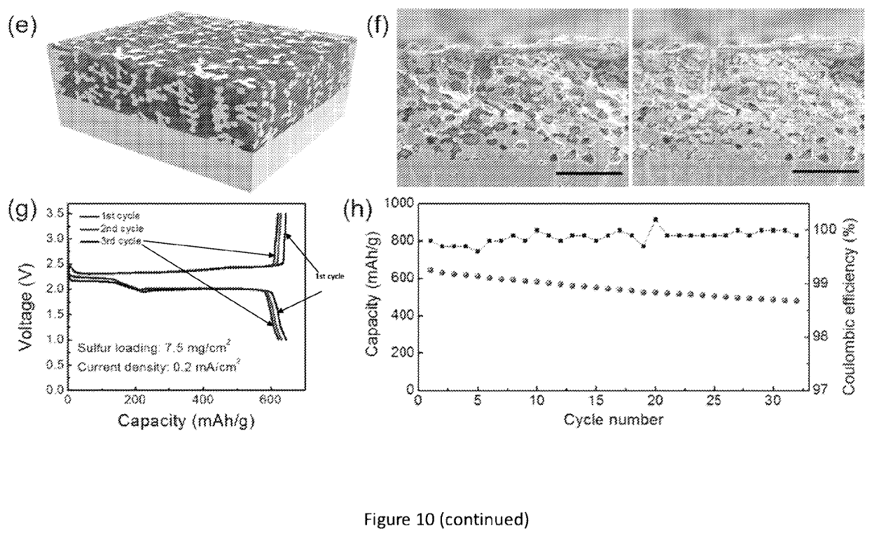

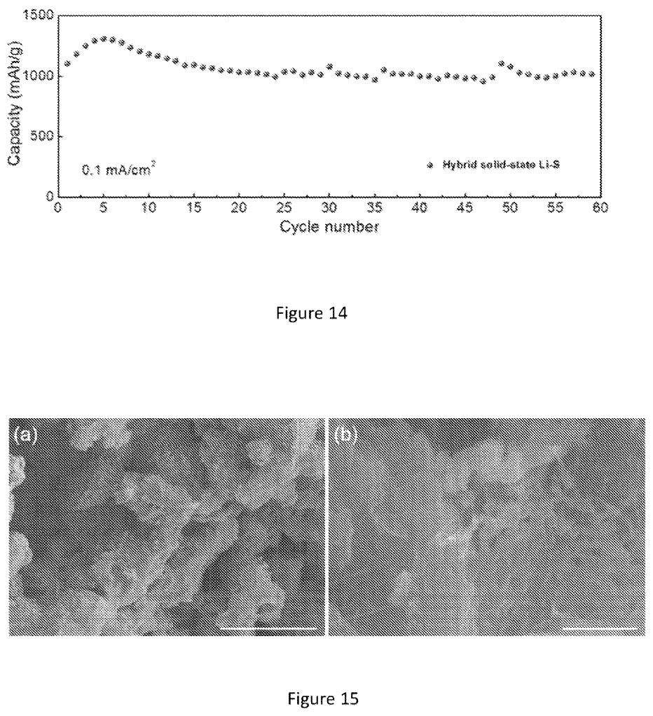

The interface stability was characterized by applying constant current to galvanostatically plate and strip Li ions in symmetric cells to mimic real lithium metal batteries working conditions. Figure &f shows the time-dependent voltage profile of the L/hybrid SSE/Li cell under current of 0.3 mA/cm² The positive voltage indicates Li stripping and the negative voltage is Li plating. The cell was run 0.5 h for each cycle. The cell exhibited a voltage of ±0.3 V in the beginning, and the voltage gradually decreased to ±0.2 V after 10 hours cycling. As comparison, symmetric Li/garnet/Li cell was also prepared and tested. For the hybrid cell, it kept cycling over 160 hours and the stripping plating voltage remained relative stable. Inset show the initial cycling of two types of cells and 140^{th} hours of the hybrid cell. High impedance and large polarization were observed. The unsmooth voltage plateau suggests the large interface resistance between Li and garnet. The hybrid cell showed smooth voltage curves. The total resistance of the symmetric can be obtained according to Ohm's law that resistance is calculated by voltage over current, so that the initial resistance is ˜1000 ohm·cm² and then cell resistance was maintained at ˜660 ohm·cm², which is consistent with the EIS in FIG. 9. These direct current (DC) resistances are slightly higher than the alternating current (AC) resistance measured by EIS. The decreased resistance indicates that the gel electrolyte interlayer improved the interface between garnet and Li metal during the repeated Li stripping and plating. The periodical fluctuation of voltage profile indicates the temperature dependent property of hybrid solid-state electrolyte. The voltage profile of the Li/hybrid SSE/Li cell under current of 0.5 and 1.0 mA/cm² in FIG. 8g-h demonstrates the high current capacity of the hybrid electrolyte.

|Electrochemical evaluation of hybrid Li—S batteries. Electrochemical characterization of the hybrid solid-state electrolyte in Li—S battery are shown in FIG. 10. In FIG. 10a, schematic of Li—S battery with conventional and hybrid solid-state electrolyte are compared. The soluble polysulfides can diffuse through porous polymer separator and migrate to the Li metal anode, but cannot penetrate through the dense ceramic ion conductor, thus avoiding polysulfides shuttling effect, side reactions on Li. and Li metal corrosion. Polysulfide shuttling behavior occurs in charge process as shown in FIG. 10b. The extended charge voltage plateau is a typical polysulfides shuttle effect, causing long-time charging before getting to the upper cut-off voltage. The fast capacity decay and low coulombic efficiency in conventional Li—S (FIG. 13) ask for the urgent need to use hybrid solid-state configuration. In hybrid cell, the charge curve didn't show the extended plateau, and the capacity value is close to the discharge capacity with a coulombic efficiency close to 100% and the hybrid delivered a stable cycling performance (FIG. 14), demonstrating that there is no polysulfides shuttling in the hybrid solid-state electrolyte system.

FIG. 10c shows the discharge and charge curves of a hybrid cell at different current density. The hybrid cell was made by using a dense garnet SSE and a slurry-casted sulfur cathode. The sulfur mass loading is ˜1.2 mg/cm². Regular liquid electrolyte (LiTFSI in DME/DOL) is used as liquid electrolyte. Note that no LiNO₃ was added in the liquid electrolyte. In current density of 200 mA/g, the sulfur cathode delivered a specific capacity of ˜1000 mAb/g with a ˜100% coulombic efficiency. In the current density of 800 mA/g (corresponding to ˜1 mA/cm²), the specific capacity was 550 mAh/g and the cell still maintained a high coulombic efficiency close to 100%. The rate performance is shown in FIG. 10d. The hybrid cell showed a good cycling stability at elevated current density and a good capacity retention at small current.

FIG. 10e shows the schematic of hybrid solid-state bilayer Li—S battery. Sulfur was encapsulated in the thick porous layer and the volume change of sulfur and its soluble polysulfides can be accommodated by the solid garnet matrix Sulfur was loaded by directly melting sulfur powder into the porous matrix at 160° C. Before melting sulfur, carbon nanotubes (CNT) were infiltrated into the microstructure of porous garnet to form electronic conducting network inside (FIG. 15). Cross-section of bilayer Li—S cathode and elemental mapping (La, red; S, green) are shown in FIG. 10f The elemental mapping image clearly indicates the sulfur distribution in the pores of garnet. Those vacant space between sulfur and garnet allow liquid electrolyte easily to penetrate into interior channels and rinse the sulfur. FIG. 10g shows discharge and charge voltage profiles of the hybrid bilayer Li—S cell with a S mass loading of ˜7.5 mg/cm² at a current density of 0.2 mA/cm². The first cycle's discharge capacity is ˜645 mAh/g with a coulombic efficiency of 99.8%, which is an exceptionally high value. The long and flat voltage plateaus indicate the uncompromised polarization between discharge and charge curves. This should be contributed to the porous garnet SSE that has high surface area to increase reaction sites with sulfur, leading to low voltage polarization and good capacity. The cycling performance is shown in FIG. 10h. No sudden capacity jump occurred in the beginning of few cycles, demonstrating that no polysulfides were lost in this hybrid cell with such a high sulfur mass loading. The coulombic efficiency maintained >99%, confirming that no shuttling effect was occurred in the hybrid design. The hybrid bilayer Li—S cell with a mass loading of 7.5 mg/cm² has an energy density of 280 Wh/kg on the basis of cathode, Li anode and electrolytes. The cycling performance exhibited slightly decay, which might be due to the charged products Li₂S and Li₂S₂ didn't get reactivated in following cycle and the high sulfur mass loading impedes further reaction inside of bulk sulfur cathode Increase of electronic conducting network and sulfur distribution are highly desirable. In this example, solid sulfur as a model material was used to study the hybrid electrolyte and hybrid cells, and also it can be envisioned that use of catholyte having liquid polysulfides can be another way to apply to the bilayer porous-dense design of garnet SSE.

In summary, disclosed are garnet SSE chemical and electrochemical stability in sulfur, polysulfides and liquid electrolyte, and developed a bilayer garnet SSE framework for hybrid Li—S battery with a continuous Lit electron pathway in porous layer for high sulfur loading cathode and a dense layer to block polysulfides diffusion and dendrite formation. Compared to conventional battery configuration, the hybrid solid-state battery cannot only prevent chemical and physical short circuits, but also allow high cathode mass loading, trap liquid electrolyte, and release cathode volume change. The bilayer SSE encapsulates active materials directly into the pores and these pores can be tailored to accommodate volume change of active materials thus keeping battery structure stable during cycling. Our work showed that the integrated sulfur cathode loading can reach >7 mg/cm², and the proposed hybrid Li—S battery exhibited a high initial coulombic efficiency (>99.8%) and high coulombic efficiency (>99%) for each following cycle, and no chemical or physical short circuit was observed in the hybrid system. This structural hybrid electrolyte is considered an improvement for Li—S batteries. In addition, this design is expected to extend to other cathode materials, such as high voltage cathode (LNMO) and air/O₂ cathode for high-performance batteries, paving the way to transition from conventional battery towards all-solid-state.

The LLCZN powder was synthesized via a modified sol-gel method. The starting materials were LiNO₃ (99%, Alfa Aesar), La(NO)₃)₃ (99.9%. Alfa Aesar), Ca(NO₃)₂ (99.9%, Sigma Aldrich), ZrO(NO₃)₂ (99.9%. Alfa Aesar) and NbCl₅ (99.99%), Alfa Aesar). Stoichiometric amounts of these chemicals were dissolved in de-ionized water and 10% excess LiNO₃ was added to compensate for lithium volatilization during the high temperature pellet preparation. Citric acid and ethylene glycol (1:1 mole ratio) were added to the solution. The solution was evaporated at 120° C. for 12 h to produce the precursor gel and then calcined to 400° C. and 800° C. for 5 hours to synthesize the garnet powder. The garnet powders were then uniaxially pressed into pellets and sintered at 1050° C. for 12 hours covered by the same type of powder.

Material characterization. The phase analysis was performed with powder X-ray diffraction (XRD) on a D8 Advanced with LynxEye and SolX (Bruker AXS, WI, USA) using a Cu Kα radiation source operated at 40 kV and 40 mA. The morphology of the samples was examined by a field emission scanning electron microscope (FE-SEM, JEOL 2100F).

Electrochemical characterization. The symmetric Li|solid-state electrolyte|La cell was prepared and assembled in an argon-filled glovebox. To measure the ionic conductivity of the garnet solid-state electrolyte, an Au paste was coated on both sides of the dense ceramic disk and acted as a blocking electrode. The gold electrodes were sintered at 700° C. to form good contact with the ceramic pellet. The cell was then assembled into a 2032 coin cell with a highly conductive carbon sponge. The carbon sponge acted as the force absorber and prevented the garnet ceramic disk from being damaged. Battery test clips were used to hold and provide good contact with the coin cell. The edge of the cell was sealed with epoxy resin. The EIS was performed in a frequency range of 1 MHz to 100 mHz with a 50 mV perturbation amplitude. Conductivities were calculated using σ=L/(Z×A), where Z is the impedance for the real axis in the Nyquist plot, L is the garnet ceramic disk length, and A is the surface area. The activation energies were obtained from the conductivities as a function of temperature using the Arrhenius equation.

First Principles Computation. The interface was considered as a pseudo-binary of Li₂S/Li₂S₈ and garnet SSE using the same approach as defined in previous work. The phase diagrams were constructed to identify possible thermodynamically favorable reactions. The energies for the materials used in our study were obtained from the Materials Project (MP) database, and the compositional phase diagrams were constructed using the pymalgen package. The mutual reaction energy of the pseudo-binary is calculated using the same approach as defined in our previous work.

Hybrid solid-state battery preparation and evaluation. All the cells were assembled in an argon-filled glove-box. The hybrid solid-state cells were assembled in 2032 coin cells. The sulfur electrode consists of 70% elemental sulfur powder (Sigma), 20% carbon black and 10% poly vinylpyrrolidone (PVP, Sigma, M_{w}=360,000) binder in water. The electrode was dried in vacuum at 60° C. for 24 hours, 1M bis(trifluoromethane)sulfonimide lithium salt (LiTFSI, Sigma) in a mixture of dimethoxyethane (DME) and 1,3-dioxolane (DOL) (1:1 by volume) was used as the electrolyte for the hybrid solid-state Li—S batteries. No LiNO₃ was added. The electrolyte/sulfur mass ratio is ˜10 ml/g in the cathode side. Cell were tested in 2032 coin cells. The galvanostatic discharge and charge test was measured using a cut-off voltage window of 1-3.5 V. For the bilayer cathode preparation, elemental sulfur power was evenly spread on top of porous garnet, and heat at 160° C. to melt sulfur. Before melting sulfur, a 10 wt. % carbon nanotube (CNT) ink in dimethylformamide (DMF) was prepared and dropped into the porous layer of bilayer garnet SSE and dried at 100° C. for 12 hours in vacuum.

FIGS. 11-15 describe characterization of bilayer garnet structure described in this example.

### Example 3

This example provides a description of solid-state hybrid electrolytes of the present disclosure. This example also provides examples of making and characterization of such electrolytes.

Three-Dimensional Bilayer Garnet Solid Electrolyte Based High Energy Density Lithium Metal-Sulfur Batteries. This example describes a new design for a three-dimensional (3D) solid electrolyte framework and a safe, high energy density hybrid solid state battery using a lithium metal anode that is capable of utilizing a wide variety of cathode chemistry. This solid state electrolyte framework can potentially open a new research direction for next-generation high energy density Li metal batteries.

To simultaneously address the challenges of chemical/physical short circuits and electrode volume variation, we demonstrated a three-dimensional (3D) bilayer garnet solid-state electrolyte framework toward advanced Li metal batteries. The dense layer is reduced in thickness to a few microns and still retains good mechanical stability, thereby enabling the safe use of Li metal anodes. The thick porous layer acts as a mechanical support for the thin dense layer which serves as both a host for high loading of cathode materials and provides pathways for continuous ion transport. Results show that the integrated sulfur cathode loading can reach >7 mg/cm² while the proposed hybrid Li—S battery exhibits a high initial coulombic efficiency (>99.8%) and high average coulombic efficiency (>99%) during the subsequent cycles. This electrolyte framework is expected to improve Li-metal batteries by transitioning to all-solid-state batteries and can be extended to other cathode materials.

In hybrid batteries, chemical and physical short circuits can be prevented by dense solid electrolyte that physically blocks dissolved cathode materials and inhibits Li dendrite penetration. The volume variation of active materials can be accommodated by designing compatible host structures of porous solid electrolyte. To achieve this goal, we demonstrate a 3D solid-state electrolyte framework having a bilayer dense-porous structure. The 3D bilayer solid-state electrolyte framework has several unique advantages: (a) the thin dense bottom layer is a rigid barrier with high elastic modulus that can efficiently separate electrodes and liquid electrolytes and prevent Li dendrite penetration; (b) the thick top porous layer mechanically supports the thin dense layer; (c) the interface between the dense and porous layers is well sintered with good mechanical integrity and continuous ion transport; (d) the solid-state framework can provide electronically and ionically conductive pathways for the encapsulated cathode materials: (e) the solid-state framework can locally confine cathode materials and accommodate their volume change, such as with solid sulfur and polysulfide catholyte. Our results show that the integrated sulfur cathode loading can reach >7 mg/cm², while the proposed hybrid Li—S battery exhibits a high initial coulombic efficiency (>99.8%) and high average coulombic efficiency (>99%) for each subsequent cycle. This electrolyte framework is expected to improve Li-metal batteries by transitioning to all-solid-state batteries and can be extended to other cathode materials, such as high voltage (LNMO) and air/O₂ cathodes.

Fabrication of garnet bilayer framework. The bilayer framework was prepared by laminating dense and porous tapes into a bilayer tape, then co-sintering to remove the organic binders and polymers. The porous garnet structure was fabricated by scalable tape casting using garnet powder slurry containing poly(methyl methacrylate) (PMMA) spheres as sacrificial pore formers for a porosity of 70%. Further details of the fabrication process are given in the Experimental Section. Unlike sulfide-type superionic conductors that are sensitive to air and moisture, garnet is chemically stable for processing in dry air and has sufficient mechanical strength for handling. Thus, the tape casting method can be readily scaled to fabricate low cost garnet solid-state electrolyte frameworks. During sintering, organic fillers were decomposed and garnet powders were sintered together to form the porous layer. The thickness of porous layer and dense layer is controlled by the tape thickness.

Characterization of garnet bilayer framework. The porous and dense layer interface which is well sintered without any observable delamination, indicating good contact at the interface. This interface can enable good ion transfer from porous to dense solid electrolyte. The dense garnet layer with large garnet crystal grains can block physical and chemical short circuits between the active electrodes. A cross-section of the bilayer garnet has a total thickness of 105 μm including the 35 μm dense layer and the 70 μm porous support.

The standard cubic phase of the sintered Li₂La_{2.75}Ca_{0.25}Zr_{1.75}Nb_{0.25}O₁₂ (LLCZNO) garnet was confirmed by X-ray diffraction (XRD) and matches well with cubic Li₅La₃Nb₂O₁₂ (PDF 80-0457). Additionally, the broad and partially overlapped bands in the Raman spectra confirm the cubic phase of LLCZNO garnet. The ionic conductivity of a dense garnet pellet was measured by electrochemical impedance spectroscopy (EIS) in a symmetric Au/garnet/Au blocking cell EIS was conducted in a temperature range of 25° C. to 50° C. The total resistance, including the bulk and grain boundary contributions, was calculated using the low frequency intercept corresponding to the capacitive behavior of the Au electrodes. The ionic conductivity was calculated using σ=L/(Z×A), where Z is the impedance for the real axis in the Nyquist plot, L is the garnet ceramic disk length, and A is the surface area, and corresponds to 2.2×10⁻⁴ S/cm at 22° C. The logarithmic ionic conductivity of the garnet electrolyte against the inverse of temperature was plotted. An activation energy of 0.35 eV was calculated from the conductivities as a function of temperature using the Arrhenius equation.

Electrochemical characterizations of garnet solid-state electrolyte/Li metal. The structure and chemistry of the garnet and electrode interfaces are the main source of challenges for the application of solid-state electrolyte. Recent work suggests that poor contact at the interface is a key factor that leads to the high interfacial impedance of solid electrolytes and electrodes. For example, by a thin (˜5 nm) atomic layer deposition (ALD) interfacial layer, the interfacial resistance of Li-metal/garnet can be significantly decreased. Compared to the reported vacuum-based processes, a gel electrolyte as an artificial interlayer between the solid electrolyte and electrodes can be more scalable toward battery manufacturing. In this case, the gel electrolyte with good wetting can not only provide an evenly distributed Li ion flux at the interface, but also prevent potential reduction of the solid electrolyte after contact with Li metal isolated pores are distributed on the garnet surface and cavities reduce the surface area contact with Li metal, leading to inhomogeneous Li ion transport and high interfacial resistance. A polymeric gel layer was implemented to conformally coat the garnet surface. The liquid filled interlayer ensures close contact between the garnet and lithium metal. Polyethylene oxide (PEO) polymer with a thickness of 2 μm conformally coats the garnet. This polymer layer compensates for interfacial roughness and enables a homogeneous Li ion flux through the interface.

The interface stability was evaluated by applying constant current to galvanostatically plate and strip Li metal in symmetric hybrid cells (Li/polymer/garnet/polymer/Li). A time-dependent voltage profile was determined of the Li/hybrid electrolyte/Li cell under a current density of 0.3 mA/cm². The positive voltage indicates Li stripping and the negative voltage is Li plating. The cell was run 0.5 h for each cycle. The cell exhibited a voltage of ±0.3 V in the beginning, and the voltage gradually decreased to: ±0.2 V after 10 hours cycling. The hybrid cell was cycled for over 160 hours und the stripping/plating voltage remained relatively stable. For comparison, a symmetric Li/garnet/Li cell without the polymer interface was also prepared and tested. The inset shows the initial cycling of the two types of cells and the 1408 hour of the hybrid cell. High impedance and large polarization were observed for the Li/garnet/Li cell, the unsmooth voltage plateaus suggest large interfacial resistance between the Li and garnet. In contrast, the hybrid cell shows smooth voltage curves. The periodic fluctuation of the voltage profile indicates the temperature dependence of the hybrid solid-state electrolyte performance. The voltage profiles of the Li/hybrid electrolyte/Li cell under 0.5 and 1.0 mA/cm² loads demonstrate the high applied current capability of the hybrid electrolyte.

Proof-of-concept Li—S batteries with bilayer Garnet framework. Electrochemical performance of Li—S batteries using the bilayer solid-state garnet hybrid electrolyte was determined. CNT were infiltrated into the microstructure of the porous garnet to form an enhanced electronically conductive network. A photograph of the CNT infiltrated bilayer garnet framework and an SEM image showed CNT coated inside the porous structure. The volume expansion of sulfur and its soluble polysulfides can be accommodated by the solid garnet framework. Sulfur was loaded directly by melting sulfur powder into the porous matrix at 160° C. Cross-sections of the Li—S cathode and elemental mapping was performed. An elemental mapping image clearly indicated the sulfur distribution in the pores of the bilayer garnet. Additional pore space between sulfur and garnet allows liquid electrolyte to penetrate into interior channels and coat the sulfur.

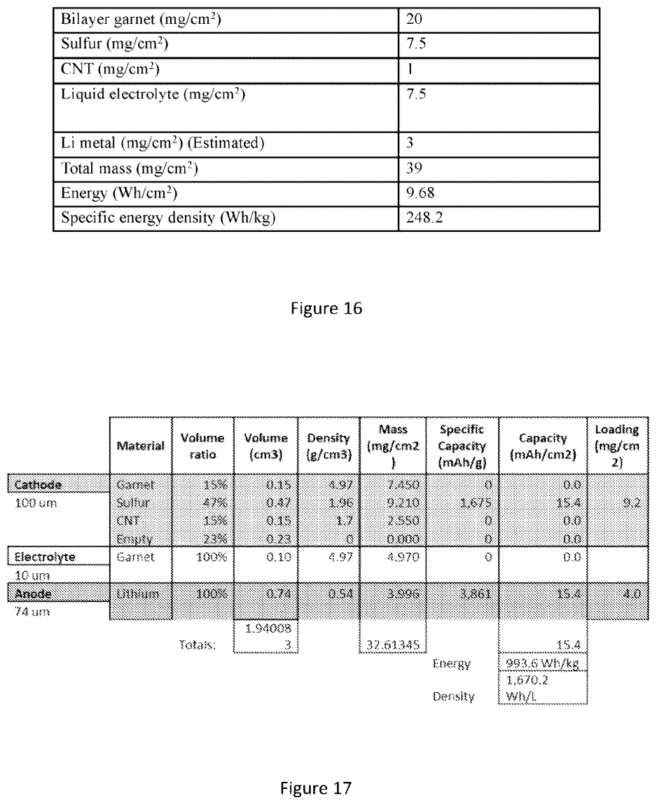

A hybrid bilayer cell with higher sulfur mass loading of approximately 7.5 mg/cm² was prepared. Discharge and charge voltage profiles were made with the hybrid Li—S cell at a current density of 0.2 mA/cm². The first cycle's discharge capacity is around 645 mAb/g with a coulombic efficiency of 99.8%, an exceptionally high value. The long and flat voltage plateaus indicate the uncompromised polarization between the discharge and charge curves. This can be attributed to the thin dense layer and porous garnet layer with high surface area to increase the number of reaction sites for sulfur, therefore leading to low voltage polarization and good capacity. The cycling performance is was plotted. No sudden capacity jump occurred during the beginning few cycles which indicates that no polysulfides were lost in the hybrid cell with high sulfur mass loading. The coulombic efficiency maintains >99% during the subsequent cycles, thereby confirming that no shuttling effect occurred in the hybrid design. Moreover, the hybrid bilayer Li—S cell with a mass loading of 7.5 mg/cm² has a total cell energy density (as calculated in FIG. 16) of 248.2 Wh/kg considering the total mass for cathode. Li anode and electrolyte far beyond any solid battery available today. The cycling performance exhibited slight decay, which is possibly due to the charged products Li₂S and Li₂S₂ not being reactivated in the following cycles. The high sulfur mass loading impedes further reaction inside the bulk sulfur cathode.

This work, for the first time, demonstrates the feasibility of using bilayer solid-state electrolyte framework in hybrid batteries. Further development will focus on increasing the amount of activated sulfur and loading amount by incorporating carbon-sulfur composites into the hybrid cells. An energy density over 900 Wh/kg is projected when the bilayer framework is further optimized, for example, by reducing the dense layer thickness and increasing the active material in a thicker porous layer (FIG. 17).

This example describes a 3D bilayer solid-state electrolyte framework that addresses the issue of both chemical and physical short circuits in Li-metal batteries. To minimize the solid-state electrolyte impedance, the dense garnet membrane thickness was reduced to a few microns while maintaining adequate mechanical strength for battery assembly. The bilayer solid-state electrolyte framework was designed with a thick porous layer to mechanically support the thin dense layer, while hosting electrode material and liquid electrolyte. The thick porous layer has continuous Li⁺/electron pathways to host the sulfur cathode. The thin dense layer additionally blocks polysulfide diffusion and impedes Li dendrite formation. The bilayer garnet solid electrolyte framework was applied to Li—S batteries to demonstrate its feasibility as well as high energy density and excellent performance. The demonstrated hybrid Li—S battery exhibits high sulfur loading >7 mg/cm²; high initial coulombic efficiency (>99.8%), and high average coulombic efficiency (>99%) for the subsequent cycles. This electrolyte framework is expected to improve Li-metal batteries and this framework supported battery design can be extended to other cathode materials, such as high voltage (LNMO) and air/O: cathodes, for commercially viable and intrinsically safe Li-metal batteries.

Methods. Garnet solid-state electrolyte preparation. The LLCZN powder was synthesized via a modified sol-gel method. The starting materials were LiNO₃ (99%, Alfa Aesar), La(NO₃)₃ (99.9%, Alfa Aesar), Ca(NO₃)₂ (29.9%, Sigma Aldrich), ZrO(NO₃)₂ (99.9%, Alfa Aesar) and NbCl₅ (99.99%, Alfa Aesar). Stoichiometric amounts of these chemicals were dissolved in de-ionized water and 10% excess LiNO₃ was added to compensate for lithium volatilization during the high temperature pellet preparation. Citric acid and ethylene glycol (1:1 mole ratio) were added to the solution. The solution was evaporated at 120° C. for 12 h to produce the precursor gel and then calcined to 400° C. and 800° C. for 5 hours to synthesize the garnet powder. The garnet powders were uniaxially pressed into pellets and sintered at 1050° C. for 12 hours covered by the same type of powder for conductivity and stability experiments.

Tape casting was used to fabricate the bilayer framework, dense and porous layers were fabricated respectively and then laminated into a bilayer tape. The thickness of each individual layer was well controlled. Fully-calcined LLZCN in desired phase was use to prepare the slurry. The LLZCN powder with fish oil as dispersant was added to toluene, isopropanol (IPA). After milling for 24 h, polyvinyl butyral (PVB) and butyl benzyl phthalate (BBP) were added as binder and plasticizer, following by balled milling for another 24 h. To eliminate bubbles, the slurry was degassed by stirring in a vacuum chamber for 2 h. Immediately after degassing process, the slurry was poured into a hanging chamber with a slot through which the slurry would be pulled out as thin film on a mylar sheet. The resulting tape was then dried at 120° C. for one hour. To fabricate porous tape, poly(methyl methacrylate) (PMMA) spheres were blended into the well-mixed slurry 1 h before degassing. The pore size of the porous layer can be controlled by the size of polymer based pore formers and its content. The tapes were laminated and hot-pressed at 80° C. for 2 h to enable porous and dense layer to melt at their interface, forming a good connection at their interface. Samples were pre-sintered at 700° C. for 4 h to remove the organic component and then sintered at 1100° C. for final stage sintering. The sintering process was well controlled to ensure sample remained flat during sintering, which is critical for Li/S infiltration and Li—S electrochemical performance tests.

Material characterization. Phase analysis was performed by powder X-ray diffraction (XRD) on a D8 Advanced with LynxEye and SolX (Bruker AXS, WI, USA) using a Cu Kα radiation source operated at 40 kV and 40 mA. The morphology of the samples was examined by a field emission scanning electron microscope (FE-SEM, JEOL 2100F).

Electrochemical characterization. Symmetric Li|solid-state electrolyte|Li cells were prepared and assembled in an argon-filled glovebox. To measure the ionic conductivity of the garnet solid-state electrolyte, an Au paste was coated on both sides of the dense ceramic disk and acted as a blocking electrode. The gold electrodes were sintered at 700° C. to form good contact with the ceramic pellet. The cell was then assembled into a 2032 coin cell with a highly conductive carbon sponge. The carbon sponge acted as the force absorber and prevented the garnet ceramic disk from being damaged. Battery test clips were used to hold and provide good contact with the coin cell. The edge of the cell was sealed with epoxy resin. EIS was performed over a frequency range of 1 MHz to 100 mHz with a 50 mV perturbation amplitude. Conductivities were calculated using σ=L/(Z×A), where Z is the impedance for the real axis in the Nyquist plot, L is the garnet ceramic disk length, and A is the surface area. The activation energies were obtained from the conductivities as a function of temperature using the Arrhenius equation.

Garnet solid-state based Li—S battery preparation and characterization. All the cells were assembled in an argon-filled glove-box. The hybrid solid-state cells were assembled in 2032 coin cells. 1M bis(trifluoromethane) sulfonimide lithium salt (LiTFSI, Sigma) in a mixture of dimethoxyethane (DME) and 1,3-dioxolane (DOL) (1:1 by volume) was used as the electrolyte for the hybrid solid-state Li—S batteries Galvanostatic discharging and charging was measured using a cut-off voltage window of 1-3.5 V. In the bilayer cathode preparation, a 10 wt % carbon nanotube (CNT) ink in dimethylformamide (DMF) was prepared and several drops of CNT ink were added into the porous layer of bilayer garnet framework and dried at 100° C.) for 12 hours in vacuum, then elemental sulfur power was evenly spread on top of porous garnet, and heat at 160° C. to melt sulfur. The bilayer garnet framework was ˜17 mg, corresponding to ˜20 mg/cm². The actual sulfur infiltrated to the bilayer garnet framework was ˜2.5 mg, corresponding to a mass loading of ˜7.5 mg/cm². The full cell was assembled in Ar-filled glovebox. Liquid electrolyte was added to rinse the sulfur cathode. Same amount of liquid electrolyte was used. Li anode was prepared by thinning Li granular (Sigma) in hydraulic press. Cells were packaged in 2032 coin cell and sealed using epoxy resin to prevent air-leakage on edge. The calculation of specific energy density is shown in FIG. 16—The calculations of the specific energy density of the tested garnet bilayer Li—S battery.

With further optimization of the thickness and mass-loading with Li metal and S cathodes, a cell energy density over 900 Wh/kg is achievable.

FIG. 17 shows projected energy density of bilayer garnet solid-state Li—S batteries with optimized parameters.

### Example 4

This example provides a description of solid-state hybrid electrolytes of the present disclosure. This example also provides examples of making and characterization of such electrolytes.

Nature-Inspired Aligned Garnet Nanostructures. Solid-state Li-batteries (SSLiBs) with solid state electrolytes (SSEs) can potentially block Li dendrite penetration, enabling the application of metallic lithium anodes to achieve high energy density with improved safety. The ion transport behavior and ionic conductivity in Li-ion batteries is significantly influenced by the tortuosity of the electrode and electrolyte materials. Low-tortuosity structures with straight ion pathways are highly desirable yet very hard to achieve in solid state ion conductors. We developed a highly conductive garnet framework with multi-scale aligned mesostructure through a scalable, top-down approach. Ion conductive polyethylene oxide (PEO) was incorporated into the mesoporous, wood-templated aligned garnet nanostructure, resulting in an intermixed hybrid ion conductor called garnet-wood. The synergistic integration of the aligned garnet with soft, mechanically robust polymer results in both a high ionic conductivity (1.8×10⁻⁴ S/cm at room temperature) and good mechanical flexibility. This work provides a new direction for developing low-tortuosity, fast ion conductors inspired by nature.

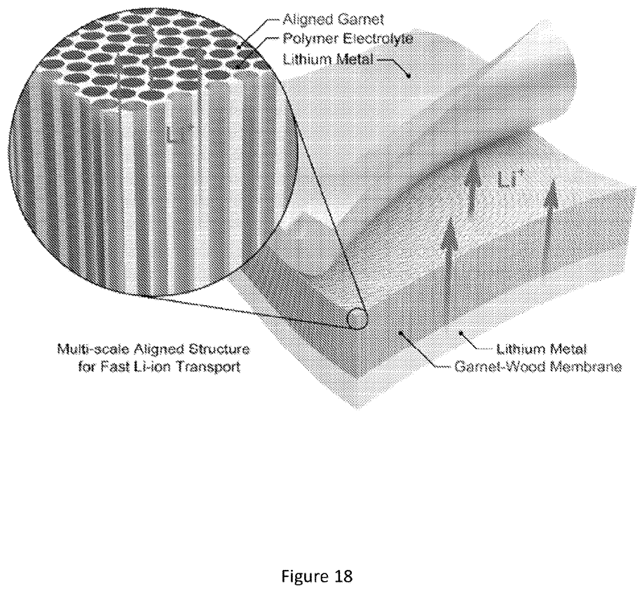

Inspired by the aligned structure of natural wood, disclosed is a highly ionically conductive garnet network with well-aligned mesostructures through templated synthesis. Wood was adopted as a sacrificial template resulting in multi-scale aligned porosity, low tortuosity, and high specific surface area of garnet mesostructures. Due to the high ionic conductivity, good chemical stability with Li anode, and wide electrochemical window, garnet-type LLZO was selected as the model system to fabricate a low tortuosity and aligned solid-state electrolyte. A composite electrolyte was developed by incorporating PEO polymer electrolyte into the aligned garnet templated by wood, which is called garnet-wood (FIG. 18). The polymer electrolyte provides additional transport pathways and also reinforces the mechanical strength of the composite structure. Li-ion can effectively transport through garnet, polymer, and along garnet-polymer interfaces. As a result, the garnet-wood membrane delivers an outstanding ionic conductivity of 1.8×10⁻⁴ S/cm at room temperature. Based on this concept, the design principle and fabrication process for aligned garnet-wood electrolyte can be extended to other types of solid-state electrolytes.

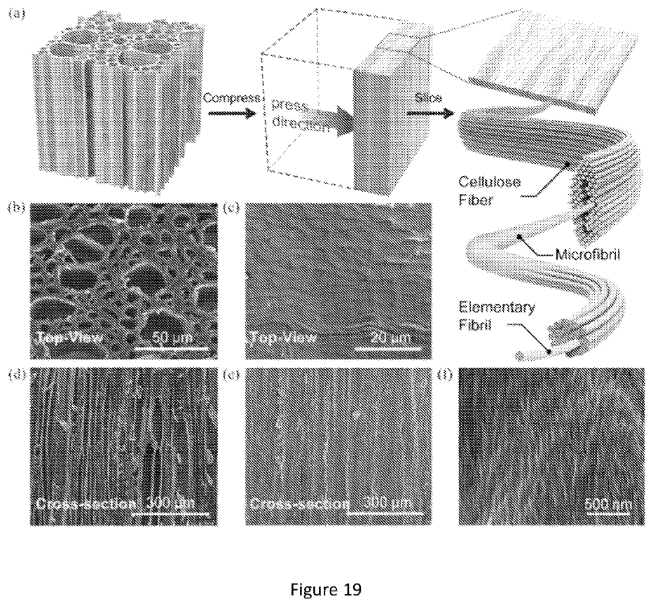

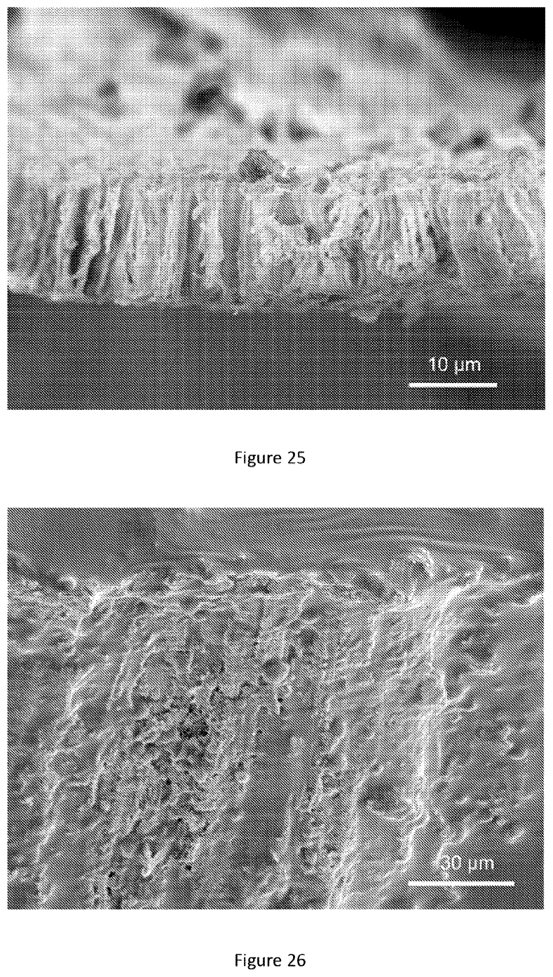

Basswood was chosen as a template to develop the aligned garnet solid-state electrolyte framework due to its high growth rate, low cost, and high porosity. The wood template was obtained after partially removing lignin from a piece of natural basswood by chemical treatment, followed by compressing and slicing perpendicular to the longitudinal direction (natural growth direction) of the wood (FIG. 19a). Mechanical pressing was used to densify the wood. Additional hydrogen bonds formed between adjacent cellulose fibers during densification, which maintains the dense structure of the framework. The morphological changes induced by mechanical compression were investigated with scanning electron microscopy (SEM) measurements of multiple specimens. Before compressing, microchannels in the wood have proximal cylindrical shape with diameters on average between 10-50 μm (FIG. 19b, d). After compression, most of the previously observed microchannels were squeezed into crack-shaped gaps, and some of the adjacent channels became connected (FIG. 19c, e). Although these open channels were severely deformed after compression, their highly aligned multiscale porous structure remained unchanged (FIG. 19f) and showed great absorbency when immersed into the precursor solution. For instance, after soaking for 48 hours and drying in vacuum at 70° C. for 4 hours, the mass of the wood template increased 27.8% from 2.7 mg to 3.45 mg (FIG. 25). The high absorption of precursor solution, pliable nature of the template pores, and scalability of the procedure are indicative of a cost-effective and productive method for fabricating SSEs with aligned mesostructures.

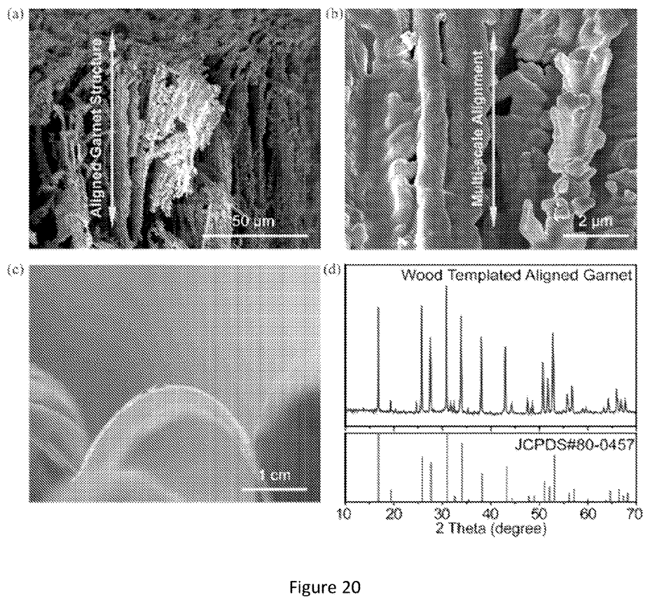

The wood with infiltrated garnet precursor was calcined at 800° C. for 4 hours in oxygen to obtain the LLZO membrane. The wood template with aligned channels has two unique functions. First, the free channels in the wood template provide reservoirs to supply precursor solutions to the template combustion reaction. Second, the aligned nanofibers with a diameter of 2˜10 nm in the wood template serve as sacrificial pore formers for additional aligned porosity in the garnet membrane. Morphological changes after calcination were characterized by SEM. The aligned porous structure from the wood template was inherited in the resulting garnet framework at both the microscale (FIG. 20a) and nanoscale (FIG. 20b). The well-aligned garnet membrane inherited directly from wood is flexible after infiltration with the PEO based polymer electrolyte (FIG. 20c). X-ray diffraction (XRD) was employed to identify the crystal phase of the garnet membrane. The XRD pattern of the aligned mesoporous garnet synthesized using wood template (FIG. 20d) matched well with the cubic-phase garnet Li₅La₃Nb₂O₁₂ (JCPDS #80-0457), despite minor peak shifts at higher angles due to aluminum (Al) doping and variations in Li concentration. As a representative structure of fast lithium-ion-conductive garnet. Li₅La₃M₂O₅ (M=Nb, Ta) is widely used as a reference to distinguish conductive garnet phases from non-conductive ones. The well XRD pattern match of the aligned mesoporous garnet with JCPDS #80-0457 verifies that the wood templated garnet is the conductive cubic phase.

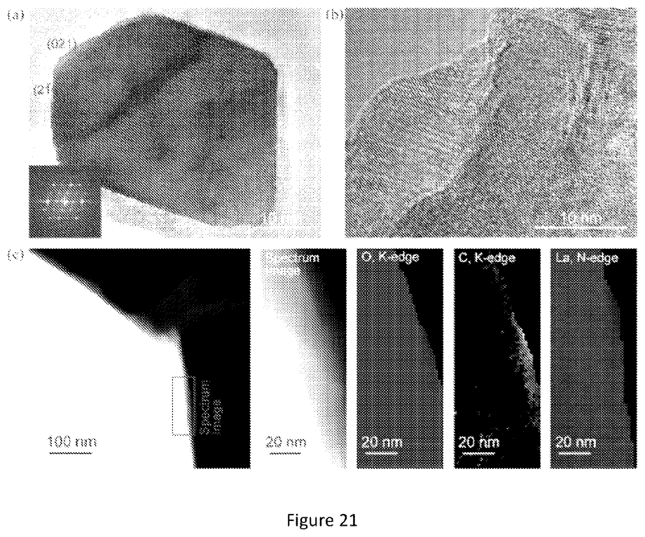

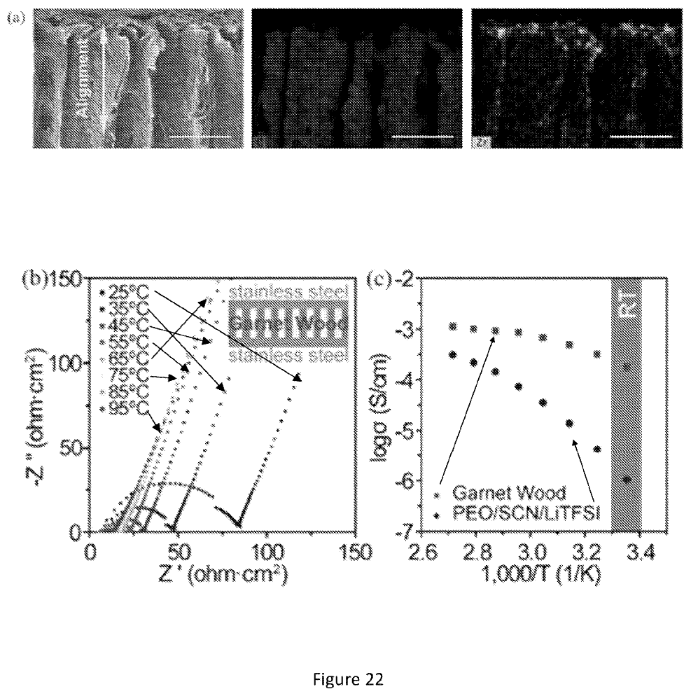

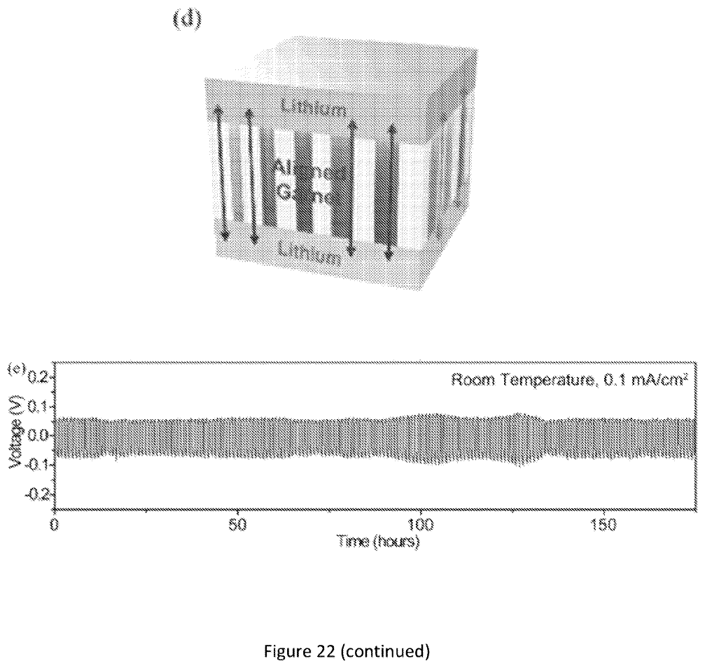

High-resolution transmission electron microscopy (HRTEM) of the resulting aligned garnet reveals the clear, well crystallized lattice structure of the garnet (FIG. 22a). The miller indices were calculated from the corresponding fast Fourier transform (FFT) pattern (Inset of FIG. 22a) and the lattice constant derived from the HRTEM and FFT is 12.982 Å, which agrees with previously reported values. Crystal grains with various orientations can be clearly distinguished in the HRTEM image of a larger garnet particle broken off from the structure (FIG. 21b). The TEM results indicate that the aligned mesoporous garnet has a highly crystallized, well-connected multicrystalline structure. Electron energy loss spectroscopy (EELS) was employed to analyze the composition of the garnet membrane. FIG. 21c shows the EELS spectrum with the region of interest (ROI) outlined. EELS mapping indicates the relative composition and distribution of oxygen, carbon, and lanthanum. The overlapping region of oxygen k-edge signal and lanthanum n-edge signal identifies the location of LLZO. Though the carbon k-edge signal is rare throughout the sample, a small overlapping region of oxygen k-edge signal and carbon k-edge signal was identified, which indicates that the Li₂CO₃ impurities caused by calcining in oxygen is minimum.

The garnet-wood was fabricated by infiltrating PEO polymer electrolyte into the aligned garnet. FIG. 22a characterizes the polymer infiltration with energy dispersive X-ray spectroscopy (EDX). The evenly distributed carbon signal from the top, down to the aligned garnet channels indicates complete and uniform infiltration of the polymer electrolyte, which is crucial for establishing sufficient Li ion transport pathways. As suggested in the literature, there are three possible Li ion transport pathways. The first pathway is the aligned PEO polymer electrolyte, whose bulk ionic conductivity (without fillers) is usually as low as 10⁻⁷ S/cm at room temperature. The second pathway is the aligned garnet-polymer interface. At the interface, the aligned mesoporous garnet behaves like ceramic fillers that can induce changes to the polymer segmental dynamics, and therefore influences lithium ion transport. Intensive studies on the influence of fillers on the ionic conductivity of polymer electrolyte suggests that ceramic fillers with Lewis acid characteristics can promote the lithium ion transport by anion coupling and providing preferential conductive pathways. The third pathway is transport through the high volume percentage (˜68%) aligned garnet nanostructure. Recent studies point out that among three transport pathways in garnet-polymer composite electrolyte systems, conducting through garnet phase is the most preferred, evidenced by tracking isotope labeled Li ion migration using nuclear magnetic resonance (NMR). Note that the typical bulk ionic conductivity of dense LLZO achieved in our lab using the same composition is up to 2.2×10⁻⁴ S/cm at room temperature. However, this bulk ionic conductivity is difficult to achieve in conventional mesoporous structures due to the highly tortuous transport pathways caused by random pores and insufficient solid-solid interfacial contact at the numerous pore gaps. In contrast, the low tortuosity of the aligned mesoporous garnet structure enables unobstructed Li ion transport along the normal direction of the flexible garnet-wood, which effectively promotes ionic conductivity.

The ionic conductivity of the garnet-wood was characterized by electrochemical impedance spectroscopy (EIS). A garnet-wood membrane (0.1 cm² area, 0.4 μm thick) was assembled into symmetric cells with stainless steel as the blocking electrodes and scanned from 1 MHz to 100 mHz. FIG. 22b shows the Nyquist plot of the electrolyte membrane tested from room temperature (25° C.) up to the melting temperature of PEO (65° C.). The experimental ionic conductivity is calculated using the electrolyte membrane thickness and area, and the results are shown in FIG. 22c. The garnet-wood membrane achieved an ionic conductivity of 1.8×10⁻⁴ S/cm at room temperature. The theoretical ionic conductivity of the composite is the total contribution of each phase weighted by the volume fractions. Given the PEO polymer electrolyte conductivity of 1.03×10⁻⁶ S/cm (FIG. 26) and garnet conductivity of 2.2×10⁻⁴ S/cm, the theoretical conductivity of garnet-wood is 1.5×10⁻⁴ S/cm at room temperature. In this low tortuosity structure with continuous conducting paths in each phase, the theoretical conductivity should hold unless there is enhanced conductivity at the two-phase interfaces. Therefore, we believe the difference between the theoretical and experimental conductivities can be attributed to an enhanced interface contribution to the total ionic conductivity.

As the operating temperature is increased, the intersection of the semicircle with the real impedance axis decreased, indicating an improved ionic conductivity with elevated temperature (FIG. 22b). At 95° C. the ionic conductivity increased to 1.1×10⁻³ S/cm, a 6.3 times improvement above the room temperature performance. The temperature dependence of the ionic conductivity for the garnet-wood can be expressed by the Arrhenius equation:

$$σ = A exp ( - \frac{{E}_{A}}{k T} )$$

Where σ is the total ionic conductivity of garnet-wood. At is the pre-exponential factor, T is the absolute temperature, E_{A} is the activation energy of garnet-wood, and k is the Boltzmann constant. The calculated activation energy of garnet-wood is 0.38 eV, which can be lowered further by adjusting the proportion of polymer electrolyte. This effect is due to various enhancement effects including the increase in the volume fraction of amorphous conducting phase as well as improvement in the long range polymer chain mobility.

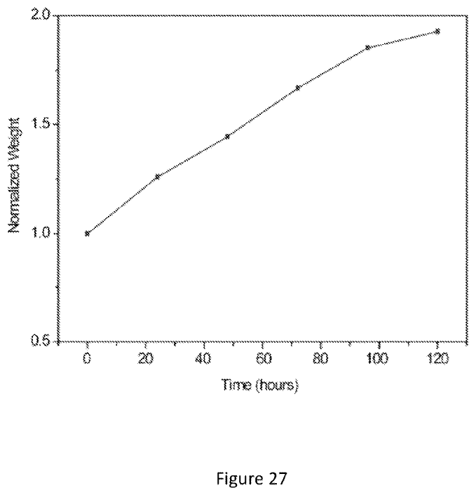

As a proof-of-concept, a Li metal/garnet-wood/Li metal symmetrical cell was fabricated and a Li stripping/plating test was performed at room temperature (FIG. 22d). FIG. 22e shows a characteristic 180 hours of the cycling at a current density of 0.1 mA/cm² for 30 min in each direction. The voltage response of the symmetric cell stabled at 50 mV with slight fluctuations. The symmetrical cell cycled well for over 600 hours with small polarization (FIG. 27). The long-term cycling performance indicates that the garnet-wood membrane enhanced with aligned mesoporous garnet can enable fast and stable ion transport. In addition, the polymer electrolyte also largely improves the mechanical flexibility of the aligned garnet enabling its use in Li metal batteries.

In summary, garnet-wood composite electrolyte with a multiscale aligned mesoporous structure is described. The scalable compressed wood template results in the unique low tortuosity and high surface area mesostructure that is critical to the improved electrochemical performance and mechanical stability. Ionically conductive polymer serves as a matrix to reinforce the mechanical strength of the aligned mesoporous garnet membrane and also provide additional ion transport pathways through the amorphous conductive phase and the garnet-polymer interfaces. Benefiting from these structural merits in combination with the intrinsic high ion conductivity and low tortuosity of the aligned mesoporous garnet, the garnet-wood composite electrolyte achieves a high Li ion conductivity of 1.8×10⁻⁴ S/cm at room temperature and 1.1×10⁻³ S/cm at 95° C. This is close to the bulk conductivity of garnet itself and moreover exhibits an enhanced contribution from the garnet/polymer interface. The garnet-wood demonstrates great potential as a low-tortuosity structure for highly conductive SSE and it also provides a model study for the design and optimization of solid state CPEs.

Experimental Section. Materials Preparation. The garnet precursor solution was prepared by dissolving stoichiometric LiNO₃ (≥99.0%, Aldrich), La(NO₃)₃ (≥99.9%, Aldrich), Al(NO₃)₃·9H₂O (≥98.0%, Aldrich). ZrO(NO₃)₂·xH₂O (≥99.9%, Aldrich), and acetic acid (≥99.7%, Aldrich) in ethanol (≥99.8%. Aldrich) at room temperature under magnetic stirring. The total cation concentration of the precursor solution was 2 mol/L, 1.5% excess lithium nitrate was added to compensate for lithium loss at high calcination temperature.

The wood template was soaked in the above-mentioned solution for 48 h to impregnate the garnet precursors. Excess solution was removed from the wood template and the sample was dried at 70° C. for 4 h. Subsequent thermal treatment was carried out in oxygen at 800° C. for 4 h to burn off the wood template and sinter the dispersed precursors. The sintering process was carefully controlled to retain the microstructure of the wood template. Garnet nanoparticles and nanofibers for TEM studies were obtained by grinding and sonicating the garnet membrane in isopropanol (IPA).

The PEO-based polymer electrolyte was prepared by dissolving PEO (Mv=600,000, Aldrich) with bis(trifluoromethane) sulfonimide lithium salt (LiTFSI, ≥99.85%, Aldrich, EO:Li⁺=8:1) into acetonitrile (anhydrous, 99.8%. Aldrich) under magnetic stirring in an argon-filled glovebox at room temperature, 15 wt % succinonitrile (SCN, 99%, Aldrich) was added into the solution and the mixture was magnetically stirred until SCN completely dissolved. The drop-cast polymer electrolyte in the aligned mesoporous garnet (garnet-wood) was fully dried in vacuum at room temperature for 1 hour before electrochemical testing.

Materials Characterization. XRD was performed on a Bruker D8 Advance with Cu K radiation. SEM images and their corresponding EDX images were obtained using a Hitachi SU-70 Field Emission SEM equipped with an energy dispersive x-ray spectrometer. TEM images were obtained using a JEM 2100 Field Emission Gun TEM equipped with an electron energy loss spectrometer for EELS studies. FFT image was computed from the high-resolution TEM image using Gatan Microscopy Suite. The EIS measurement was performed with a Solartron-1260 impedance gain phase analyzer on symmetric cells consisting of the garnet-wood between stainless steel plates as blocking electrodes. The cells were rested in an environmental chamber for 30 minutes at the predetermined temperature before each EIS test to reach thermal equilibrium and then scanned from 1 MHz to 100 mHz to acquire the impedance curves at various temperatures. The Li stripping/plating tests were performed with a BioLogic VMP₃ multi-channel potentiostat on symmetric cells consisting of the garnet-wood between Li metal foils as electrodes. The cells were cycled at a current density of 0.1 mA/cm² for 30 minutes in each direction at room temperature in an argon filled glovebox.

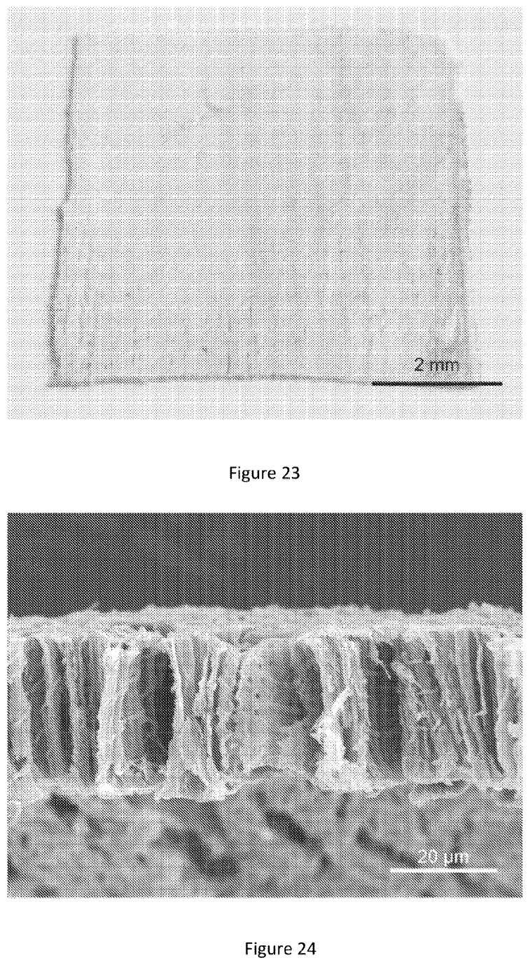

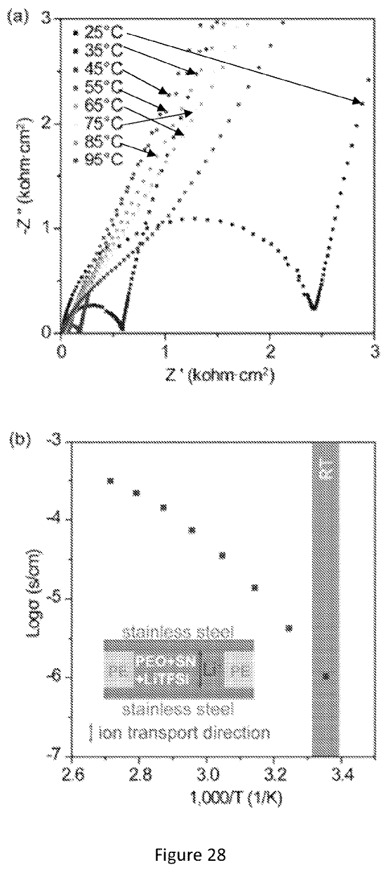

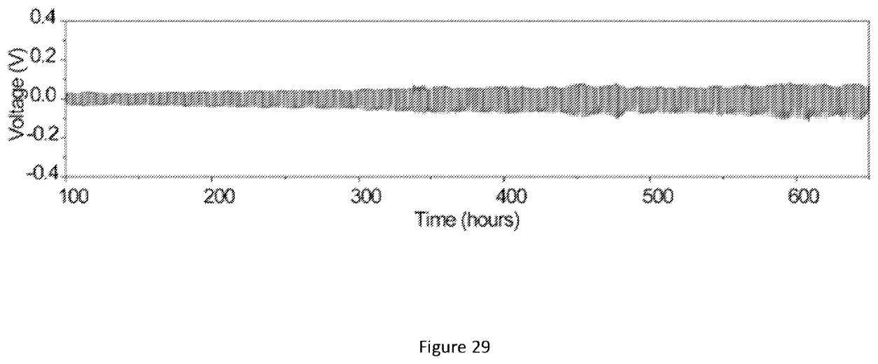

FIGS. 23-29 describe making solid-state electrolytes of this example and characterization of same.

### Example 5

This example provides a description of solid-state hybrid electrolytes of the present disclosure. This example also provides examples of making and characterization of such electrolytes.

Lithium-Ion Conductive Ceramic Textile: A New Architecture for Flexible Solid-State Lithium Metal Batteries. Designing solid-state lithium metal batteries requires fast lithium-ion conductors, good electrochemical stability, and scalable processing approaches to device integration. This example demonstrates a unique design for a flexible lithium-ion conducting ceramic textile with the above features for use in solid-state batteries. The ceramic textile was based on the garnet-type conductor Li₁₇La₃Zr₂O₁₂ and exhibited a range of desirable chemical and structural properties, including: lithium-ion conducting cubic structure, low density, multi-scale porosity, high surface area/volume ratio and good flexibility. The solid garnet textile enabled reinforcement of a solid polymer electrolyte to achieve high lithium-ion conductivity and stable long-term Li cycling over 500 h without failure. The textile also provided an electrolyte framework when designing a 3D electrode design to realize ultrahigh cathode loading (10.8 g/cm² sulfur) for high performance Li-metal batteries.

To achieve a fine distributed ionically conductive phase, a fibrous structure with a high surface area/volume ratio would be the ideal architecture for the ionic conduction and electrochemical reactions that occur in batteries. The template method provides a simple but effective way to generate the necessary structure, wherein a textile template is soaked with the ceramic precursor solution followed by pyrolysis to remove the organic components. The resulting fibrous ceramic features desirable properties that allow for integration in either flexible or rigid battery configurations. For example, ceramic fiber networks have been used to establish lithium-ion migration pathways within polymer electrolytes and improve the mechanical strength of the polymer. Alternatively, the ceramic textile can be combined with electrode materials in interdigitated or concentric arrangements to minimize electrolyte volume and maximize electrode utilization, thereby increasing active electrolyte area, lithium-ion interfacial transport, and tolerance for electrode volume change during charging/discharging.

This example demonstrated the fabrication of garnet based lithium-ion conductive ceramic textiles derived from templates, producing textiles with superior characteristics for integration into solid state batteries. The garnet textiles were used to provide a solid lithium-ion conducting framework that simultaneously reinforces polymer electrolyte for stable Li cycling over 500 h, and 3D electrode structure to achieve ultrahigh sulfur loading of 10.8 g/cm² for high performance Li-metal batteries. The simplicity of the template method makes it useful for fabricating ceramics with tailored compositions and structures, opening the possibility of building solid state batteries that are low cost and durable.

Material and methods. Synthesis of Garnet Textile. Various aliovalent cations have been suggested to effectively stabilize cubic phase garnet and obtain high lithium-ion conductivity at room temperature. Al-doped LLZO with the chemical composition of Li_{6.28}Al_{0.24}La₃ZrO_{11.98} was prepared by dissolving stoichiometric amounts of 2.31 g LiNO₃ (99%; Alfa Aesar), 0.48 g Al(NO₃)₃·9H₂O) (98%; Alfa Aesar), 6.94 g La(NO₃)₃·6H₂O) (99.9%; Alfa Aesar), and 5.0 g Zirconium propoxide solution (70 wt. %: Sigma Aldrich) in 30 ml ethanol with 15 vol % acetic acid. Excess LiNO₃ (15 wt. %) was added to compensate for lithium loss during the subsequent calcination procedure. Cellulose Textile templates were pretreated by annealing in air at 270° C. for 10 h, then rinsed with ethanol (Sigma Aldrich) and dried at 100° C. for 12 h. After pretreatment, the templates were soaked in a 2.5 mol/L LLZO precursor solution for 24 h. The multi-scale porosity existing in the porous templates enabled homogenous impregnation by the LLZO precursor. Thermal behavior of the LLZO precursor-infiltrated textile template was analyzed with Thermogravimetric analysis (TGA, STAR System). Calcination of the precursor impregnated templates was conducted in oxygen at different temperatures to obtain garnet textiles. The 3D morphology of garnet textile was scanned using a LK-H082 semiconductor laser model with a wavelength of 655 nm (Keyence). The crystallographic phase of the LLZO was analyzed by powder X-ray diffraction on a D8 Advanced with LynxEye and SolX (XRD, Bruker AXS) using a Cu Kα radiation source operated at 40 KV and 40 mA. The microstructure and element distribution were examined by analytical scanning electron microscope (SEM, Hitachi SU-70) equipped with an Energy Dispersive Spectrometer (EDS, Oxford Instruments).

Fabrication of Garnet Textile Reinforced Composite Polymer Electrolyte. The polymer matrix was prepared by dissolving LiTFSI (Sigma Aldrich) and PEO (˜600,000, Sigma Aldrich) in acetone nitrile as we have described in early work. The lithium salt/polymer mixture was repeatedly infiltrated into the garnet textile placed on a Teflon block. The composite polymer electrolyte was first dried in an argon-filled glove box, followed by drying in a vacuum oven to remove the residual solvent before morphological and electrochemical performance characterization. For comparison, an insulting Al₂O₃ textile prepared by the identical template method was fabricated and incorporated into the polymer matrix as the control composite electrolyte. Electrochemical impedance of the composite polymer electrolytes was measured in a stainless steel/composite polymer electrolyte/stainless steel sandwich configuration using a Solartron 1260 Impedance Analyzer A Teflon spacer was included to fix the thickness. Impedance tests were conducted with AC amplitude of 20 mV in the frequency range of 1 Hz and 1 MHz from 25° C. to 100° C. Long-term lithium cycling stability and compatibility of the composite polymer electrolyte was evaluated using a sealed Li/composite polymer electrolyte/Li symmetric cell. Charge and discharge cycling of the symmetric cell was monitored by an Arbin BT-2000 in an environmental chamber (Tenney).

Fabrication of Garnet Textile Electrode Architecture for Solid-State Li—S Battery. Garnet powder with a composition of Li₇La_{2.75}Ca_{0.25}Zr_{1.75}Nb_{0.25}O₁₂ was synthesized following the same processes in our early work. Scalable tape casting and hot laminating methods were used to fabricate the dense electrolyte support. The laminated green tape was sintered at 1050° C. in a tube furnace under oxygen atmosphere. Garnet textiles were sintered onto the garnet electrolyte support in oxygen to form a framework for cathode infiltration. The cell was assembled in an argon-filled glovebox with O₂ and H₂O level both under 0.1 ppm. Lithium metal was melted onto the dense garnet electrolyte support coated with an ultrathin layer of amorphous Si to achieve proper interfacial contact.

The sulfur slurry was prepared by mixing Sulfur powder (Sigma Aldrich), carbon nanotubes (Carbon Solutions) and PVP (˜40,000. Sigma Aldrich) in a mass ratio of 8:1:1 in N-methylpyrrolidone (Sigma Aldrich) to achieve a concentration of ˜10 mg/mL. After sonication for 5 h to obtain a dilute and uniform suspension, drops of the sulfur slurry were repeatedly applied to the garnet textile to infiltrate the open porosity and dried. The final sulfur loading was calculated by subtracting the weight of the half-cell before cathode slurry infiltration from the total weight of the full battery and then multiplying the weight ratio of sulfur in the cathode mixture. A small amount of 1M LiTFSI in DME/DOL was introduced into the cathode to facilitate sulfur/garnet contact before carbon felt was placed on the cathode side as a spacer and current collector. The battery was sealed in a coin-type cell with epoxy and connected to an Arbin BT-2000 for charge and discharge measurement.

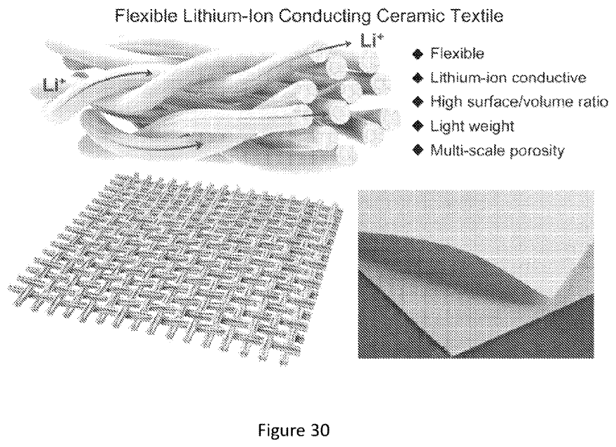

Results and discussion. Lithium-ion conductive ceramic textiles were created by impregnating the templates with precursor solutions followed by pyrolysis conversion. As illustrated in FIG. 30, the flexible ceramic textile retained the structural characteristics of the original textile template, which differed significantly from the rigid network of discrete particles in conventionally sintered porous ceramic powder compacts. The textile structure consisted of a network of continuous interlocked fibers and interlaced yarns through weaving that impact the spatial distribution of lithium-ion conducting material and open pores. Movement of lithium-ions can occur inside and along the surface of polycrystalline fibers over the entire textile pattern. Small, polydisperse and interconnected pores existed between individual fibers, while discrete large pores in relatively uniform size and shape were found between adjacent yarns.

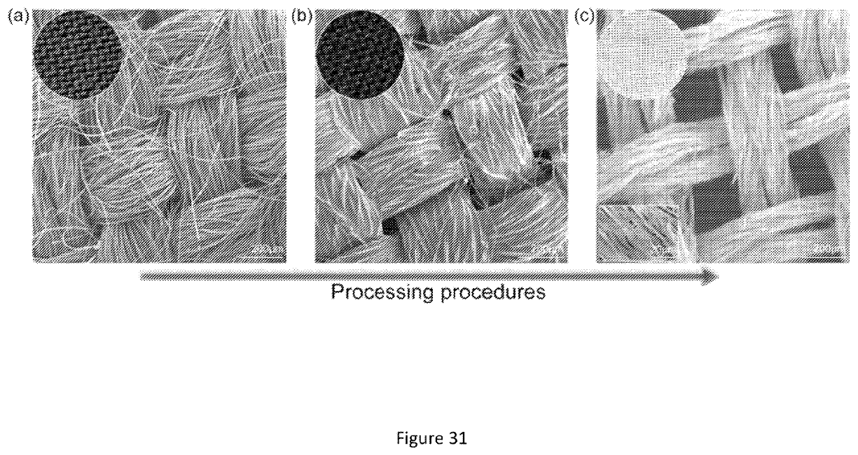

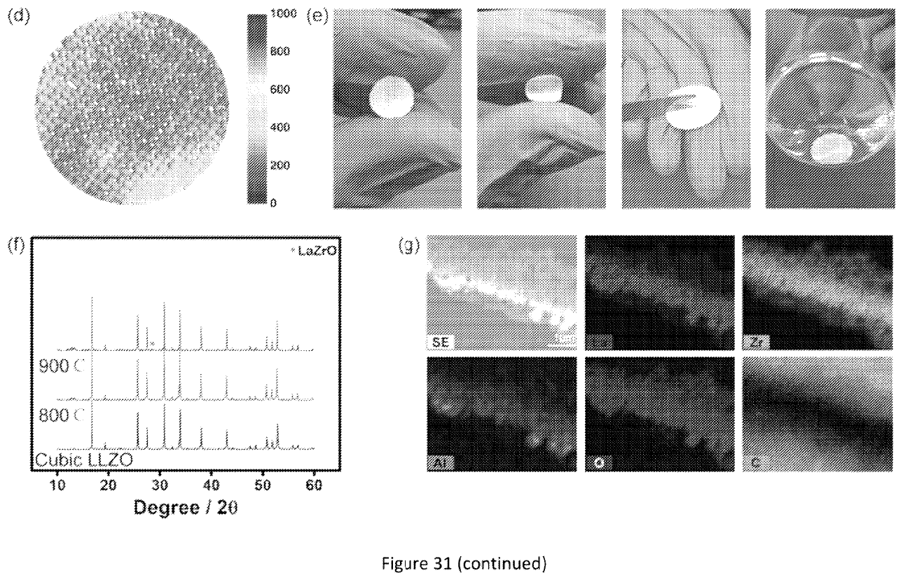

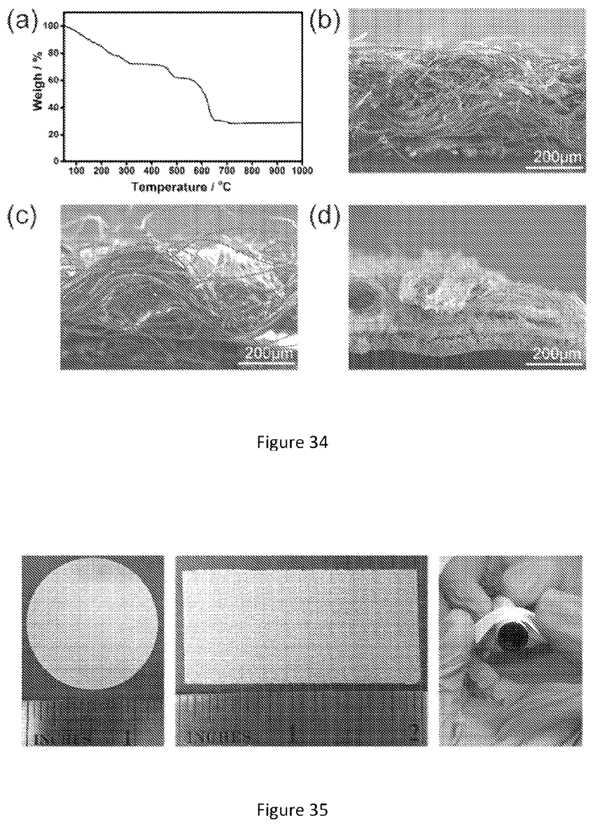

Characterization of Flexible Garnet Textile. Fibrous ceramic textiles are commercially available products in different technical fields. The production of ceramic fibers and textiles can be categorized into direct spinning processes and indirect template processes. The general procedure of the template process is elucidated by the representative images in FIG. 31a-c: (1) pretreating the template; (2) impregnating the template with precursor solution; (3) converting the precursors into nano-sized ceramic oxide via pyrolysis of the template and sintering of the relic structure at high temperature (Thermogravimetric analysis in FIG. 34a). Garnet textiles essentially retained the characteristic physical features of the original template, which consisted of continuous individual microfibers of approximately 10 μm in diameter that were arranged mostly parallel and twisted to each other. Cross-sectional SEM images can be referred to FIG. 34b-d. The fibers were bundled together into yarns of about 200 μm in diameter interlacing with each other to form the periodically ordered woven pattern. Interfiber pores ranged from 10 to 20 μm in diameter and larger pores between yarns were formed after thermal treatment.

For the purpose of quality control and inspection, nondestructive 3D laser scanning was applied to map large areas of the geometry of the garnet textile. The reconstructed digital structure in FIG. 31d shows a typical over one-under one, plain weave textile pattern. Height profiles of the topography indicate the distance between the highest position of the cross-yarn junction and the lowest position with ground contact in the pattern. The junction areas were generally around 200 μm in height, while some of the edge areas showed slightly larger values. The upward edge curling can be eliminated by strict process control to ensure proper sintering. FIG. 31e shows the pronounced physical features of garnet textile. Distinct from the rigid appearance of typical sintered ceramics, garnet textiles performed similar to the template with regards to tolerating certain flexural strength, geometrical tailoring and organic solvent erosion. Smooth transition from small scale fabrication to large scale manufacturing would be possible due to the simplicity, rapidity, and cost-saving characteristics of the template method. FIG. 35 shows how the garnet textile can be tailored for particular shapes in large dimension.

In addition to the ability of creating versatile ceramic structures, the template method offers chemical flexibility when synthesizing complex oxides. Garnet-type conductors with nominal composition of Li₇La₃Zr₂O₁₂ exist in two phases: cubic and tetragonal. The cubic structure is favorable for high ionic conductivity, but is stable only at high temperature. Through simple composition design by doping with supervalent cations and optimizing lithium concentration in the precursor solution, stabilization of the cubic phase can be achieved at sintering temperatures as low as 800° C., as shown in FIG. 31C. Attention must be given to ensuring the calcination process avoids over-sintering, which would cause excessive volatilization of lithium and segregation of lanthanum zirconate (LZO) phase. Homogenous distribution of constituent chemical elements of garnet fibers was confirmed by EDS in FIG. 31g. The element aluminum served as a doping cation to stabilize the cubic phase and promote sintering because of its simplicity and low cost.

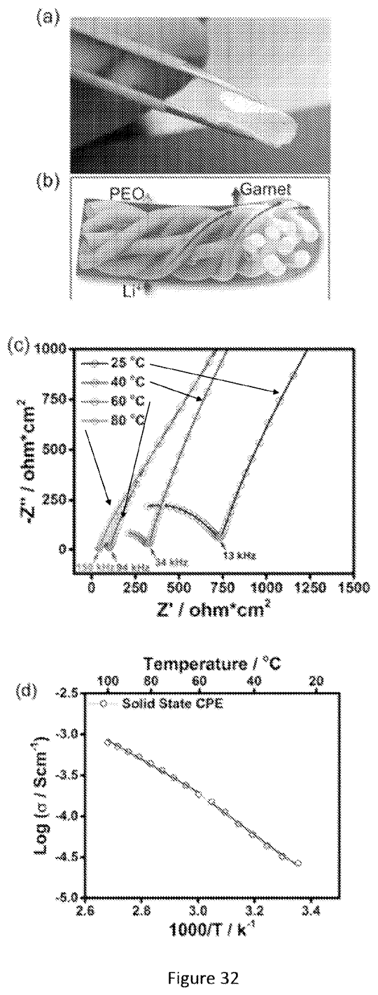

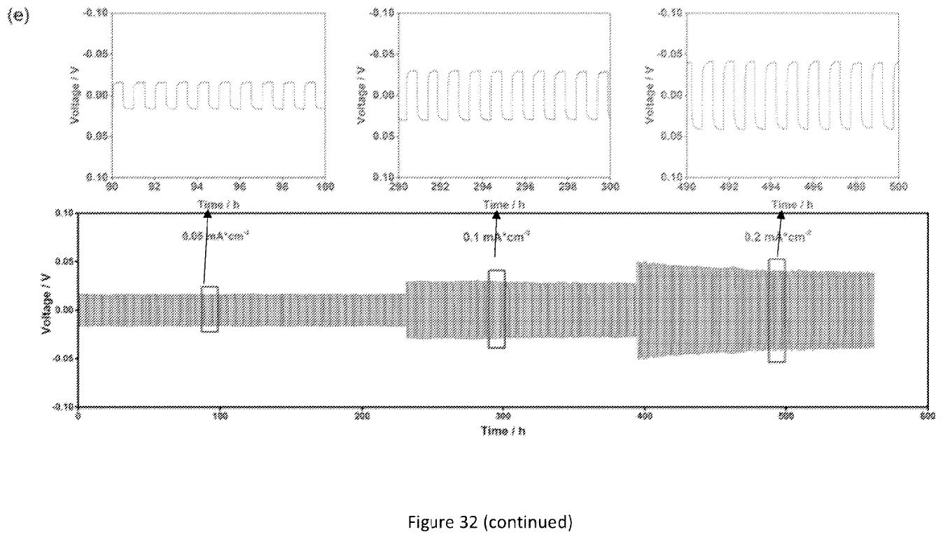

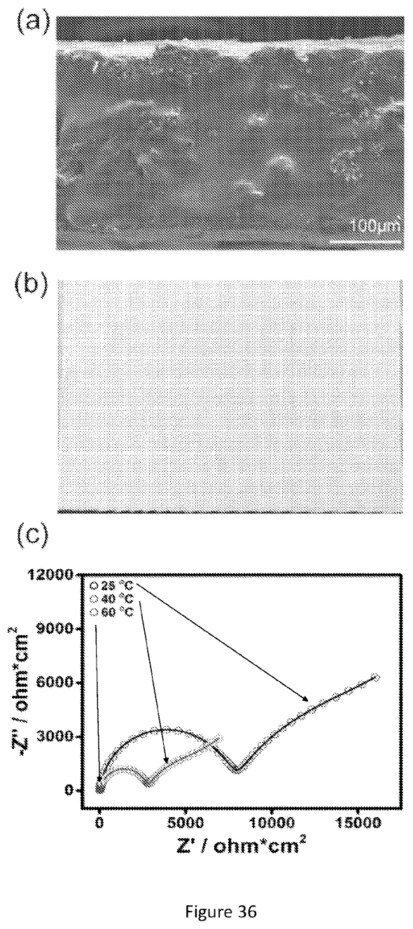

Garnet Textile Reinforced Flexible Composite Polymer Electrolyte. The structural and chemical advantages of the garnet textile make it ideal for reinforcing the mechanical and electrochemical properties of a composite polymer electrolyte (CPE), as shown in FIG. 32. The free-standing CPE was prepared by vacuum infiltrating a solution containing PEO and lithium salts into the garnet textile. The dried CPE in FIG. 32a appeared soft and flexible, indicating that efficient wetting and capillary action successfully drew the fluid into the multi-level open pores, which allowed strong physical bonding between the garnet fibers and the polymer matrix. Cross-sectional microstructure analysis further confirmed the CPE appeared fully densified without any noticeable porosity in FIG. 36a. Despite the cured CPE appearing to be a homogenous solid, it consisted of physically and chemically unique ceramic and polymer phases separated by distinct interfaces. Both components therefore affected the lithium-ion transfer kinetics within the CPE, elucidated by the schematic in FIG. 32b Most continuous ceramic fibers are bundled into yarns that penetrate through the PRO matrix. The yarns are generally oriented perpendicular to the vertical direction of lithium-ion transfer within the CPE (bold arrow). Lithium-ions migrate across the CPE through a multi-step process: (1) lithium-ions migrate through the PEO to the “bottom” of the garnet fibers and transfer from the PEO into the higher conductivity fiber: (2) lithium-ions migrate along the length of the fiber until reaching the “top” of the yarn and then transfer back to the PEO. This process minimizes the involvement of resistive garnet/polymer interfaces or diffusion through the polymer bulk (dotted arrow), making lithium-ion diffusion less dependent on the solvated lithium content of the polymer matrix.

FIG. 32c presents typical impedance plots for the CPE measured at different temperatures. Lithium-ion transfer processes were divided into ion conduction within the CPE (high frequency arc) and ion blocking at the CPE/stainless steel interface (low frequency inclined tail). The resistance of the CPE was obtained by reading the real impedance values at the high frequency intercept of the arc. FIG. 32d analyzes the temperature dependence of lithium-ion conductivity using an Arrhenius plot. In general, lithium-ion conductivity exhibited non-linear behavior as temperature increased. A slight reduction in activation energy occurred when temperatures exceeded 60° C. corresponding to the phase transition temperature of PEO. It is known that when a PEO-LiX system undergoes a thermal phase transition, the conductivity shows a sharp change in activation energy. In contrast, the energy barrier to lithium-ion conduction in crystalline garnets is expected to remain constant across the tested temperature range. Therefore, the smooth transition in activation energy observed for the CPE suggests that the fibrous garnet phase played a dominant role in lithium-ion conduction within the CPE, by forming a long-range garnet fibrous network and continuous channels along the fiber surfaces. To further elucidate the effect of Li-ion conducting garnet textile on the electrochemical performance of the CPE, a control sample was made using an insulating Al₂O₃ textile fabricated by the identical template method (FIG. 36b). The EIS of this control sample was measured as a function of temperature (FIG. 36c) and the resulting high impedance and corresponding low room temperature conductivity of 2.48×10⁻⁶ S/cm indicates that the Al₂O₃ phase and ceramic/polymer interface provide an insignificant contribution to Li-ion conduction within the CPE as this is essentially the room temperature polymer conductivity, confirming the dominant contribution from the Li-ion conducting garnet textile phase.

Measured lithium-ion conductivities of the garnet CPE were 2.7×10⁻⁵ S/cm at 25° C. and 1.8×10⁻⁴ S/cm at 60° C. These are an order of magnitude higher than the conductivities of the PEO-LiX polymer electrolyte system, ˜10⁻⁶ S/cm at 25° C. and ˜10⁻⁵ S/cm at 60° C., which comprises 85 vol. % of the CPE. This is due to the Al-doped garnet which has a reported ionic conductivity of 4×10⁻⁴ S/cm at 25° C., however it comprises a CPE volume fraction of only 15 vol. %. The corresponding theoretical volume fraction normalized CPE conductivity at 25° C. is 6×10⁻⁵ S/cm, which is consistent with the measured CPE conductivity. Therefore, a significant increase in conductivity could readily be achieved by increasing the garnet phase volume fraction by optimizing the garnet ceramic textile densification processes.

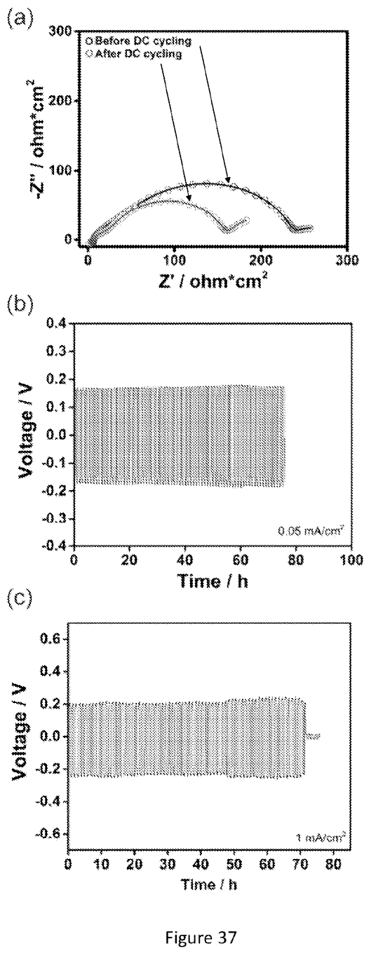

Long-term lithium cycling stability and compatibility of the CPE was evaluated by galvanostatic striping (0.5 h) and plating (0.5 h) measurement. Stable DC cycling as a function of current density was achieved over the entire test period at 60° C. in FIG. 36e. When current densities were set to 0.05 mA/cm² and 0.1 mA/cm′, symmetrical cells achieved low over-potentials of 15 mV and 27 mV, respectively. As the current densities were increased to 0.2 mA/cm², an immediate rise in over-potential occurred, which reached a maximum value of 47 mV. The over-potential gradually decreased and stabilized at 41 mV during the rest of the test period. The total resistance, obtained from the voltage vs. current density, and the impedance measurements (FIG. 37a) decreased as the current density and operation time increased, which might be due to activation diffusion processes in the CPE and improvement of the lithium/CPE interface. Stable galvanostatic cycling of the CPE was also achieved at lower operating temperature (FIG. 37b) and higher current density (FIG. 37c). For practical application, further reduction of overpotential and extension of operating life requires increasing garnet phase loading in the multi-level pores and employing stiffer cross-linked polymers.

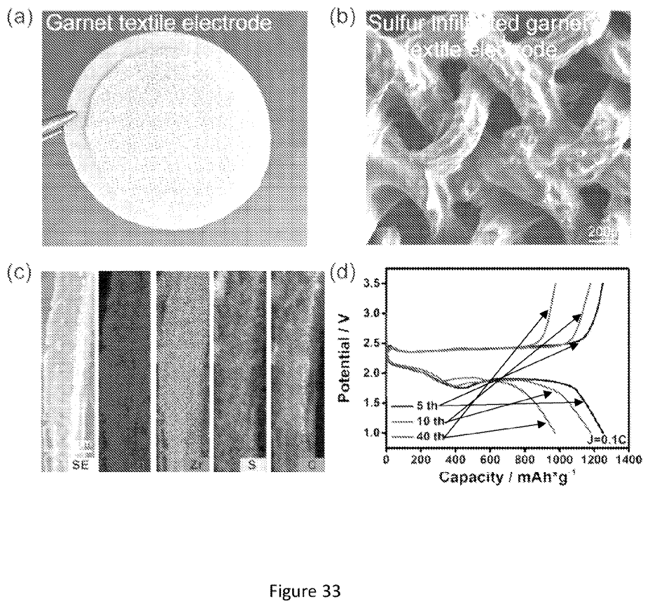

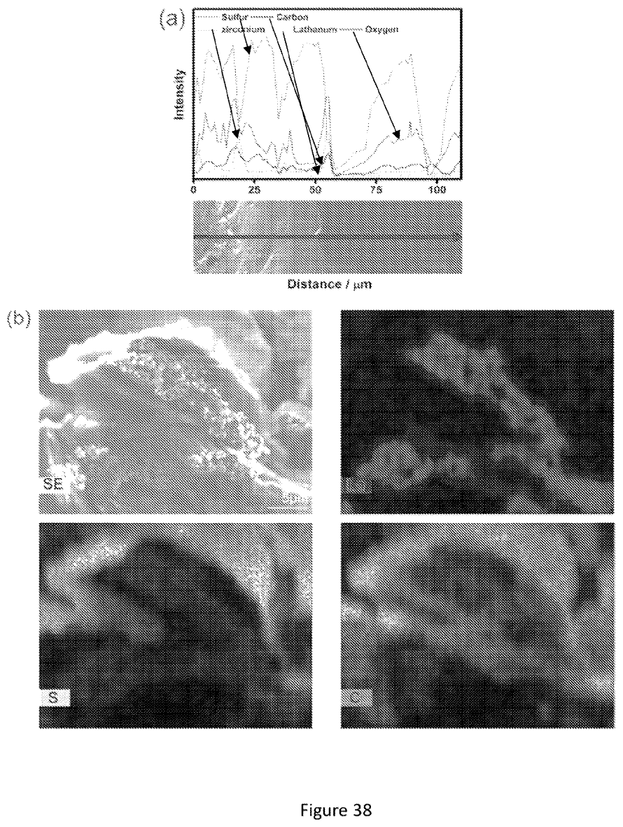

Garnet Textile structured 3D Electrode Architecture. Garnet textiles can also be used to make 3D electrode architectures, wherein the textile is sintered on a dense electrolyte support (FIG. 33a) and electrode material is infiltrated into the textile structure. Li—S batteries are demonstrated here as a proof of concept due to the high energy density and low material cost of sulfur cathodes. The well-distributed porosity of the fibrous structure allowed the textile to easily accommodate high sulfur loading. FIG. 33b shows the SEM image of the garnet textile loaded with 10.8 mg/cm² of sulfur. Garnet fibers were linked together and the open porosity was filled with the sulfur/carbon mixture. EDX linear scan across the region of the yarn/electrolyte boundary reveals sulfur/carbon on the exposed surface of the garnet yarn and the electrolyte in FIG. 38a. Cross-sectional analysis exhibits that the sulfur/carbon mixture has penetrated the porous textile to coat individual fibers and reached the dense electrolyte surface in FIG. 38b. Under higher magnification, EDX mapping confirms homogeneous elemental distribution of sulfur/carbon loaded onto the garnet fibers and intimate contact between the continuous lithium-ion conducting phase, electron conducting phase and sulfur phase in FIG. 33c.

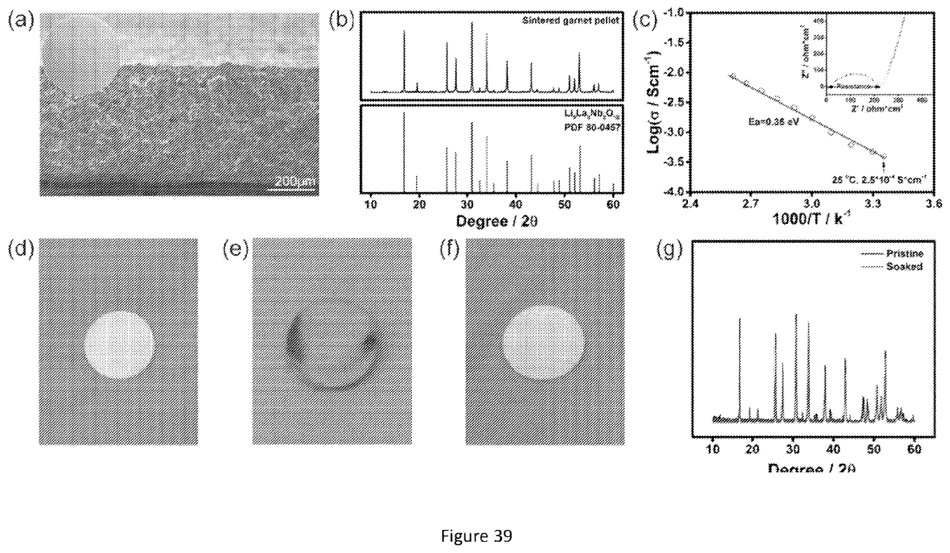

Solid-state Li—S batteries were assembled to demonstrate the electrochemical advantages of the garnet textile 3D electrode architecture. A small amount of liquid electrolyte was added to activate the sulfur and improve contact between the garnet and the sulfur without creating an undesirable lithium-ion barrier. This hybrid configuration was still predominantly solid-state despite the small amount of liquid electrolyte. The dense garnet electrolyte support functioned as lithium-ion conductor, electron insulator, and lithium-polysulfide shuttle shield in FIG. 39.

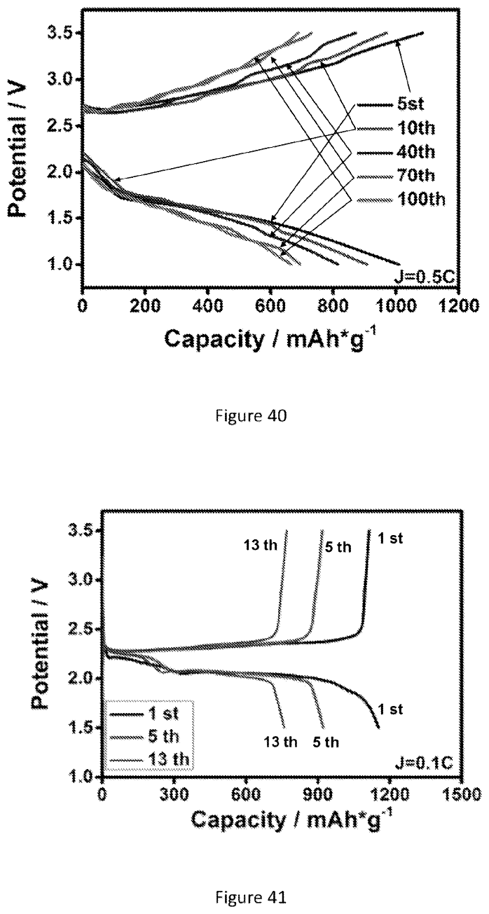

Charge-discharge profiles of the solid-state Li—S battery loaded with 10.8 mg/cm² sulfur cycled at 0.15 mA/cm² are presented in FIG. 33d. The sulfur cathode exhibited two discharging plateaus at −2.1 V and ˜1.8 V, while the charging profile had corresponding plateaus at ˜2.38 V and ˜2.43V. Relatively large polarization over-potential between charge and discharge (˜0.6 V) may be caused by the polarization contribution from the relatively thick garnet electrolyte and the impurities on the garnet electrolyte surface, which could be improved by reducing the electrolyte thickness and adding a moisture-proof LiF layer or additional liquid electrolyte. Discharge capacity reached a high value of 1.250 mAh/g in the fifth cycle as sulfur utilization was improved due to the continuous wetting process by the small amount of added liquid electrolyte. The 3D Li-ion conductive electrode structure also allowed successful cycling of the solid-state Li—S battery at a current density of 0.75 mA/cm² (FIG. 40). To maximize the volume utilization of textile electrode architecture, nearly double the sulfur content (˜18.6 mg/cm²) was attempted. Such high sulfur loading led to lower utilization and early cycling degradation (FIG. 41). However, the stabilized reversible high capacity of 800 mAh/g, confirmed the energy storage capacity of an electrode framework built with a garnet textile.

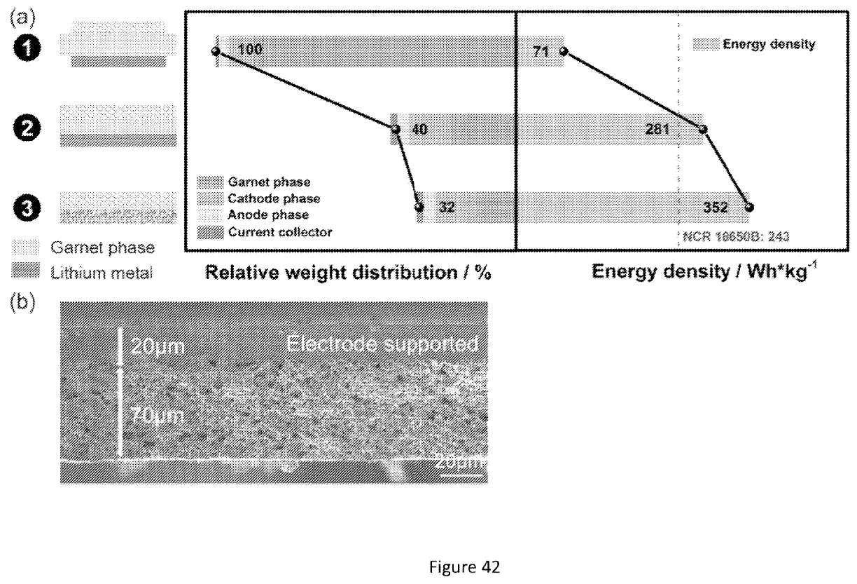

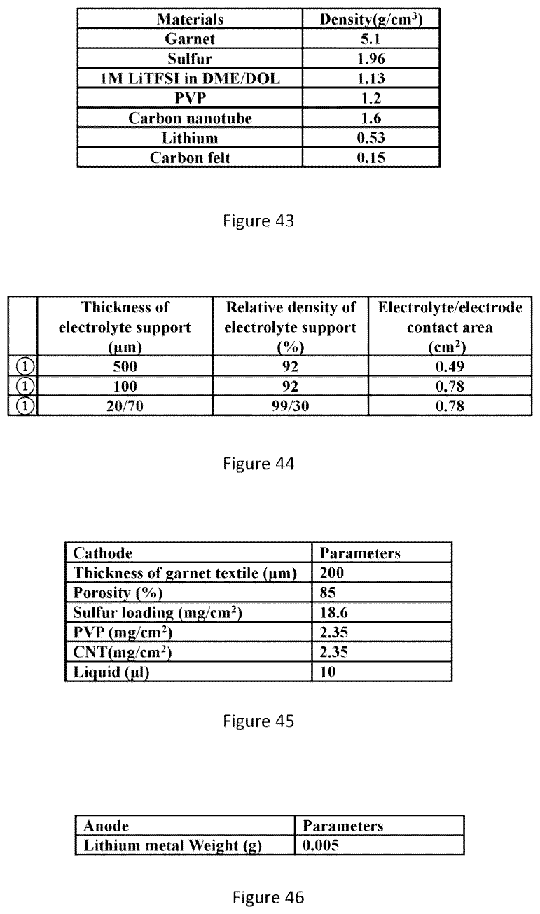

The theoretical energy density of a Li—S battery using a dense solid-state electrolyte to separate the lithium and sulfur was projected to be as high as 500 Wh/kg at cell level. In comparison FIG. 42a shows the energy densities of solid-state Li—S batteries utilizing ceramic textiles for sulfur loading and variable dense electrolyte structure for interfacing with lithium. With a 500 μm-thick electrolyte support and 63% utilization of electrolyte area, the attainable energy density was 71 Wh/kg. Reducing the electrolyte support thickness to 100 μm and matching the electrolyte/electrode area to carry more sulfur would enable a higher energy density of 281 Wh-kg. Further reduction in electrolyte support thickness requires development of a complex electrolyte structure to maintain mechanical strength. FIG. 42b shows a representative SEM image of the necessary bi-layer structure consisting of a thin dense electrolyte (20 μm) and a porous substrate (70 μm). Lithium metal could be infused into the pores to create abundant lithium garnet transfer interfaces and further promote mechanical strength. Integrating the garnet textile and the bi-layer support will make it possible to achieve an even higher energy density of 352 Wh/kg, which significantly exceeds the capability of the state-of-the-art lithium-ion batteries.

We successfully demonstrated a flexible lithium-ion conducting garnet textile fabricated by a simple template method. The unique architectural advantages of the flexible fibrous garnet textile allow the creation of a solid-state electrolyte framework with continuous lithium-ion conducting paths and high surface-volume ratio Incorporation of the textile into solid polymer electrolyte enables improved lithium-ion conduction and stable Li cycling over 500 h. In addition, the tailored garnet textile was used to fabricate 3D porous electrode to accommodate high sulfur loading (10.8 mg/cm²) and the resulting battery delivered a high capacity of 1000 mAb/g. Current laboratory scale fabrication procedures can be translated to affordable, reliable and industrially-relevant scale production. While initial efforts have so far been directed to solid state lithium metal battery, the novel structural design strategies utilized in this example is expected to be able to be applied to other solid-state devices for energy storage and conversion beyond lithium-ion technology.

FIGS. 34-42 describes flexible solid-state electrolytes of this example and characterization of these electrolytes. These figures provide thermogravimetric analysis; additional SEM images; photographs of garnet textile in larger dimension; characterization of composite polymer electrolyte; SEM image of sulfur infiltrated garnet textile electrode; characterization of the stability of garnet and sulfur; performance of solid state battery with higher sulfur loading; and calculation of energy density.

### Example 6

This example provides a description of solid-state hybrid electrolytes of the present disclosure. This example also provides examples of making and characterization of such electrolytes.

Flexible, Solid-State Ion-conducting Membrane with 3D Garnet Nanofiber Networks for Lithium Batteries. Beyond state-of-the-art lithium-ion battery (LIB) technology, with metallic lithium anodes to replace conventional ion-intercalation anode materials, is highly desirable due to lithium's highest specific capacity (3860 mA/g) and lowest negative electrochemical potential (−3.040 V vs. the standard hydrogen electrode). In this example, a three-dimensional (3D) Li-ion conducting ceramic network, based on garnet-type Li_{6.4}La₃Zr₂Al_{0.2}O₁₂ (LLZO) lithium-ion conductor to provide continuous Lit transfer channels, in a PEO-based composite is described. This composite structure further provides structural reinforcement to enhance the mechanical properties of the polymer matrix. The flexible solid-state electrolyte composite membrane exhibited an ionic conductivity of 2.5×10⁻⁴ S/cm at room temperature. The membrane can effectively block dendrites in a symmetric Li|electrolyte|Li cell during repeated lithium stripping/plating at room temperature with a current density of 0.2 mA/cm² for around 500 hours, and with a current density of 0.5 mA/cm² for over 300 hours. These results provide an all solid ion-conducting membrane that can be applied to flexible lithium-ion batteries and other electrochemical energy storage systems, such as lithium-sulfur batteries.

This example describes a flexible, solid-state lithium ion-conducting membrane based on a three-dimensional (3D) ion-conducting network and polymer electrolyte for lithium batteries. The 3D ion-conducting network is based on percolative garnet-type Li_{6.4}La₃Zr₂Al_{0.2}O₁₂ (LLZO) solid-state electrolyte nanofibers, which enhance the ionic conductivity of the solid-state electrolyte membrane at room temperature and the mechanical strength of conventional polymer electrolyte. The membrane has shown superior electrochemical stability to high voltage, and high mechanical stability to effectively block lithium dendrites. This work represents a significant breakthrough to enable high performance of lithium batteries.

In this example, a three dimensional (3D) ceramic network based on garnet-type Li_{6.4}La₃Zr₂Al_{0.2}O₁₂ (LLZO) nanofibers to provide continuous Lit transfer channels in PEO-based composite electrolytes as all solid ion-conducting membranes for lithium batteries was successfully developed. A garnet-type lithium-ion conducting ceramic was selected as the inorganic component due to several desired physical and chemical properties, including: (a) high ionic conductivity approaching 10⁻³ S/cm at room temperature with optimized element substitution: (b) good chemical stability against lithium metal; and (c) good chemical stability against air and moisture. FIG. 47 shows the schematic structure of 3D LLZO/polymer composite membrane. The LLZO porous structure consists of randomly distributed and interconnected nanofibers, creating a continuous lithium-ion conducting network. The La salt/PEO polymer is then filled into the porous 3D ceramic networks, forming the 3D garnet polymer composite membrane. Different from conventional methods to prepare polymer electrolytes, the 3D garnet/polymer composite membrane doesn't need to mechanically mix fillers with polymers, instead we can directly soak a pre-formed 3D ceramic structure into Li salt/polymer solutions to get the desired polymer composite electrolyte hybrid structure, thus simplifying fabrication process and avoiding the agglomeration of fillers.

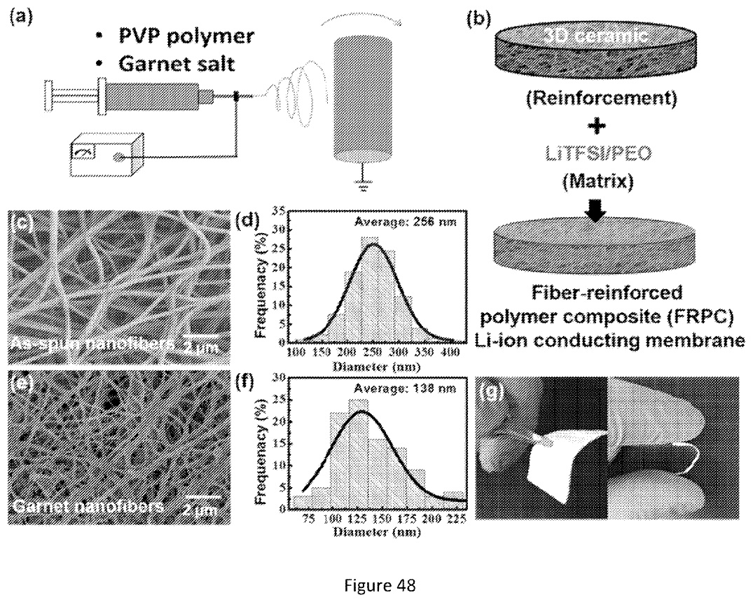

Results and discussion. FIG. 48 schematically shows the procedure to synthesize flexible solid-state garnet LLZO nanofiber-reinforced polymer composite electrolytes. As shown in FIG. 48a, garnet LLZO nanofibers were prepared by electrospinning of polyvinylpyrrolidone (PVP) polymer mixed with relevant garnet LLZO salts, followed by the calcination of the as-prepared nanofibers at 800° C. in air for 2 hours. On the drum collector of the electrospinning setup, a thin nonwoven fabric was covered to collect the nanofibers.

The schematic fabrication of FRPC Li-ion conducting membrane using the 3D porous garnet nanofiber network is shown in FIG. 2b. A PEO polymer mixture with Li salt, such as bis(trifluoromethane) sulfonimide lithium salt (LiTFSI), is prepared. Then the Li salt. PEO polymer is reinforced by the 3D nanofibers to form a composite electrolyte, which can be called fiber-reinforced polymer composite (FRPC) electrolyte membrane. Compared to filler-containing polymer electrolyte, the FRPC electrolyte membrane maintains the framework of 3D garnet nanofiber networks and is believed to have a better mechanical property due to the continuous nanofiber structure that enhances the integrity of polymer electrolyte.

Morphologies of the as-spun PVP/garnet salt nanofibers and calcinated garnet nanofibers were characterized by scanning electron microscopy (SEM) as shown in FIGS. 48c and 48e. Before calcination, the PVP/garnet salt nanofibers have smooth surfaces and nanofibers have a diameter of 256 nm in average. The corresponding diameter distribution is shown in FIG. 48d. After the calcination at 800° C. in air, PVP polymer were removed and garnet LLZO nanofibers were obtained. The average diameter of the nanofibers decreased to 138 nm. Their diameter distribution is given in FIG. 48f. After annealing, garnet nanofibers were “inter-welded” with each other, forming cross-linked 3D garnet nanofiber networks. The large volume of inter-space between nanofibers can facilitate La salt/polymer infiltration to form the composite membrane. The flexibility of the membrane is demonstrated in FIG. 48g. The bendable electrolyte membrane can then be employed to construct flexible solid-state lithium batteries. Note that the design of flexible 3D ion-conducting networks mainly depends on ceramic garnet nanofibers, for which a thin and mechanically stable structure are desired for good ionic conductivity and feasible battery fabrication. To achieve a thinner polymer composite electrolyte while maintain a good mechanical stability, some important parameters need to be considered, which include electrospinning process (e.g., collecting time, drum rotating speed, syringe moving speed, and the like), precursor solution preparation (e.g., garnet salt concentration, polymer concentration, polymer molecular weight, solvent selection, and the like), and thermal annealing optimization (e.g., heating rate, temperature, time, cooling rate, and the like).

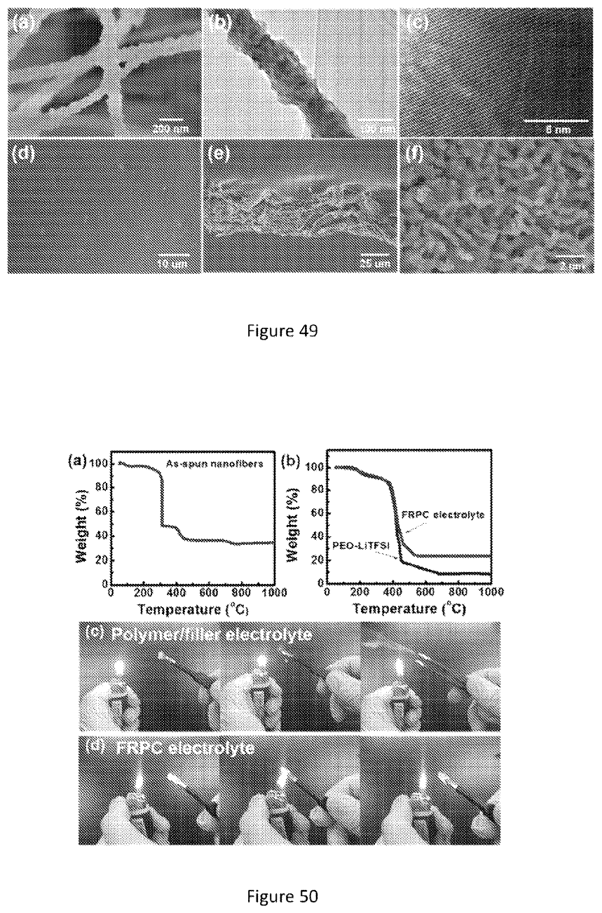

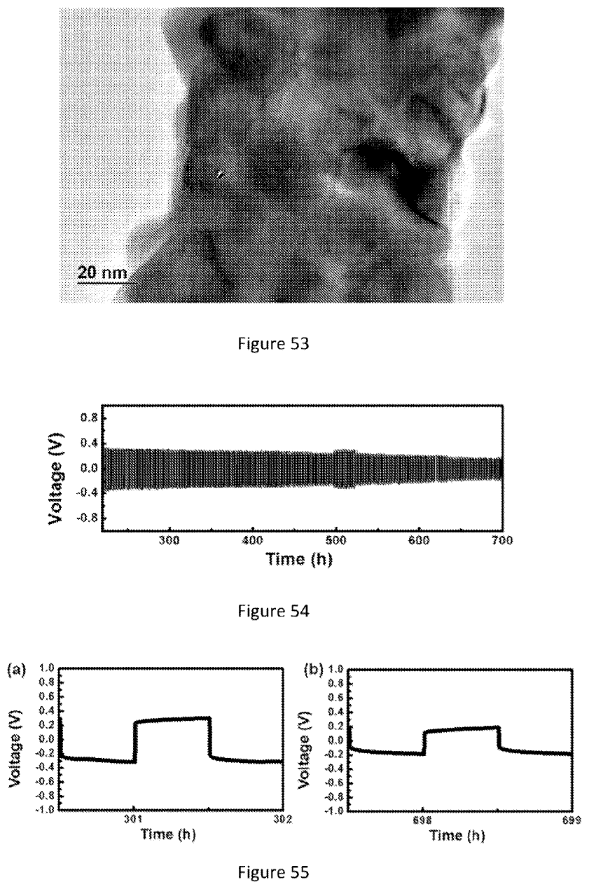

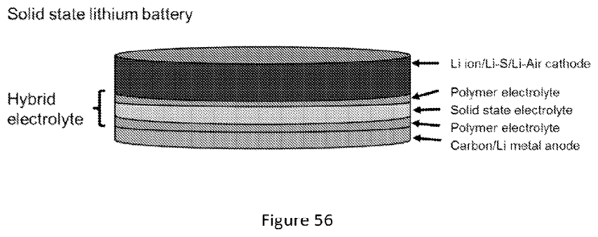

FIG. 49 shows the morphological characterization of the garnet nanofibers and resulting FRPC electrolyte. As shown in FIG. 49a, garnet nanofibers were bonded together at their intersection points, forming a cross-linked network. These interconnected garnet nanofibers offer a continuous ion-conducting pathway due to the extended long-range lithium transport channels, which should be superior to the isolated particle fillers that are distributed in typical polymer matrixes. FIGS. 49b and 49e show the transmission electron microscopy (TEM) images of the garnet nanofibers. The garnet nanofiber has a polycrystalline structure, consisting of interconnected small crystallites to form the long, continuous nanofiber (FIG. 49b). FIG. 53 shows the magnified TEM image of a garnet nanofiber with an average grain size of 20 am in diameter. FIG. 49c indicates the highly crystalized structure of the garnet grain.

The morphologies of FRPC electrolyte were examined by SEM (FIG. 49d-f). The FRPC electrolyte exhibited a smooth surface, which came from the PEO-LiTFSI polymer (FIG. 49d). Inside of the FRPC electrolyte, it was observed that the 3D porous garnet nanofiber network supported the main structure of the composite, and PEO-LiTFSI polymer was infiltrated into the porous garnet membrane and filled the inter-space between garnet nanofibers. The cross-section image of the FRPC electrolyte showed a thickness of 40-50 μm (FIG. 49e) To increase interphase contact between garnet nanofibers and PEO-LiTFSI polymer, the FRPC electrolyte was thermally treated at 60° C., which is slightly above the polymer melting temperature (Tₘ), to enable the melted PRO-LiTFSI polymer to fully infiltrate the 3D porous garnet nanofiber network. As shown in FIG. 49f, after thermal treatment PEO-LiTFSI polymer was fully embedded with garnet nanofibers. Garnet nanofibers increased to an average diameter of 500 nm due to the PEO-LiTFSI polymer coating. The interconnected pores were filled with polymer to maintain good lithium ion transfer. The FRPC electrolyte membrane is proposed to have three ion-conducting pathways: one is the inter-welded ceramic garnet nanofiber network, another is the continuous garnet fiber/polymer interface, and the third is the Li salt-containing polymer matrix. Due to the higher ionic conductivity of garnet-type electrolytes than that of Li salt-containing polymer electrolyte, we believe the former two ion-conducting pathways are the dominant factors to provide improved ionic conductivity to the electrolyte membrane.

Thermogravimetric analysis (TGA) was used to study the garnet nanofiber formation during the calcination process. The TGA was carried out under air flow with a rapid heating rate of 10° C./min. FIG. 50a shows the TGA profile of the as-spun nanofibers containing PVP polymer and garnet precursor. The result shows that above 750° C. the weight became stable, indicating that stable garnet nanofibers were formed. FIG. 50b compares the TGA profiles of the PEO; LiTFSI and the FRPC electrolyte. Both electrolytes were thermally stable to around 200° C. In the rapid beating process, polymers began to decompose above 200° C. and showed a significant weight loss at around 400° C. due to the almost complete decomposition of the polymer. The slope at 400° C. was the decomposition of LITFSI. For the FRPC electrolyte, the weight was stable at 500° C. and the remaining was the garnet nanofiber membrane due to the superior stability of garnet material in air. For the polymer electrolyte, the weight was stable at 650° C., leaving with decomposed LiTFSI salt.

Thermal stability is an important consideration for using solid-state electrolytes, especially polymer electrolyte. Traditional liquid electrolytes, such as carbonate electrolytes, tend to cause thermal runaway when batteries are under extreme conditions of short circuits, overcharge, and high temperature. Due to its relatively high thermal stability, polymer electrolytes becomes a safer choice compared to liquid electrolytes. Since traditional polymer electrolytes are built on their own polymer structure and fillers cannot offer sufficient mechanical support for the electrolyte, the polymer electrolyte is inevitable to melt and shrink at high temperature, especially above the polymer thermal decomposition temperature, which may cause direct contact between cathode and anode and is a significant safety concern. The FRPC electrolyte is able to address this concern because the garnet nanofiber membrane within the polymer electrolyte provides a ceramic barrier to physically block cathode and anode contact even after loss of the polymer.

FIGS. 50c and 50d compares the combustion tests of a traditional polymer electrolyte and the novel FRPC electrolyte developed in this work. The traditional polymer electrolyte was prepared using the same recipe to prepare the PEO-LTFSI polymer, but using garnet nanopowders (vs. the 3D garnet network) as fillers. The mass ratio of polymer and filler was controlled at 4:1. In FIG. 50c, the polymer electrolyte caught fire instantly when it came close to the ignited lighter and was quickly burned off into ashes. This high flammability indicates poor thermal stability of the polymer electrolyte. In comparison, the FRPC electrolyte exhibited an outstanding thermal stability, even though the polymer component was gone, the garnet nanofiber membrane still retained its structure (FIG. 50d). This low-flammable FRPC electrolyte can provide enhanced safety for all lithium metal and lithium ion batteries.

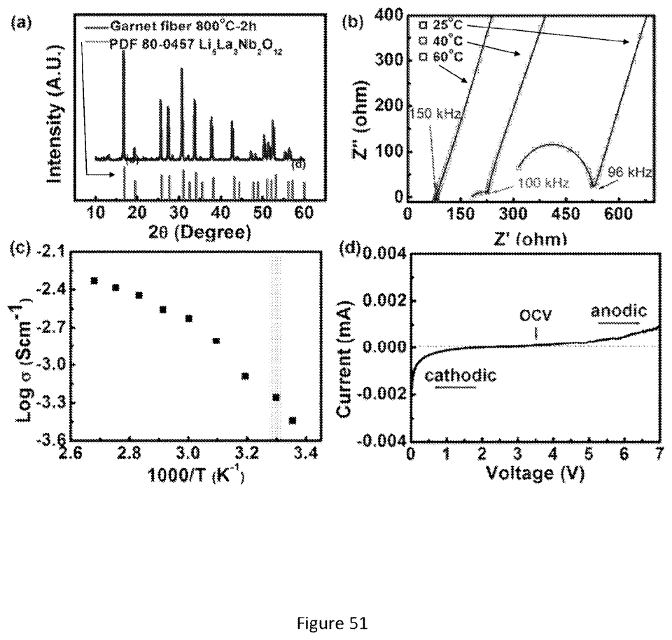

Powder X-ray diffraction (XRD) pattern of LLZO garnet nanofibers that were calcined at 800° C. for 2 hours are shown in FIG. 51a. Almost all of the diffraction peaks match very well with those of cubic phase garnet Li₅La₃Nb₂Nv₂O₁₂ (JCPBS card 80-0457). Li₅La₃M₂O₅ (M=Nb, Ta) is the first example of fast lithium ion conductive processing garnet-like structure, which is the typical structure has been widely used as model to study the garnet structure of LLZO material. So here standard Li₅La₃Nb₂O₁₂XRD profile was used to identify the synthesized garnet nanofiber structure. A small amount of La₂Zr₂O₇ was identified, but other impurities were below detection limit. According to the TG results, decomposition of precursors to oxide was completed at approximately 750° C. Further heating at 800° C.′ resulted in reaction of the oxides and formation of cubic phase LLZO garnet structure. However, the small amount of La₂Zr₂O₇ phase could also be formed by lithium loss at elevated temperature.

The total lithium ion conductivity of FRPC electrolyte was characterized by electrochemical impedance spectroscopy (EIS). FIG. 51b shows the typical Nyquist plots of FRPC electrolyte sandwiched between stainless steel blocking electrodes in the frequency range of 1 Hz to 1 MHz. Each impedance profile shows a real axis intercept at high frequency, a semicircle at intermediate frequency and an inclined straight tail at low frequency. The intercept of the extended semicircle on the real axis and semicircle in high and intermediate frequency range represent the bulk relaxation of FRPC electrolyte. The low frequency tail is due to the migration of lithium ions and the surface inhomogeneity of the blocking electrodes. FIG. 51c shows the Arrhenius plot of the FRPC electrolyte. Lithium ion conductivity was calculated based on the thickness FRPC electrolyte and diameter of stainless electrodes. Lithium ion conductivity of cubic phase LLZO garnet pellet would reach as high as 103 S/cm, while lithium salt stuffed PEO is generally in the order of 10⁶-10⁻⁹ S/cm at room temperature. Our FRPC electrolyte combining conductive cubic LLZO garnet and lithium-PEO could exhibit reasonably high ionic conductivity of 2.5×10⁻⁴ S/cm at room temperature.

A large electrochemical window is another key factor to determine the polymer electrolyte application for high-voltage lithium batteries. FIG. 51d shows the result of the linear sweep voltammetry (EIS) profile of the FRPC electrolyte using lithium metal as counter and reference electrode, and stainless steel as working electrode. The FRPC electrolyte exhibits a stable voltage window up to 6.0 V versus Li/Li⁺, indicating that this ion-conducting membrane can satisfy the requirement of most of high-voltage lithium batteries.

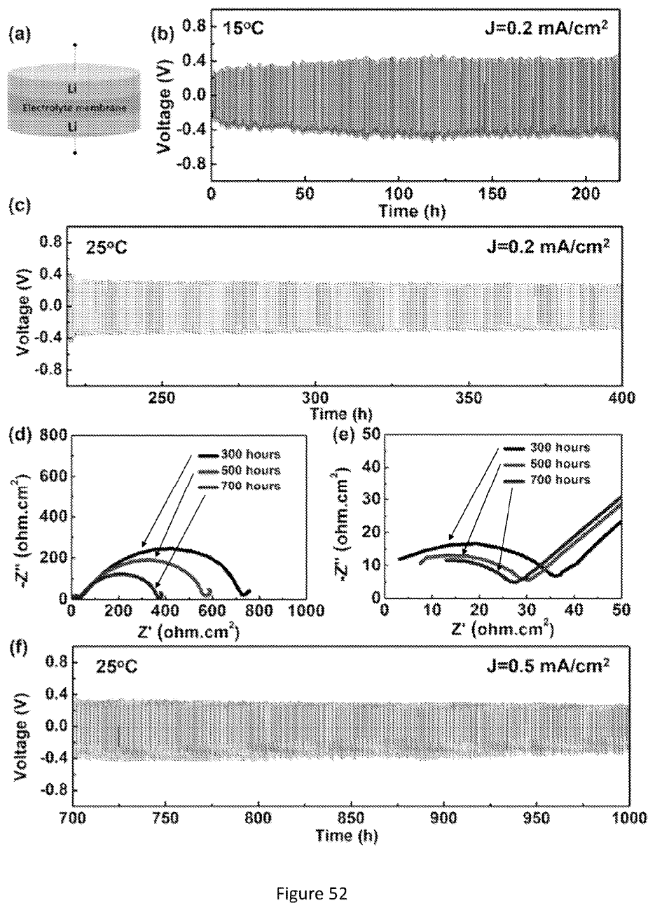

The mechanical stability of the FRPC electrolyte membrane against Li dendrites was evaluated by using a symmetric Li|FRPC electrolyte|Li cell. During charge and discharge process at a constant current, lithium ions are plating/stripping the lithium metal electrode to mimic the operation of charging and discharging lithium metal batteries. FIG. 52a represents the schematic of the symmetric cell setup. The FRPC electrolyte membrane was sandwiched between two lithium metal foils and sealed in coin cell. FIG. 52b shows the time-dependent voltage profile of the cell with FRPC electrolyte membrane cycled over 230 hours at a constant current density of 0.2 mA/cm² and a temperature of 15° C. The symmetric cell was periodically charged and discharged for 0.5 hour. The positive voltage is the Li stripping, and the negative voltage value refers to the Li plating process. In the first 70 hours, the cell's voltage slightly increased from 0.3 V to 0.4 V and then stabilized at 0.4 V.

When the testing temperature increased to 25° C., the voltage dropped to 0.3 V due to the improved ionic conductivity at elevated temperature as shown in FIG. 52c. In the following long-time cycles, the voltage kept decreasing to 0.2 V with increasing cycle time to 700 hours (FIG. 54). The fluctuation of voltage was caused by the surrounding environmental temperature change. Two voltage profiles of the symmetric cell at two different stripping/plating process time were compared as shown in FIG. 55. The voltage hysteresis apparently decreased with increase of cycle time. This decrease in voltage is quite different from the liquid electrolyte system in which the voltage normally increases with the increase of time, and is mainly ascribed to the non-uniform Li deposition and severe electrolyte decomposition that cause impedance increase. Similar voltage decrease has been observed in recent polymer electrolyte studies but the reason why voltage keeps decreasing with the increasing cycle time has not yet been explained. Based on our understanding, the decrease in voltage might be due to the improved interface between the electrolyte membrane and lithium metal during the repeated Li electrodeposition, which is confirmed by the EIS spectra of the symmetric cell measured at 300 hours, 500 hours, and 700 hours (FIG. 52d). The depressed semicircles at lower frequency indicate decreased interfacial impedance between electrolyte membrane and lithium metal during cycling. In the high frequency (FIG. 52e), the semicircle also decreased with the increased cycle time, indicating the decreased bulk impedance of the electrolyte membrane. When the current density increased to 0.5 mA/cm², the voltage increased to 0.3 V and the cell also exhibited slight decrease in voltage with increasing time to 1000 hours (FIG. 52f), showing good cycling stability with long cycle life.

In summary, all solid ion-conducting membrane of 3D garnet polymer composite was synthesized for lithium batteries, 3D garnet nanofiber networks were prepared by electrospinning and high temperature annealing. The garnet nanofibers constructed an “inter-welded” 3D structure that provides long-range lithium ion transfer pathways and further provides structural reinforcement to enhance the polymer matrix. This flexible solid-state electrolyte composite membrane exhibited an ionic conductivity of 2.5×10⁻⁴ S/cm at room temperature. The membrane can effectively block dendrites in a symmetric Li|electrolyte|Li cell during repeated lithium stripping/plating at room temperature with a current density of 0.2 mA/cm² around 500 hours, and with a current density of 0.5 mA/cm² over 300 hours. The decrease of voltage with increasing cycle time is observed for the symmetric cell, which is possibly due to the improved interfaces during repeated lithium electrodeposition. This example describes of the development of 3D Li-ion conducting ceramic materials in solid-state electrolytes, which are expected to be applied to flexible lithium-ion batteries and other electrochemical energy storage systems, such as lithium-sulfur batteries.

Although the present disclosure has been described with respect to one or more particular embodiments and/or examples, it will be understood that other embodiments and/or examples of the present disclosure may be made without departing from the scope of the present disclosure.

1-53. (canceled)

54. A solid-state hybrid electrolyte comprising:
an inorganic solid-state electrolyte (SSE); and
a polymeric material disposed on at least a portion an exterior surface of or all of the exterior surfaces of the solid-state electrolyte material, wherein the polymeric material comprises a copolymer or a mixture of polymers and/or copolymers.

55. The solid-state hybrid electrolyte of claim 54, wherein the inorganic SSE is a monolithic SSE body or a mesoporous SSE body.

56. The solid-state hybrid electrolyte material of claim 54, wherein the inorganic SSE is a disc, a sheet, or a polyhedron.

57. The solid-state hybrid electrolyte of claim 54, wherein the polymeric material is present at 5 volume percent or greater of the solid-state hybrid electrolyte.

58. The solid-state hybrid electrolyte of claim 54, wherein the polymeric material is present at 40 volume percent or greater of the solid-state hybrid electrolyte.

59. The solid-state hybrid electrolyte of claim 54, wherein the polymeric material is present at 60 volume percent or greater of the solid-state hybrid electrolyte.

60. The solid-state hybrid electrolyte of claim 54, wherein the polymeric material comprises a copolymer, and wherein the copolymer is selected from the group consisting of poly(ethylene oxide) (PEO) containing co-polymers, poly(acrylonitrile-co-methylacrylate), polyvinylidene difluoride (PVdF) containing co-polymers, and polymethyl methacrylate (PMMA) co-polymers.

61. The solid-state hybrid electrolyte of claim 60, wherein the copolymer is selected from the group consisting of a polystyrene (PS) PEO copolymer, a poly(methyl methacrylate) (PMMA)-PEO copolymer, and polyvinylidene fluoride-co-hexafluoropropylene (PVdF-co-HFP).

62. The solid-state hybrid electrolyte of claim 54, wherein the polymeric material comprises a mixture of polymers and/or copolymers, and wherein the polymers and/or copolymers are selected from the group consisting of poly(ethylene) (PE), poly(ethylene oxide) (PEO), poly(propylene) (PP), poly(propylene oxide), polymethyl methacrylate (PMMA), polyacrylonitrile (PAN), poly[bis(methoxy ethoxyethoxide)-phosphazene], poly(dimethylsiloxane) (PDMS), cellulose, cellulose acetate, cellulose acetate butylate, cellulose acetate propionate, polyvinylidene difluoride (PVdF), polyvinylpyrrolidone (PVP), polystyrene, sulfonate (PSS), polyvinylchloride (PVC) group, poly(vinylidene chloride) polypropylene oxide, polyvinylacetate, polytetrafluoroethylene, poly(ethylene terephthalate) (PET), polyimide, polyhydroxyalkanoate (PHA), PEO containing co-polymers, polyacrylonitrile (PAN), poly(acrylonitrile-co-methylacrylate), PVdF containing co-polymers, PMMA co-polymers, and derivatives thereof.

63. The solid-state hybrid electrolyte of claim 62, wherein the polymers and/or copolymers are selected from the group consisting of polyvinylidene fluoride (PVDF), polyvinylidene fluoride-co-hexafluoropropylene (PVdF-co-HFP), polyvinylpyrrolidone (PVP), PEO, PMMA, PAN, polystyrene (PS), and polyethylene (PE).

64. The solid-state hybrid electrolyte of claim 54, wherein the polymeric material is a gel, and wherein the gel comprises a liquid selected from the group consisting of ethylene carbonate (EC), diethyl carbonate (DEC), dimethoxyethane (DME), dioxolane (DOL), N-Propyl-N-methylpyrrolidinium bis(trifluoromethanesulfonyl) imide (PYR13TFSI), and combinations thereof and/or a salt selected from the group consisting of LiPF6, LiTFSI, LiTFSI, and combinations thereof.

65. A device comprising the solid-state hybrid electrolyte of claim 54.

66. The device of claim 65, wherein the device is a battery comprising:
the solid-state hybrid electrolyte;
an anode; and
a cathode,
wherein the solid-state hybrid electrolyte is disposed between the cathode and anode.

67. The device of claim 66, wherein the battery is a lithium-ion conducting solid-state battery and the solid-state hybrid electrolyte is a lithium ion-conducting SSE material.

68. The device of claim 66, wherein the cathode and/or anode comprises a conducting carbon material.

69. The device of claim 66, wherein the cathode comprises a material selected from sulfur, sulfur composite materials, and polysulfide materials, or the cathode is air.

70. The device of claim 69, wherein the cathode comprises a lithium containing cathode material, and wherein the lithium-containing cathode material is selected from the group consisting of lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, wherein M is selected from Fe, Co, and combinations thereof.

71. The device of claim 66, wherein the anode comprises a material selected from the group consisting of lithium-ion conducting anode materials.

72. The device of claim 71, wherein the anode is lithium metal.

73. The device of claim 66, wherein the anode comprises a material selected from sodium-ion conducting anode materials.
